(19) United States
(12) Patent Application Publication
(10) Pub. No.: US 2009/0099282 A1
(43) Pub. Date: Apr. 16, 2009

(54) Functionalized nanoparticles

(76) Inventors: Martin Muller, Lorrach (DE); Andreas Muhlebach, Frick (CH); Thomas Giesenberg, Oberwil (CH); Didier Bauer, Kembs (FR); Thomas Ruch, Delemont (CH); Francois Rime, Delemont (CH); Leonhard Feiler, Binzen (DE); Roman Lenz, Liestal (CH); Laurent Michau, Rosenau (FR)

Correspondence Address: JoAnn Villamizar;Patent Department, 540 White Plains Road, P.O.Box 2005, Tarrytown, NY, 10591-9005, US

(21) Appl. No.: 11/920,295

(22) PCT Filed: May 17, 2006
(86) PCT No.: PCT/EP2006/062357

§ 371 Date: Nov. 13, 2007

(30) Foreign Application Priority Data
May 27, 2005 (EP) 05104541.7

(51) Int. Cl. C08K 5/5419; C04B 16/00; C08K 5/00

(52) U.S. Cl. 524/100; 106/481; 106/287.13; 524/267; 524/261; 524/83; 524/188

(57) ABSTRACT

The present invention discloses functionalized nanoparticles comprising on the surface a covalently bound radical of formula (1), wherein the nanoparticles are SiO₂, Al₂O₃ or mixed SiO₂ and Al₂O₃ nanoparticles, R₁ and R₂ are independently of each other hydrogen, nanoparticle surface-O—, or a substituent, n is 1, 2, 3, 4, 5, 6, 7 or 8, and Y is a radical of formula —B₁-D₁ (2a), wherein B₁ is the direct bond or a bridge member, and D₁ is a radical of a cationic dye, a radical of a phthalocyanine dye which carries no water-solubilizing group, or a radical of a fluorescent dye selected from the group consisting of coumarins, benzocoumarins, xanthenes, benzo[a]xanthenes, benzo[b]xanthenes, benzo[c]xanthenes, phenoxazines, benzo[a]phenoxazines, benzo[b]phenoxazines, benzo[c]phenoxazines, napthalimides, naphtholactams, azlactones, methines, oxazines, thiazines, diketopyrrolopyrroles, quinacridones, benzoxanthenes, thio-epindolines, lactamimides, diphenylmaleimides, acetoacetamides, imidazothiazines, benzanthrones, phthalimides, benzotriazoles, pyrimidines, pyrazines and triazines, or Y is a radical of formula —B₂D₂ (2b), wherein B₂ is an organic radical comprising at least one group having a negative charge, and D₂ is a cationic dye selected from the group consisting of monoazo, disazo, polyazo, methine, azamethine, diphenylmethane, triphenylmethane, triaminotriaryl methane, azine, oxazine, cyanine and anthraquinone dyes.

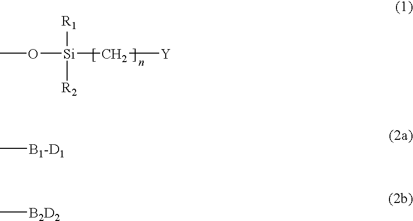

The present invention relates to novel functionalized nanoparticles, to compositions comprising an organic material, preferably a synthetic polymer, and the novel functionalized nanoparticles, as well as to the use thereof as coloring materials for organic materials.

The use of fillers in polymers has the advantage that it is possible to bring about improvement in, for example, the mechanical properties, especially the density, hardness, rigidity or impact strength of the polymer.

Using extremely small filler particles (<400 nm), so-called nano-scaled fillers, mechanical properties, long term stability or flame retardant property of the polymers can be improved at a much lower concentration of 5 to 10% by weight compared to 20 to 50% by weight with the micro-scaled normal filler particles. Polymers containing nano-scaled fillers show improved surface qualities like gloss, lower tool wear at processing and better conditions for recycling. Coatings and films comprising nano-scaled fillers show improved stability, flame resistance, gas barrier properties and scratch resistance. In addition, improved transparency and less scattering of fillers can be achieved.

Nano-scaled fillers possess an extremely large surface with high surface energy. The reduction of the surface energy and the compatibilization of the nano-scaled fillers with a polymeric substrate is therefore even more important than with a common micro-scaled filler in order to avoid aggregation and to reach an excellent dispersion of the nano-scaled filler in the polymer.

WO-A-03/002652 discloses the preparation of additive functionalized organophilic nanoscaled fillers.

It has now been found that a selected group of novel functionalized nanoparticles is especially useful as coloring material for various substrates, wherein the nanoparticles are compatible with the substrates and, in addition, show advantageous properties like those given above.

By the use of colorants in polymers or coatings often migration of the colorants occurs, leading, for example, to undesired colorings on adjacent materials. In ink-jet printing applications often bleeding occurs, resulting in prints which are not clear.

Therefore, there is still a need for colorants having improved properties and it is an object of the present invention to provide colorants which are especially useful for the applications mentioned above.

The present invention therefore relates to functionalized nanoparticles comprising on the surface a covalently bound radical of formula

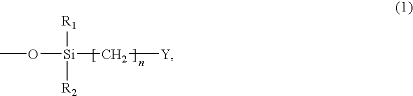

wherein
the nanoparticles are SiO₂, Al₂O₃ or mixed SiO₂ and Al₂O₃ nanoparticles,
R₁ and R₂ are independently of each other hydrogen, nanoparticle surface-O—, or a substituent,
n is 1, 2, 3, 4, 5, 6, 7 or 8, and
Y is a radical of formula

—B₁-D₁ (2a),

wherein
B₁ is the direct bond or a bridge member, and
D₁ is a radical of a cationic dye, a radical of a phthalocyanine dye which carries no water-solubilizing group, or a radical of a fluorescent dye selected from the group consisting of coumarins, benzocoumarins, xanthenes, benzo[a]xanthenes, benzo[b]xanthenes, benzo[c]xanthenes, phenoxazines, benzo[a]phenoxazines, benzo[b]phenoxazines, benzo[c]phenoxazines, napthalimides, naphtholactams, azlactones, methines, oxazines, thiazines, diketopyrrolopyrroles, quinacridones, benzoxanthenes, thio-epindolines, lactamimides, diphenylmaleimides, acetoacetamides, imidazothiazines, benzanthrones, phthalimides, benzotriazoles, pyrimidines, pyrazines and triazines,
or Y is a radical of formula

—B₂D₂ (2b),

wherein
B₂ is an organic radical comprising at least one group having a negative charge, and
D₂ is a cationic dye selected from the group consisting of monoazo, disazo, polyazo, methine, azamethine, diphenylmethane, triphenylmethane, triaminotriarylmethane, azine, oxazine, cyanine and anthraquinone dyes.
R₁ and R₂ are, for example, independently of each other hydrogen; C₁-C₂₅alkyl which may be interrupted by —O— or —S—; C₂-C₂₄alkenyl; phenyl; C₇-C₉phenylalkyl; —OR₅;

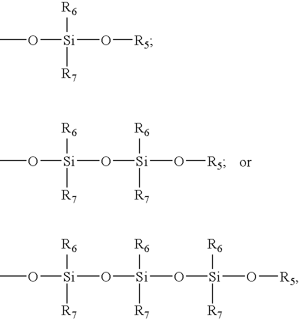

R₅ is hydrogen; C₁-C₂₅alkyl which may be interrupted by —O— or —S—; C₂-C₂₄alkenyl; phenyl; C₇-C₉phenylalkyl;

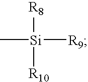

or the nanoparticle surface,
R₆ and R₇ independently of each other are hydrogen; C₁-C₂₅alkyl which may be interrupted by —O— or —S—; C₂-C₂₄alkenyl; phenyl; C₇-C₉phenylalkyl; or —OR₅, and
R₈, R₉ and R₁₀ independently of each other are hydrogen; C₁-C₂₅alkyl which may be interrupted by —O— or —S—; C₂-C₂₄alkenyl; phenyl; or C₇-C₉phenylalkyl.

R₁, R₂, R₅, R₆, R₇, R₈, R₉ and R₁₀ as C₁-C₂₅alkyl may be a branched or unbranched radical, for example methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, icosyl or docosyl. The alkyl radicals may be uninterrupted or be interrupted by —O— or —S—. Alkyl radicals like C₂-C₂₅alkyl, especially C₃-C₂₅alkyl, which are interrupted by —O— or —S— are, for example, CH₃—O—CH₂CH₂—, CH₃—S—CH₂CH₂—, CH₃—O—CH₂CH₂—O—CH₂CH₂—, CH₃—O—CH₂CH₂—O—CH₂CH₂—, CH₃—(O—CH₂CH₂—)₂O—CH₂CH₂—, CH₃—(O—CH₂CH₂—)₃O—CH₂CH₂— or CH₃—(O—CH₂CH₂—)₄O—CH₂CH₂—.

Preferred is C₁-C₁₂alkyl, especially C₁-C₈alkyl, which alkyl radicals may be uninterrupted or be interrupted by —O—.

R₁, R₂, R₅, R₆, R₇, R₈, R₉ and R₁₀ as alkenyl having 2 to 24 carbon atoms may be a branched or unbranched radical such as, for example, vinyl, propenyl, 2-butenyl, 3-butenyl, isobutenyl, n-2,4-pentadienyl, 3-methyl-2-butenyl, n-2-octenyl, n-2-dodecenyl, isododecenyl, oleyl, n-2-octadecenyl or n-4-octadecenyl. Preference is given to alkenyl having 3 to 18, especially 3 to 12, for example 3 to 6, especially 3 to 4 carbon atoms.

R₁, R₂, R₅, R₆, R₇, R₈, R₉ and R₁₀ as C₇-C₉phenylalkyl are, for example, benzyl, α-methylbenzyl, α,α-dimethylbenzyl or 2-phenylethyl. Preference is given to benzyl.

R₅ is preferably hydrogen, C₁-C₄alkyl, or Al₂O₃ surface or SiO₂ surface, especially the Al₂O₃ surface or SiO₂ surface. A highly preferred meaning for R₅ is the SiO₂ surface.

R₆, R₇, R₈, R₉ and R₁₀ are preferably C₁-C₄alkyl, especially methyl.

Preferably, R₁ and R₂ are —OR₅;

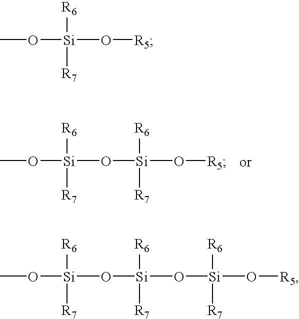

especially a radical of formula —OR₅, wherein for R₅, R₆ and R₇ the above-mentioned meanings and preferences apply.

More preferably, R₁ and R₂ are a radical of formula —OR₅, wherein R₅ is the Al₂O₃ surface or SiO₂ surface, especially the SiO₂ surface.

n is preferably 2, 3 or 4, especially 3.

B₁ is, for example, the direct bond, —NH—SO₂—, —NH—CO—, —NH—CO—NH—CO— or C₁-C₂₅alkylene, which may be bound and/or be interrupted by at least one of the radicals selected from the group consisting of —O—, —S—, —N(R₃)—, —CO—, —O—CO—, —CO—O—, —N(R₃)—CO— and —CO—N(R₃)—, wherein R₃ is hydrogen, C₁-C₁₂alkyl or hydroxyl-substituted C₁-C₁₂alkyl. Preferably, R₃ is hydrogen or C₁-C₈alkyl, especially hydrogen or C₁-C₄alkyl. A highly preferred meaning for R₃ is hydrogen.

Preferably, B₁ is the direct bond, —NH—SO₂—, —NH—CO—, —NH—CO—NH—CO— or C₁-C₂₅alkylene, which may be bound and/or be interrupted by at least one of the radicals selected from the group consisting of —O—, —S—, —NH—, —CO—, —O—CO—, —CO—O—, —NH—CO— and —CO—NH—.

Highly preferred meanings for B₁ are the direct bond, —NH—SO₂—, —NH—CO—, —NH—CO—NH—CO— or bridge members of the formula -A₁-C₁-C₂₅alkylene-A₂-, wherein the C₁-C₂₅alkylene can be uninterrupted or be interrupted as given above and A₁ and A₂ are the direct bond or radicals as given above. Preferred meanings for A₁ are —O—, —S—, —NH—, —NH—CO— or —O—CO—, especially —NH— or —NH—CO—, and more preferably —NH—. Preferred meanings for A₂ are the direct bond, —O—, —S—, —NH—, —CO—O— or —CO—NH—, especially the direct bond, —O—, —CO—O— or —CO—NH—. As to the C₁-C₂₅alkylene it is preferred that it is uninterrupted or interrupted by at least one of the radicals selected from the group consisting of —O—, —NH—, —CO—, —CO—O— and —CO—NH—, especially —O—, —NH— and —CO—O—, and more preferably by —CO—O—.

Important meanings for B₁ are the direct bond, —NH—SO₂— or the bridge member of formula -A₁-C₁-C₂₅alkylene-A₂-, especially the direct bond or the bridge member of formula -A₁-C₁-C₂₅alkylene-A₂-, and more preferably the direct bond.

Examples for B₁ are the direct bond or —NH—SO₂—, —NH—CO—(CH₂)₁₋₆—, —NH—(CH₂)₁₋₆—CO—O—(CH₂)₁₋₆—, —NH—CO—(CH₂)₁₋₆—CO—NH—, —NH—CO—(CH₂)₁₋₆—CO—O— or —NH—(CH₂)₁₋₆—CO—O—(CH₂)₁₋₆—O—

As examples for groups in B₂ having a negative charge carboxy, sulfo or sulfato groups may be mentioned.

B₂ is, for example, C₁-C₂₅alkyl which may be bound and/or be interrupted by at least one of the radicals selected from the group consisting of —O—, —S—, —N(R₄)—, —CO—, —O—CO—, —CO—O—, —N(R₄)—CO— and —CO—N(R₄)—, and which is unsubstituted or substituted by hydroxy, carboxy, sulfo or sulfato,

R₄ is hydrogen or C₁-C₁₂alkyl which is unsubstituted or substituted by hydroxy, carboxy, sulfo or sulfato, and
wherein at least one of the alkyl radicals B₂ and R₄ contains a carboxy, sulfo or sulfato group, especially a carboxy or sulfo group.

R₄ is preferably hydrogen, or C₁-C₈alkyl which is unsubstituted or substituted by a carboxy, sulfo or sulfato group, especially by a carboxy or sulfo group and more preferably by a sulfo group. A highly preferred meaning for R₄ is hydrogen.

As to the alkyl radical B₂ it is preferred that it is bound by —O—, —S—, —N(R₄)—, —N(R₄)—CO— or —O—CO—, especially by —N(R₄)— or —N(R₄)—CO—. The alkyl radical is preferably uninterrupted or interrupted by —N(R₄)— or —O—, especially by —O—.

Important radicals B₂ are C₁-C₂₅alkyl radicals, which are bound by —O—, —S—, —N(R₄)—, —N(R₄)—CO— or —O—CO—, especially by —N(R₄)— or —N(R₄)—CO—, which are uninterrupted or interrupted by —N(R₄)— or —O—, especially by —O—, and which are unsubstituted or substituted by hydroxy, carboxy, sulfo or sulfato,

R₄ is hydrogen or C₁-C₈alkyl which is unsubstituted or substituted by carboxy, sulfo or sulfato, and

wherein at least one of the alkyl radicals B₂ and R₄ contains a carboxy, sulfo or sulfato group, especially a carboxy or sulfo group.

Very important radicals B₂ are C₁-C₂₅alkyl radicals, which are bound by —N(R₄)— or —N(R₄)—CO—, which are uninterrupted or interrupted by —O—, and which are unsubstituted or substituted by hydroxy, carboxy or sulfo, and

R₄ is hydrogen or C₁-C₈alkyl which is unsubstituted or substituted by carboxy or sulfo, and wherein at least one of the alkyl radicals B₂ and R₄ contains a carboxy or sulfo group.

D₁ is preferably derived from a xanthene, benzoxanthene, naphthalimid, diketopyrrolopyrrole or phthalocyanine dye, especially from a xanthene, benzoxanthene, naphthalimid or diketopyrrolopyrrole dye. Preference is given to corresponding fluorescent dyes.

Highly preferred radicals for D₁ are those of formula

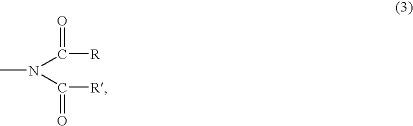

wherein R and R′ together with the residue of formula —N(CO—)₂ form the radical of a benzoxanthene or naphthalimid dye.

Examples of such radicals of formula (3) are the following

Radicals Derived from Naphthalimide Dyes:

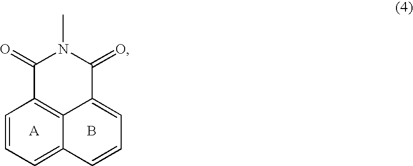

wherein
the rings A and B can be unsubstituted or substituted by C₁₋₈alkyl, C₁₋₈alkoxy, amino, mono- or di(C₁₋₈alkyl)amino, halogen or sulfo.

Radicals Derived from Benzoxanthene Dyes:

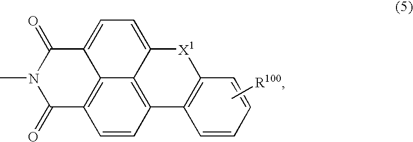

wherein
R¹⁰⁰ is C₁₋₈alkyl, C₁₋₈alkoxy, C₁₋₈thioalkyl, amino, mono- or di(C₁₋₈alkyl)amino, or halogen, and X is —O—, —S—, —NH—, or —N(R¹⁰¹)—, wherein R¹⁰¹ is C₁₋₈alkyl, hydroxy-C₁₋₈alkyl, or C₆₋₁₀aryl.

Highly preferred radicals for D₁ are furthermore those wherein D₁ is derived from a xanthene dye:

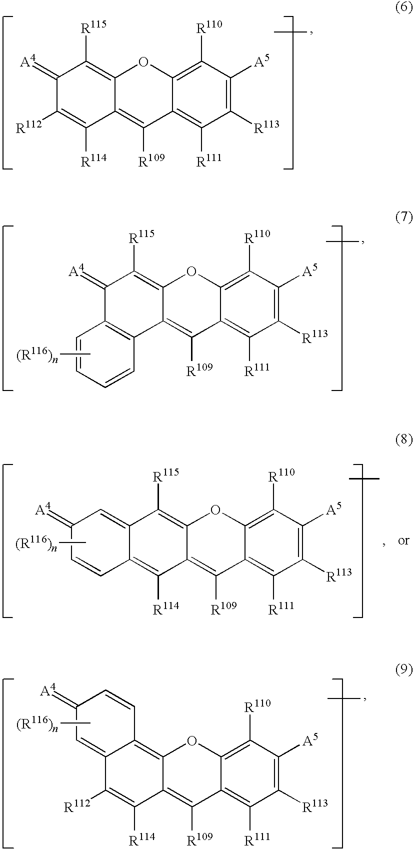

wherein
A⁴ represents O, N-Z¹ or N(Z¹)₂ in which Z¹ is H or C₁-C₈alkyl,
A⁵ represents —OH or —N(Z²)₂, in which Z² is H or C₁-C₈alkyl,
n is 1, 2, 3 or 4,
R¹¹⁰, R¹¹¹, R¹¹², R¹¹³, R¹¹⁴, R¹¹⁵ and R¹¹⁶ are each independently selected from H, halogen, cyano, CF₃, C₁-C₈alkyl, C₁-C₈alkylthio, C₁-C₈alkoxy, phenyl, naphthyl and heteroaryl; wherein the alkyl portions of any of R¹¹⁰ through R¹¹⁶ are optionally substituted with halogen, carboxy, sulfo, amino, mono- or di(C₁-C₈alkyl)amino, C₁-C₄alkoxy, cyano, haloacetyl or hydroxy; and the phenyl, naphthyl or heteroaryl portions of any of R¹¹⁰ through R¹¹⁶ are optionally substituted with from one to four substituents selected from the group consisting of halogen, cyano, carboxy, sulfo, hydroxy, amino, mono- or di(C₁-C₈)alkylamino, C₁-C₈alkyl, C₁-C₈alkylthio and C₁-C₈alkoxy;
R¹⁰⁹ is halogen, cyano, CF₃, C₁-C₈alkyl, C₂-C₈alkenyl, C₂-C₈alkynyl, phenyl, naphthyl or heteroaryl having the formula:

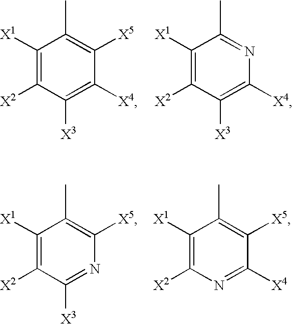

wherein
X¹, X², X³, X⁴ and X⁵ are each independently selected from the group consisting of H, halogen, cyano, CF₃, C₁-C₈alkyl, C₁-C₈alkoxy, C₁-C₈alkylthio, C₂-C₈alkenyl, C₂-C₈alkynyl, SO₃H and CO₂H. Additionally, the alkyl portions of any of X¹ through X⁵ can be further substituted with halogen, carboxy, sulfo, amino, mono- or di(C₁-C₈alkyl)amino, C₁-C₈alkoxy, cyano, haloacetyl or hydroxy. Optionally, any two adjacent substituents X¹ through X⁵ can be taken together to form a fused aromatic ring, like a phenyl ring, that is optionally further substituted with from one to four substituents selected from halogen, cyano, carboxy, sulfo, hydroxy, amino, mono- or di(C₁-C₈alkyl)amino, C₁-C₈alkyl, C₁-C₈alkylthio and C₁-C₈alkoxy. In certain embodiments, the xanthene colorants of the above formulae (as well as other formulae herein) will be present in isomeric or tautomeric forms which are included in this invention.

Radicals Derived from Diketopyrrolopyrroles of Formula:

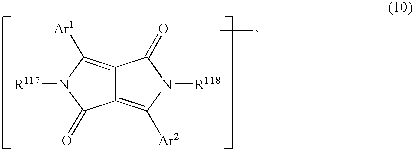

wherein
R¹¹⁷ and R¹¹⁸ are independently of each other an organic group, and
Ar¹ and Ar² are independently of each other an aryl group or a heteroaryl group, which can optionally be substituted.

The term “aryl group” in the definition of Ar¹ and Ar² is typically C₆-C₃₀aryl, such as phenyl, indenyl, azulenyl, naphthyl, biphenyl, terphenylyl or quadphenylyl, as-indacenyl, s-indacenyl, acenaphthylenyl, phenanthryl, fluoranthenyl, triphenlenyl, chrysenyl, naphthacen, picenyl, perylenyl, pentaphenyl, hexacenyl, pyrenyl, or anthracenyl, preferably phenyl, 1-naphthyl, 2-naphthyl, 9-phenanthryl, 2- or 9-fluorenyl, 3- or 4-biphenyl, which may be unsubstituted or substituted.

The term “heteroaryl group”, especially C₂-C₃₀heteroaryl, is a ring, wherein nitrogen, oxygen or sulfur are the possible hetero atoms, and is typically an unsaturated heterocyclic radical with five to 18 atoms having at least six conjugated π-electrons such as thienyl, benzo[b]thienyl, dibenzo[b,d]thienyl, thianthrenyl, furyl, furfuryl, 2H-pyranyl, benzofuranyl, isobenzofuranyl, 2H-chromenyl, xanthenyl, dibenzofuranyl, phenoxythienyl, pyrrolyl, imidazolyl, pyrazolyl, pyridyl, bipyridyl, triazinyl, pyrimidinyl, pyrazinyl, 1H-pyrrolizinyl, isoindolyl, pyridazinyl, indolizinyl, isoindolyl, indolyl, 3H-indolyl, phthalazinyl, naphthyridinyl, quinoxalinyl, quinazolinyl, cinnolinyl, indazolyl, purinyl, quinolizinyl, chinolyl, isochinolyl, phthalazinyl, naphthyridinyl, chinoxalinyl, chinazolinyl, cinnolinyl, pteridinyl, carbazolyl, 4aH-carbazolyl, carbolinyl, benzotriazolyl, benzoxazolyl, phenanthridinyl, acridinyl, perimidinyl, phenanthrolinyl, phenazinyl, isothiazolyl, phenothiazinyl, isoxazolyl, furazanyl or phenoxazinyl, preferably the above-mentioned mono- or bicyclic heterocyclic radicals, which may be unsubstituted or substituted.

It is preferred that Ar¹ and Ar² are phenyl; naphthyl, like 1- or 2-naphthyl; biphenyl, like 3- or 4-biphenyl; phenanthryl, like 9-phenanthryl; or fluororenyl, like 2- or 9-fluorenyl. Highly preferred are phenyl or naphthyl, especially phenyl.

Ar¹ and Ar² can be unsubstituted or substituted by, for example, C₁-C₁₂alkyl; C₁-C₁₂alkoxy; halogen, like fluorine, chlorine or bromine; cyano; amino; N-mono- or N,N-di-(C₁-C₁₂alkyl)amino; phenylamino, N,N-di-phenylamino, naphthylamino or N,N-di-naphthylamino, wherein the phenyl or naphthyl radicals can be further substituted by, for example, C₁-C₁₂alkyl, C₁-C₁₂alkoxy or halogen. Preferred substituents are C₁-C₁₂alkyl, especially C₁-C₄alkyl; C₁-C₁₂alkoxy, especially C₁-C₄alkyl; and halogen.

R¹¹⁷ and R¹¹⁸ may be the same or different and are preferably selected from a C₁-C₂₅alkyl group, which can be substituted by fluorine, chlorine, bromine or hydroxyl, an allyl group, which can be substituted by C₁-C₄alkyl, a cycloalkyl group, a cycloalkyl group, which can be condensed one or two times by phenyl which can be substituted by C₁-C₄-alkyl, halogen, nitro or cyano, an alkenyl group, a cycloalkenyl group, an alkynyl group, a haloalkyl group, a haloalkenyl group, a haloalkynyl group, a ketone or aldehyde group, an ester group, a carbamoyl group, a ketone group, a silyl group, a siloxanyl group, A⁶ or —CR¹¹⁹R¹²⁰—(CH₂)ₘ-A⁶, wherein

R¹¹⁹ and R¹²⁰ independently from each other stand for hydrogen, or C₁-C₄alkyl, or phenyl which can be substituted by C₁-C₄alkyl,
A⁶ stands for aryl or heteroaryl, in particular phenyl or 1- or 2-naphthyl, which can be substituted by C₁-C₈alkyl, C₁-C₈alkoxy or halogen, and m stands for 0, 1, 2, 3 or 4.
R¹¹⁷ and R¹¹⁸ are preferably C₁-C₂₅alkyl, which is unsubstituted or substituted by fluorine, chlorine, bromine or hydroxyl; or A⁶ or —CR¹¹⁹R¹²⁰—(CH₂)ₘ-A⁶, wherein
R¹¹⁹ and R¹²⁰ independently from each other stand for hydrogen, or C₁-C₄alkyl, or phenyl which can be substituted by C₁-C₄alkyl,
A⁶ stands for phenyl or 1- or 2-naphthyl, which can be substituted by C₁-C₈alkyl, C₁-C₈alkoxy or halogen and m stands for 0, 1, 2, 3 or 4.

Highly preferred meanings for R¹¹⁷ and R¹¹⁸ are C₁-C₂₅alkyl; or benzyl, which is unsubstituted or substituted in the phenyl ring by C₁-C₈alkyl, C₁-C₈alkoxy or halogen.

D₁ as the radical of a phthalocyanine dye is preferably a radical of formula

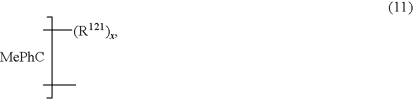

in which
MePhC is the radical of a metal phthalocyanine,
R¹²¹ is hydrogen, C₁-C₂₅alkyl which can be substituted by hydroxy; C₁-C₂₅alkoxy which can be substituted by hydroxy; halogen; amino; acetylamino; mono- or di(C₁-C₈alkyl)amino; cyano or hydroxy, and x is 1, 2, 3, 4, 5, 6, 7 or 8. Me is preferably a metal selected from copper, nickel or cobalt, especially copper.

D₁ as radical of a cationic dye is preferably derived from a cationic dye selected from the group consisting of monoazo, disazo, polyazo, methine, azamethine, diphenylmethane, triphenylmethane, triaminotriarylmethane, azine, oxazine, thiazine, cyanine and anthraquinone dyes, preferably from diphenylmethane, triphenylmethane, triaminotriarylmethane dyes, and more preferably from triaminotriarylmethane dyes.

Preferred radicals D₁ of a cationic monoazo dye are the following:

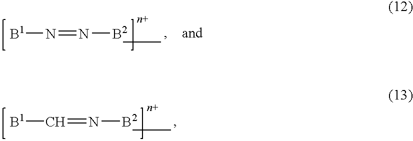

wherein
B¹ and B², independently of each other, are phenyl, naphthyl, or a heterocylic group, each of which can be substituted by C₁-C₈alkyl, C₁-C₈alkoxy, phenyl, halogen, or a radical of formula —N(R⁵⁰)R¹⁵¹, —N(R¹⁵⁰)(R¹⁵¹)R¹⁵² or —OR¹⁵⁰, wherein R¹⁵⁰, R¹⁵¹ and R¹⁵² are hydrogen, C₁-C₈alkyl, C₁-C₈hydroxyalkyl or phenyl, which phenyl radical can be further substituted by one of the substituents given above for B¹ and B²,
n is 1, 2, 3 or 4, especially 1.

Preferred heterocyclic groups are the imidazole and the pyridazine group.

Preferred radicals D₁ of a cationic disazo dye are the following:

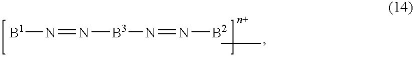

wherein B¹, B² and n are as defined above under formulae (12) and (13) and B³ is phenylene or naphthylene, each of which can be substituted as given above for B¹ and B² under formulae (12) and (13).

Preferred radicals D₁ of a cationic triarylmethane dye are those of formula:

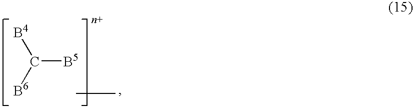

wherein B⁴, B⁵ and B⁶, independently of each other, are phenyl or naphthyl, which can be substituted by C₁-C₈alkyl, C₁-C₈alkoxy, phenyl, halogen, sulfo, carboxy, or a radical of formula —N(R¹⁵³)R¹⁵⁴, —N(R¹⁵³)(R¹⁵⁴)R¹⁵⁵ or —OR¹⁵³, wherein R¹⁵³, R¹⁵⁴ and R¹⁵⁵ are hydrogen;
C₁-C₈alkyl which can be further substituted by phenyl or hydroxy; or phenyl,
and wherein the phenyl radicals mentioned above as substituents can be further substituted by at least one of the substituents mentioned for the phenyl or naphthyl radicals B⁴, B⁵ and B⁶, and
n is 1, 2, 3 or 4, especially 1.

Highly preferred radicals D₁ of a cationic triarylmethane dye are corresponding radicals of triaminotriarylmethane dyes which contain at least three groups of formula —N(R¹⁵³)R¹⁵⁴ or —N(R¹⁵³)(R¹⁵⁴)R¹⁵⁵, wherein R¹⁵³, R¹⁵⁴ and R¹⁵⁵ are as defined above under formula (15).

D₂ as a cationic dye can be any of the cationic dyes given above, whereby the above preferences apply. Since D₂ is electrostatically bound, D₂ as a cationic dye does not contain the covalent bond indicated in the above formulae.

According to a further embodiment of the present invention the functionalized nanoparticles can comprise on the surface, in addition to the radical of formula (1), a covalently bound radical of the formula

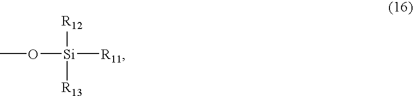

wherein
the nanoparticles are SiO₂, Al₂O₃ or mixed SiO₂ and Al₂O₃ nanoparticles,
R₁₁ is C₁-C₂₅alkyl or C₂-C₂₄alkenyl, which may be substituted by amino, mercapto or hydroxyl and/or may be interrupted by —O—, —S—, —N(R₁₄)—, —CO—, —O—CO— or —CO—O—; C₅-C₁₂cycloalkyl;
C₅-C₁₂cycloalkenyl; or a polymerizable group or a polymer each of which may be bound via a bridge member,
R₁₂ and R₁₃ are independently of each other hydrogen, nanoparticle surface-O—, or a substituent, and
R₁₄ is hydrogen or C₁-C₄alkyl.

As to R₁₂ and R₁₃ the definitions and preferences given herein before for R₁ and R₂ apply.

R₁₄ is preferably hydrogen or methyl, especially hydrogen.

As to R₁₁ in the meaning as C₁-C₂₅alkyl and C₂-C₂₄alkenyl the definitions and preferences given above for R₁, R₂, R₅, R₆, R₇, R₈, R₉ and R₁₀ apply. A preferred definition of R₁₁ is C₂-C₁₂alkyl, especially C₂-C₈alkyl.

R₁₁ as hydroxyl-substituted C₁-C₂₅alkyl is a branched or unbranched radical which contains preferably 1 to 3, in particular 1 or 2, hydroxyl groups, such as, for example, hydroxyethyl, 3-hydroxypropyl, 2-hydroxypropyl, 4-hydroxybutyl, 3-hydroxybutyl, 2-hydroxybutyl, 5-hydroxypentyl, 4-hydroxypentyl, 3-hydroxypentyl, 2-hydroxypentyl, 6-hydroxyhexyl, 5-hydroxyhexyl, 4-hydroxyhexyl, 3-hydroxyhexyl, 2-hydroxyhexyl, 7-hydroxyheptyl, 6-hydroxyheptyl, 5-hydroxyheptyl, 4-hydroxyheptyl, 3-hydroxyheptyl, 2-hydroxyheptyl, 8-hydroxyoctyl, 7-hydroxyoctyl, 6-hydroxyoctyl, 5-hydroxyoctyl, 4-hydroxyoctyl, 3-hydroxyoctyl, 2-hydroxyoctyl, 9-hydroxynonyl, 10-hydroxydecyl, 11-hydroxyundecyl, 12-hydroxydodecyl, 13-hydroxytridecyl, 14-hydroxytetradecyl, 15-hydroxypentadecyl, 16-hydroxyhexadecyl, 17-hydroxyheptadecyl, 18-hydroxyoctadecyl, 20-hydroxyeicosyl or 22-hydroxydocosyl. A preferred definition of R₁₁ is hydroxyl-substituted C₂-C₁₂alkyl, especially hydroxyl-substituted C₄-C₈alkyl.

R₁₁ as alkyl which is interrupted by —O—, —S—, —N(R₁₄)—, —CO—, —O—CO— or —CO—O— is a corresponding C₂-C₂₅alkyl radical, for example, CH₃—O—CH₂CH₂—, CH₃—NH—CH₂CH₂—, CH₃—N(CH₃)—CH₂CH₂—, CH₃—S—CH₂CH₂—, CH₃—O—CH₂CH₂—O—CH₂CH₂—, CH₃—O—CH₂CH₂—O—CH₂CH₂—, CH₃—(O—CH₂CH₂—)₂O—CH₂CH₂—, CH₃—(O—CH₂CH₂—)₃O—CH₂CH₂—, CH₃—(O—CH₂CH₂—)₄O—CH₂CH₂—, CH₃—(O—CH₂CH₂—)₄O—CH₂CH₂—O(CO)—CH₂CH₂— or CH₃CH₂—(O—CH₂CH₂—)₄O—CH₂CH₂—O(CO)—CH₂CH₂—.

R₁₁ as alkyl which is substituted by hydroxyl and is interrupted by —O—, —S—, —N(R₁₄)—, —CO—, —O—CO— or —CO—O— is a corresponding C₂-C₂₅alkyl radical, for example, —CH₂—CH(OH)—CH₂—O—CH₃, —CH₂—CH(OH)—CH₂—O—CH₂CH₃, —CH₂—CH(OH)—CH₂—O—CH(CH₃)₂ or —CH₂CH₂—CO—O—CH₂CH₂—O—CO—(CH₂)₅—O—CO—(CH₂)₅—OH.

R₁₁ as alkyl which is substituted by amino-, mercapto- or hydroxyl and is interrupted by —O—, —S—, —N(R₁₄)—, —CO—, —O—CO— or —CO—O— is a corresponding C₂-C₂₅alkyl radical, for example, HO—CH₂CH₂—O—CH₂CH₂—, H₂NCH₂CH₂—NH—CH₂CH₂—, HOCH₂CH₂—NH(CH₃)—CH₂CH₂—, HOCH₂CH₂—S—CH₂CH₂—, H₂NCH₂CH₂—O—CH₂CH₂—O—CH₂CH₂—, HOCH₂CH₂—O—CH₂CH₂—O—CH₂CH₂—, HSCH₂CH₂—(O—CH₂CH₂—)₂O—CH₂CH₂—, H₂NCH₂CH₂—(O—CH₂CH₂—)₃O—CH₂CH₂—H₂NCH₂CH₂—(O—CH₂CH₂—)₄O—CH₂CH₂—, HSCH₂CH₂—(O—CH₂CH₂—)₄O—CH₂CH₂—O(CO)—CH₂CH₂— or HOCH₂CH₂CH₂CH₂—(O—CH₂CH₂—)₄O—CH₂CH₂—O(CO)—CH₂CH₂—.

R₁₁ as C₅-C₁₂cycloalkyl is, for example, cyclopentyl, cyclohexyl, cycloheptyl, cyclooctyl, cyclononyl, cyclodecyl, cycloundecyl or cyclododecyl. Preference is given to cyclohexyl.

R₁₁ as C₅-C₁₂cycloalkenyl is, for example, cyclopentenyl, cyclohexenyl, cycloheptenyl, cyclooctenyl, cyclononenyl, cyclodecenyl, cycloundecenyl or cyclododecenyl. Preference is given to cyclohexenyl.

R₁₁ as a polymerizable group is, for example,

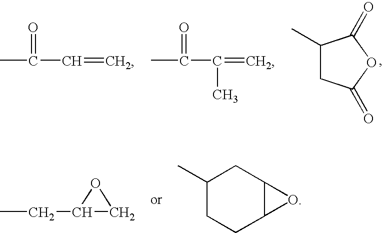

R₁₁ as a polymer is the polymerization product when a polymerizable group, as for example outlined above, is polymerized.

R₁₁ is preferably C₁-C₂₅alkyl which is unsubstituted or substituted by hydroxyl, and is uninterrupted or interrupted by —O—, —S—, —NH—, —CO—, —O—CO— or —CO—O—, especially by —NH—, —CO—, —O—CO— or —CO—O—,

or R₁₁ is a polyethylene glycol, polypropylene glycol or polyacrylate group which is bound via C₁-C₂₅alkylene, which in turn may be bound and/or be interrupted by at least one of the radicals selected from the group consisting of —O—, —S—, —NH—, —CO—, —O—CO— or —CO—O—, especially by —NH—, —CO—, —O—CO— or —CO—O—.

More preferably R₁₁ is C₁-C₁₂alkyl; C₁-C₁₂alkyl which is substituted by hydroxy; C₁-C₁₂alkyl which is substituted by a polymerizable group, like those given above; C₂-C₂₅alkyl which is interrupted by —NH—, —CO—, —O—CO— or —CO—O— and which is optionally substituted by hydroxy; or a polyethylene glycol, polypropylene glycol or polyacrylate group which is bound via C₁-C₂₅alkylene, which in turn may be bound and/or be interrupted by at least one of the radicals selected from the group consisting of —NH—, —CO—, —O—CO— or —CO—O—. It is preferred that the polymer is bound to the alkylene radical via —O—CO—. As to the alkylene it is preferred that it is bound directly to the Si atom indicated in formula (16). Furthermore, it is preferred that the alkylene is interrupted by at least one of —O—, —S—, —NH—, —CO—, —O—CO— or —CO—O—, especially by —NH—, —CO—, —O—CO— or —CO—O—, and more preferably by —NH—, —O—CO— or —CO—O—.

According to a further embodiment of the present invention the functionalized nanoparticles comprise on the surface, in addition to the radical of formula (I) or in addition to the radicals of formulae (1) and (16), a covalently bound radical of formula

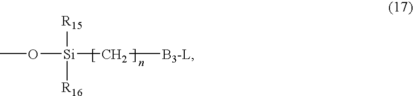

wherein
the nanoparticles are SiO₂, Al₂O₃ or mixed SiO₂ and Al₂O₃ nanoparticles,
R₁₅ and R₁₆ are independently of each other hydrogen, nanoparticle surface-O—, or a substituent,
n is 1, 2, 3, 4, 5, 6, 7 or 8,
B₃ is the direct bond or a bridge member, and
L is the residue of a stabilizer.

As to R₁₅ and R₁₆ the definitions and preferences given hereinbefore for R₁ and R₂ apply.

n is preferably 2, 3 or 4, especially 3.

B₃ is, for example, the direct bond, or C₁-C₂₅alkylene, which may be bound and/or be interrupted by at least one of the radicals selected from the group consisting of —O—, —S—, —N(R₃)—, —CO—, —O—CO—, —CO—O—, —N(R₃)—CO— and —CO—N(R₃)—, wherein R₃ is hydrogen, C₁-C₈alkyl or hydroxyl-substituted C₁-C₈alkyl. Preferably, R₃ is hydrogen or C₁-C₄alkyl, especially hydrogen.

Preferably, B₃ is C₁-C₂₅alkylene, which may be bound and/or be interrupted by at least one of the radicals selected from the group consisting of —O—, —S—, —NH—, —CO—, —O—CO—, —CO—O—, —NH—CO— and —CO—NH—.

Highly preferred meanings for B₃ are bridge members of the formula -A₄-C₁-C₂₅alkylene-A₅-, wherein the C₁-C₂₅alkylene can be uninterrupted or be interrupted as given above and A₄ and A₅ are the direct bond or radicals as given above. Preferred meanings for A₄ are —O—, —S—, —NH—, —NH—CO— or —O—CO—, especially —NH— or —NH—CO—, and more preferably —NH—. Preferred meanings for A₅ are the direct bond, —O—, —S—, —NH—, —CO—O— or —CO—NH—, especially the direct bond, —O—, —CO—O— or —CO—NH—. As to the C₁-C₂₅alkylene it is preferred that it is uninterrupted or interrupted by at least one of the radicals selected from the group consisting of —O—, —NH—, —CO—, —CO—O— and —CO—NH—, especially —O—, —NH— and —CO—O—, and more preferably by —CO—O—.

Examples for B₃ are —NH—CO—(CH₂)₁₋₆—, —NH—(CH₂)₁₋₆—CO—O—(CH₂)₁₋₆—, —NH—CO—(CH₂)₁₋₆—CO—NH—, —NH—CO—(CH₂)₁₋₆—CO—O— or —NH—(CH₂)₁₋₆—CO—O—(CH₂)₁₋₆—O—.

L is preferably selected from the group consisting of sterically hindered amines, 2-hydroxyphenyl benzotriazoles, 2-hydroxyphenylbenzophenones, oxalanilides, 2-hydroxyphenyl-4,6-diaryltriazines, or sterically hindered phenol types.

More preferably, L is a radical of formula

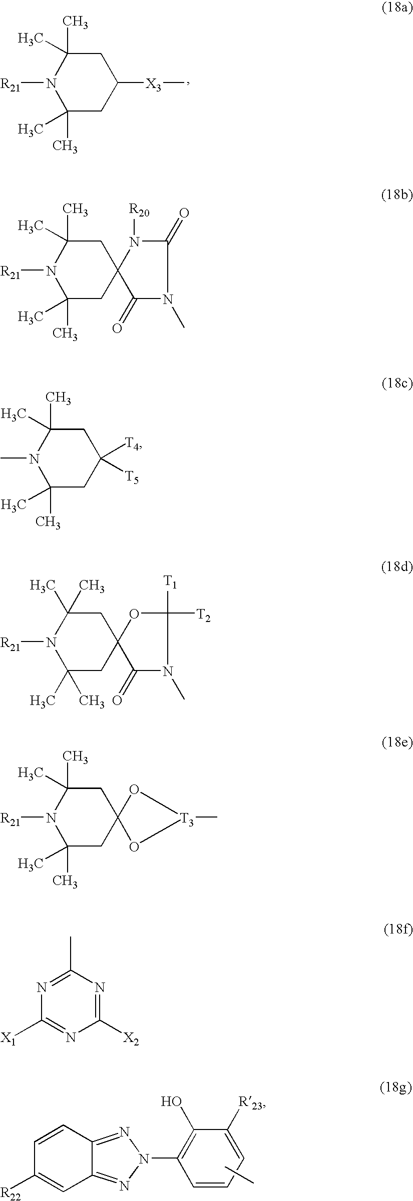

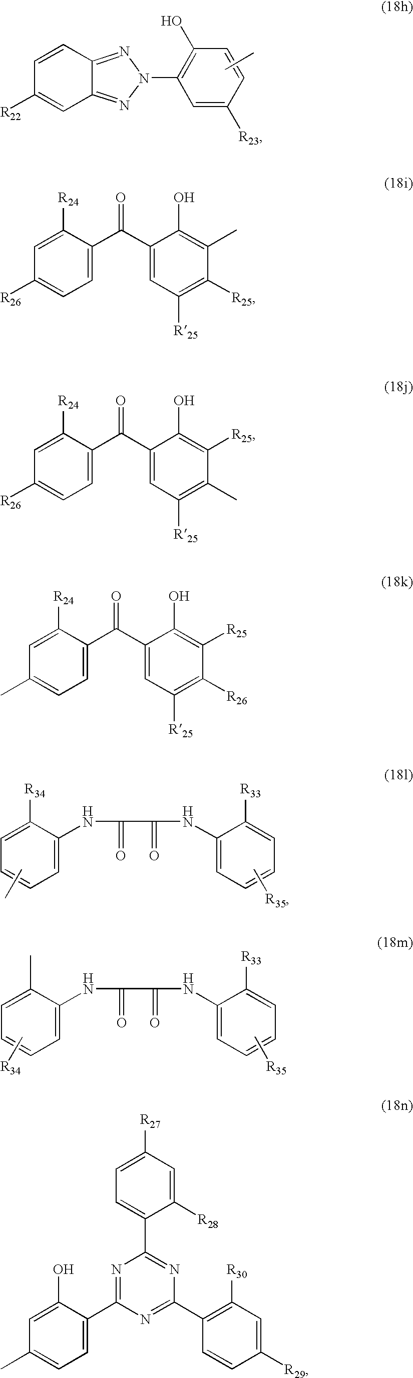

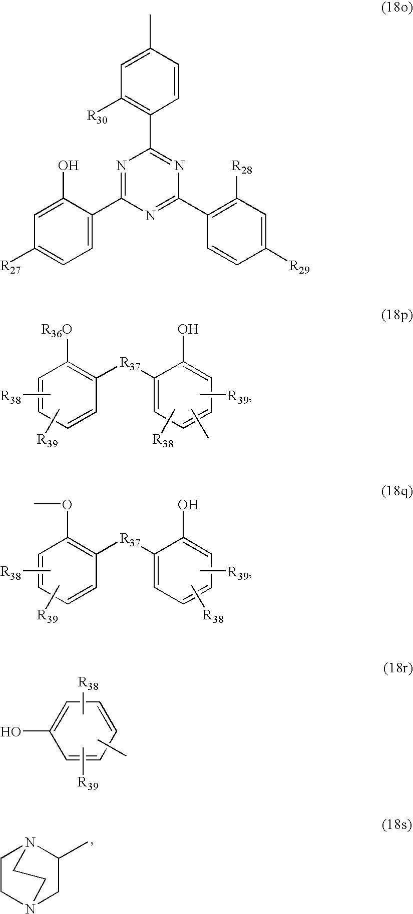

wherein
R₂₀ is H, C₁-C₁₈alkyl, C₇-C₁₁phenylalkyl, C₂-C₆alkoxyalkyl or C₅-C₁₂cycloalkyl;
R₂₁ is hydrogen, oxyl, hydroxyl, C₁-C₁₈alkyl, C₃-C₈alkenyl, C₃-C₈alkynyl, C₇-C₁₂aralkyl, C₁-C₁₈alkoxy, C₁-C₁₈hydroxyalkoxy, C₅-C₁₂cycloalkoxy, C₇-C₉phenylalkoxy, C₁-C₈alkanoyl, C₃-C₅alkenoyl, C₁-C₁₈alkanoyloxy, benzyloxy, glycidyl or a group —CH₂CH(OH)-G, in which G is hydrogen, methyl or phenyl,
R₂₂ is H, Cl, C₁-C₄alkyl or C₁-C₄alkoxy;
R₂₃ is C₁-C₁₂alkyl;
R′₂₃ is H or C₁-C₁₂alkyl;

### R₂₄ is H or OH;

R₂₅ is H, Cl, OH or C₁-C₁₈alkoxy;
R′₂₅ is H, Cl or C₁-C₄alkyl;
R₂₆ is H, Cl, OH or C₁-C₁₈alkoxy;
R₂₇ and R₂₉, independently of one another, are H, OH, Cl, CN, phenyl, C₁-C₆alkyl, C₁-C₁₈alkoxy, C₄-C₂₂alkoxy which is interrupted by O and/or substituted by OH, or are C₇-C₁₄phenylalkoxy; and
R₂₈ and R₃₀, independently of one another, are H, OH, Cl, C₁-C₆alkyl or C₁-C₆-alkoxy;
R₃₁ and R′₃₁, independently of one another, have one of the meanings indicated for R₂₀ or together form tetramethylene or -oxamethylene or pentamethylene or -oxamethylene;
R₃₂ is C₁-C₁₈alkyl, C₂-C₄alkenyl or phenyl;
R₃₃, R₃₄ and R₃₅, independently of one another, are H, C₁-C₁₈alkyl or C₁-C₁₈-alkoxy;
R₃₆ is hydrogen or

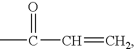

R₃₇ is C₁-C₄alkylene,
R₃₈ and R₃₉ are each independently of the other hydrogen, C₁-C₁₈alkyl, C₇-C₉phenylalkyl, phenyl or C₅-C₈cycloalkyl,
T₁ and T₂, independently of one another, are hydrogen, C₁-C₁₈alkyl, phenyl-C₁-C₄-alkyl or unsubstituted or halogen- or C₁-C₄alkyl-substituted phenyl or naphthyl or T₁ and T₂, together with the carbon atom connecting them, form a C₅-C₁₂cycloalkane ring,
T₃ is C₂-C₈alkanetriyl,
T₄ is hydrogen, C₁-C₁₈alkoxy, C₃-C₈alkenyloxy or benzyloxy, and
T₅ has the same meaning as T₄, or T₄ and T₅ together are —O—C₂-C₈alkylene-O—, or T₅, if T₄ is hydrogen, is —OH or —NR₂₀—CO—R₃₂;
X₁ is a group of the formula (18a) and
X₂ has the same meaning as X₁ or is C₁-C₁₈alkoxy or —NR₃₁R′₃₁;
X₃ is the direct bond, —NR₂₀—, —NX₆— or —O—, or is a radical of the formula —O—CO—X₅—CO—O—X₆, where
X₅ is C₁-C₁₂alkanetriyl and
X₆ is a radical of the formula

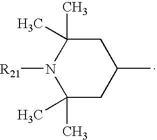

Of special interest are functionalized nanoparticles comprising on the surface at least a radical of the formula (1) and at least one radical of formula (16). Important are functionalized nanoparticles comprising on the surface at least a radical of the formula (I) and at least one radical of formula (17). Highly interesting are functionalized nanoparticles comprising on the surface at least a radical of the formula (1) and at least one radical of formula (16) and at least one radical of formula (17).

It is preferred that the radicals of formulae (1), (16) and (17) are directly bonded to the nanoparticles and that there is no further bridge member.

Furthermore, the present invention is directed to functionalized nanoparticles comprising on the surface a covalently bound radical of formula

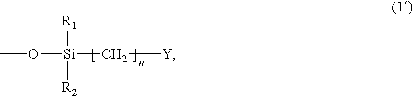

wherein
the nanoparticles are SiO₂, Al₂O₃ or mixed SiO₂ and Al₂O₃ nanoparticles,
R₁ and R₂ are independently of each other hydrogen, nanoparticle surface-O—, or a substituent,
n is 1, 2, 3, 4, 5, 6, 7 or 8, and
Y is a radical of formula

—B₁D₁′ (2′),

wherein
B₁ is the direct bond or a bridge member, and
D₁′ is the radical of a fluorescent perylene dye,
and wherein the functionalized nanoparticles comprise on the surface additionally a covalently bound radical of the formula (16) or a radical of formula (17), preferably a radical of formula (16).

As to R₁, R₂, n, B₁ and the nanoparticles the definitions and preferences given before apply.

Preferred as radicals D₁′ are the following:

Radicals Derived from Perylene Dyes

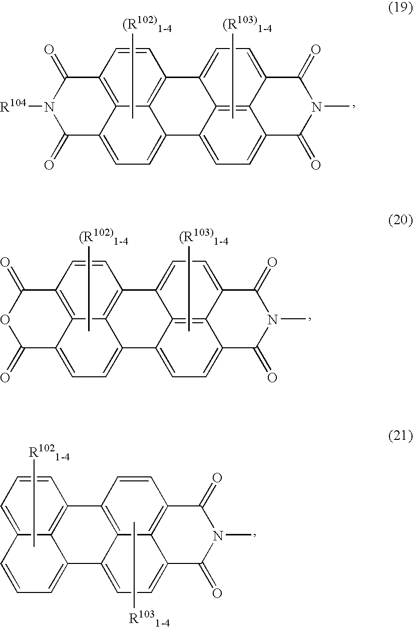

wherein
R¹⁰⁴ is hydrogen; C₁-C₂₅alkyl, which can be substituted by halogen, phenyl or naphthyl, whereby the phenyl or naphthyl can in turn be further substituted by C₁-C₈alkyl or C₁-C₈alkoxy; allyl which can be substituted one to three times with C₁-C₄alkyl; a C₅-C₇cycloalkyl group; a C₅-C₇cycloalkyl group, which can be condensed one or two times by phenyl which can be substituted one to three times with C₁-C₄-alkyl, halogen, nitro or cyano; a C₂-C₂₅alkenyl group which can be substituted by halogen; or a C₂-C₂₅alkynyl group which can be substituted by halogen,
R¹⁰² and R¹⁰³, independently of each other, are hydrogen; C₁-C₈alkyl; phenyl or naphthyl which can be substituted by C₁-C₈alkyl, C₁-C₈alkoxy or halogen; cyano; nitro; halogen; —OR¹⁰⁵; —COR¹⁰⁵; —COOR¹⁰⁵; —OCOR¹⁰⁵; —CONR¹⁰⁵R¹⁰⁶; —OCONR¹⁰⁵R¹⁰⁶; —NR¹⁰⁵R¹⁰⁶; —NR¹⁰⁵COR¹⁰⁶; —NR¹⁰⁵COOR¹⁰⁶; —NR¹⁰⁵SO₂R¹⁰⁶; —SO₂R¹⁰⁵; —SO₃R¹⁰⁶; —SO₂NR¹⁰⁵R¹⁰⁶ or —N═N—R¹⁰⁵; and R¹⁰⁵ and R¹⁰⁶ are each independently of the others hydrogen; C₁-C₈alkyl; or phenyl which can in turn be further substituted by C₁-C₈alkyl, C₁-C₈alkoxy or halogen.

R¹⁰⁴ is preferably C₁-C₂₅alkyl, which can be substituted by halogen, phenyl or naphthyl, whereby the phenyl or naphthyl can in turn be further substituted by C₁-C₈alkyl or C₁-C₈alkoxy. A highly preferred meaning for R¹⁰⁴ is C₁-C₂₅alkyl.

R¹⁰² and R¹⁰³ are preferably, independently of each other, hydrogen; C₁-C₈alkyl; phenyl or naphthyl which can be substituted by C₁-C₈alkyl, C₁-C₈alkoxy or halogen; cyano; nitro; halogen; amino; hydroxyl; or —COOR¹⁰⁵, wherein R¹⁰⁵ is as defined above. Highly preferred meanings for R¹⁰² and R¹⁰³ are hydrogen or —COOR¹⁰⁵.

Further interesting radicals derived from perylene dyes are the following:

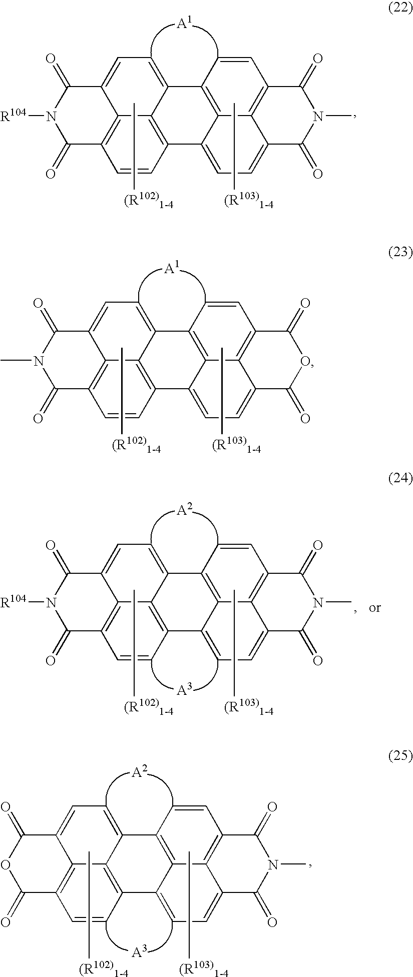

wherein
R¹⁰², R¹⁰³ and R¹⁰⁴ are as defined above, and
A¹ and A³ are each independently of the other —S—, —S—S—, —CH═CH—,
R¹⁰⁷OOC—C(−)=C(−)—COOR¹⁰⁷, —N═N— or —N(R¹⁰⁸)—, or a linkage selected from the group consisting of the organic radicals of formulae

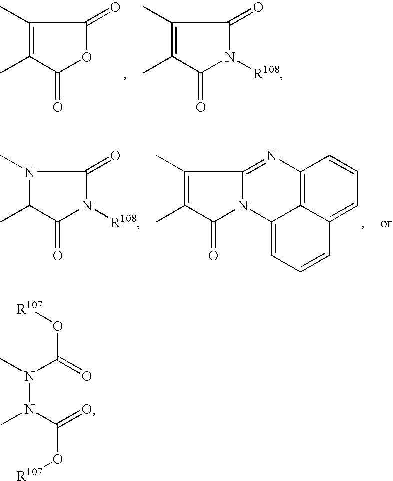

wherein
R¹⁰⁷ is hydrogen, C₁-C₂₄alkyl or C₁-C₂₄cycloalkyl,
R¹⁰⁸ is unsubstituted or substituted C₁-C₂₄alkyl, C₁-C₂₄cycloalkyl, phenyl, benzyl, —CO—C₁-C₄alkyl, —CO—C₆H₅ or C₁-C₄alkylcarboxylic acid (C₁-C₄alkyl)ester, and
A² is a linkage of formula

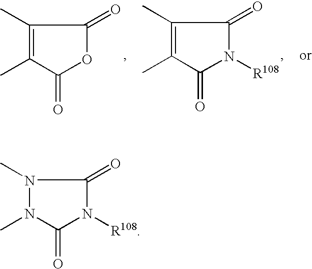

The functionalized nanoparticles according to the present invention have preferably a spherical shape.

The particle size of the nanoparticles is, for example, 10 to 1000 nm, preferably 10 to 500 nm, and more preferably 40 to 500 nm. Highly preferred is a particle size of 40 to 400 nm.

The organic content of the nanoparticles according to the present invention is, for example, 5 to 80 percent by weight, especially 10 to 70 percent by weight, based on the total weight of the nanoparticle.

Nanoparticles are typically silicon dioxide, aluminum oxide, a heterogeneous mixture thereof or silicon aluminum oxide as mixed oxides. The silicon aluminum oxide nanoparticles according to the present invention can show silicon contents in between 1 to 99 metal-atom %.

Relating to a specific application the expert would preferably use particles showing an index of refraction close to the matrix material. Using pure silicon dioxide (n_{D} 1.48 to 1.50) or pure aluminum oxide (n_{D} 1.61) or silicon aluminum oxides with the whole range of silicon to aluminum ratio covers material with an index of refraction from 1.48 to 1.61.

Unmodified nanoparticles are commercially available from different suppliers such as Degussa, Hanse Chemie, Nissan Chemicals, Clariant, H.C. Starck, Nanoproducts or Nyacol Nano Technologies as powder or as dispersions. Examples of commercially available silica nanoparticles are Aerosil® from Degussa, Ludox® from DuPont, Snowtex® from Nissan Chemical, Levasil® from Bayer, or Sylysia® from Fuji Silysia Chemical. Examples of commercially available Al₂O₃ nanoparticles are Nyacol® products from Nyacol Nano Technologies Inc., or Disperal® products from Sasol. The artisan is aware of different well-established processes to access particles in different sizes, with different physical properties and with different compositions such as flame-hydrolysis (Aerosil-Process), plasma-process, arc-process and hot-wall reactor-process for gas-phase or solid-phase reactions or ionic-exchange processes and precipitation processes for solution-based reactions. Reference is made to several references describing the detailed processes, such as EP-A-1 236 765, U.S. Pat. No. 5,851,507, U.S. Pat. No. 6,719,821, US-A-2004-178530 or U.S. Pat. No. 2,244,325, WO-A-05/026068, EP-A-1 048 617.

The preparation of the functionalized nanoparticles comprising on the surface at least a radical of the formula (1) can, for example, be carried out by the reaction of corresponding unmodified nanoparticles, like commercially available silica or Al₂O₃ nanoparticles, with a compound of the formula (1a)

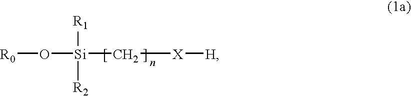

wherein
R₀ is C₁-C₂₅alkyl,
R₁ and R₂ are hydrogen or a substituent as defined above under formula (I),
n is as defined above under formula (1), and
X is a functional group, like —O—, —S— or —N(R₃)—, wherein
R₃ is hydrogen, C₁-C₈alkyl or hydroxyl-substituted C₁-C₈alkyl. Preferably, R₃ is hydrogen or C₁-C₄alkyl, especially hydrogen.

In a further step, the reaction product of the nanoparticles with the compound of formula (1a) can easily be derivatized to obtain nanoparticles comprising radicals of the formula (1) by known processes such as for example esterification, amidation, Michael addition or opening of epoxides.

The reaction of the compound of formula (1a) with the nanoparticles can be carried out in analogy to known processes. The reaction can, for example, be carried out in an organic medium, like ethanol, at elevated temperature. It is preferred to use a compound of formula (1a), wherein R₀ is methyl and R₁ and R₂ are methoxy.

According to an alternative process for the preparation of nanoparticles comprising radicals of formula (1) corresponding unmodified nanoparticles, like commercially available silica or Al₂O₃ nanoparticles, can be reacted with a compound of the formula (1b)

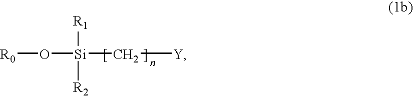

wherein R₀, R₁, R₂ and n are as defined above under formula (1a) and
Y is as defined above under formula (1).

The reaction of the compound of formula (1b) with silica or Al₂O₃ nanoparticles can be carried out in analogy to known processes. The reaction can, for example, be carried out in analogy to the preparation process described in WO-A-03/002652.

The radicals of formulae (16) and (17) can be introduced in analogy to the above preparation processes. These reactions can be carried out simultaneously with the introduction of the radical of formula (I), or stepwise.

The functionalized nanoparticles of the present invention are especially suitable for coloring organic materials, in particular synthetic polymers or coatings. By use of the nanoparticles a high colour depth and, in case of fluorescent dyes, a high fluorescence can be obtained. In addition, the dyes show good properties with respect to migration and a good photostability and thermal stability. In case the nanoparticles contain in addition the light stabilizer containing compound of formula (17) the stability can be further increased.

The nanoparticles of the present invention can, in addition, also act as stabilizing or flame-retarding and/or compatibilizing agents for organic materials, in particular synthetic polymers or coatings.

Examples of Organic Materials are

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(II) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (lonomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stepreoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethyllene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimids, polyesterimids, polyhydantoins and polybenzimidazoles.

18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.

19. Polycarbonates and polyester carbonates.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins and melamine/formaldehyde resins.

23. Drying and non-drying alkyd resins.

24. Unsaturated polyester resins derived from copolyesters of saturated and unsaturated dicarboxylic acids with polyhydric alcohols and vinyl compounds as crosslinking agents, and also halogen-containing modifications thereof of low flammability.

25. Crosslinkable acrylic resins derived from substituted acrylates, for example epoxy acrylates, urethane acrylates or polyester acrylates.

26. Alkyd resins, polyester resins and acrylate resins crosslinked with melamine resins, urea resins, isocyanates, isocyanurates, polyisocyanates or epoxy resins.

27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

30. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.

31. Aqueous emulsions of natural or synthetic rubber, e.g. natural latex or latices of carboxylated styrene/butadiene copolymers.

32. Pre-polymeric monomers or oligomers of the aforementioned polymers or blends.

33. Sols, especially organosols, as stable liquid suspensions of colloidal nano-particles in a diluent, a reactive (e.g. crosslinking) diluent or in a polymerizable or crosslinking monomer, or in a mixture of all.

The present invention relates therefore also to a composition comprising: an organic material (component (a)), and

functionalized nanoparticles according to the present invention (component (b)).

Preferred organic materials are polymers, for example a pre-polymer for a nanocomposite material, in particular synthetic polymers, for example thermoplastic polymers. Polyamides, polyurethanes and polyolefins are particularly preferred. Examples of preferred polyolefins are polypropylene or polyethylene.

Of special interest are also compositions wherein the composition is a coating composition and component (a) is an organic film-forming binder.

Of special interest are transparent coating compositions which after curing lead to transparent coatings.

The coating composition is preferably a coating material or paint, especially an aqueous coating material or an aequeous paint.

Examples of coating materials are lacquers, paints or varnishes. These always contain an organic film-forming binder in addition to other, optional components.

Preferred organic film-forming binders are epoxy resins, polyurethane resins, amino resins, acrylic resins, acrylic copolymer resins, polyvinyl resins, phenolic resins, styrene/butadiene copolymer resins, vinyl/acrylic copolymer resins, polyester resins, UV-curable resins or alkyd resins, or a mixture of two or more of these resins, or an aqueous basic or acidic dispersion of these resins or mixtures of these resins, or an aqueous emulsion of these resins or mixtures of these resins.

Of particular interest are organic film-forming binders for aqueous coating compositions, such as, for example, alkyd resins; acrylic resins, two-component epoxy resins; polyurethane resins; polyester resins, which are usually saturated; water-dilutable phenolic resins or derived dispersions; water-dilutable urea resins; resins based on vinyl/acrylic copolymers; and hybrid systems based on, for example, epoxy acrylates.

More specifically, the alkyd resins can be water-dilutable alkyd resin systems which can be employed in air-drying form or in the form of stoving systems, optionally in combination with water-dilutable melamine resins; the systems may also be oxidatively drying, air-drying or stoving systems which are optionally employed in combination with aqueous dispersions based on acrylic resins or copolymers thereof, with vinyl acetates, etc.

The acrylic resins can be pure acrylic resins, epoxy acrylate hybrid systems, acrylic acid or acrylic ester copolymers, combinations with vinyl resins, or copolymers with vinyl monomers such as vinyl acetate, styrene or butadiene. These systems can be air-drying systems or stoving systems.

In combination with appropriate polyamine crosslinkers, water-dilutable epoxy resins exhibit excellent mechanical and chemical resistance. If liquid epoxy resins are used, the addition of organic solvents to aqueous systems can be omitted. The use of solid resins or solid-resin dispersions usually necessitates the addition of small amounts of solvent in order to improve film formation.

Preferred epoxy resins are those based on aromatic polyols, especially those based on bis-phenols. The epoxy resins are employed in combination with crosslinkers. The latter may in particular be amino- or hydroxy-functional compounds, an acid, an acid anhydride or a Lewis acid. Examples thereof are polyamines, polyaminoamides, polysulfide-based polymers, polyphenols, boron fluorides and their complex compounds, polycarboxylic acids, 1,2-dicarboxylic anhydrides or pyromellitic dianhydride.

Polyurethane resins are derived from polyethers, polyesters and polybutadienes with terminal hydroxyl groups, on the one hand, and from aliphatic or aromatic polyisocyanates on the other hand.

Preferably, the polyurethanes are prepared in situ from polyethers, polyesters and polybutadienes with terminal hydroxyl groups, on the one hand, and from aliphatic or aromatic polyisocyanates on the other hand.

Examples of suitable polyvinyl resins are polyvinylbutyral, polyvinyl acetate or copolymers thereof.

Suitable phenolic resins are synthetic resins in the course of whose construction phenols are the principal component, i.e. in particular phenol-, cresol-, xylenol- and resorcinol-formaldehyde resins, alkylphenolic resins, and condensation products of phenols with acetaldehyde, furfurol, acrolein or other aldehydes. Modified phenolic resins are also of interest.

UV-(ultraviolet) curable resins may contain one or more olefinic double bonds. They may be of low (monomeric) or relatively high (oligomeric) molecular mass. Examples of monomers containing a double bond are alkyl or hydroxyalkyl acrylates or methacrylates, such as methyl, ethyl, butyl, 2-ethylhexyl or 2-hydroxyethyl acrylate, isobornyl acrylate, methyl methacrylate or ethyl methacrylate. Other examples are acryinitrile, acrylamide, methacrylamide, N-substituted (meth)acrylamides, vinyl esters such as vinyl acetate, vinyl ethers such as isobutyl vinyl ether, styrene, alkylstyrenes and halostyrenes, N-vinylpyrrolidone, vinyl chloride or vinylidene chloride.

Examples of monomers containing two or more double bonds are ethylene glycol, propylene glycol, neopentyl glycol, hexamethylene glycol and bisphenol A diacrylates, 4,4′-bis(2-acryl-oyloxyethoxy)diphenylpropane, trimethylolpropane triacrylate, pentaerythritol triacrylate or tetraacrylate, vinyl acrylate, divinylbenzene, divinyl succinate, diallyl phthalate, triallyl phosphate, triallyl isocyanurate or tris(2-acryloylethyl)isocyanurate.

Examples of relatively high molecular mass (oligomeric) polyunsaturated compounds are acrylated epoxy resin and acrylated or vinyl ether- or epoxy-functional polyesters, polyurethanes and polyethers. Further examples of unsaturated oligomers are unsaturated polyester resins, generally prepared from maleic acid, phthalic acid and one or more diols and having molecular weights of from about 500 to 3000. In addition to these it is also possible to use vinyl ether monomers and oligomers, and also maleate-terminated oligomers with polyesters, polyurethane, polyether, polyvinyl ether and epoxide main chains. Especially suitable are combinations of polymers and oligomers which carry vinyl ether groups, as described in WO-A-90/01512. Also suitable, however, are copolymers of monomers functionalized with maleic acid and vinyl ether.

Also suitable are compounds containing one or more free-radically polymerizable double bonds. In these compounds the free-radically polymerizable double bonds are preferably in the form of (meth)acryloyl groups. (Meth)acryloyl and, respectively, (meth)acrylic here and below means acryloyl and/or methacryloyl, and acrylic and/or methacrylic, respectively. Preferably, at least two polymerizable double bonds are present in the molecule in the form of (meth)acryloyl groups. The compounds in question may comprise, for example, (meth)acryloyl-functional oligomeric and/or polymeric compounds of poly(meth)acrylate. The number-average molecular mass of this compound may be for example from 300 to 10 000, preferably from 800 to 10 000. The compounds preferably containing free-radically polymerizable double bonds in the form of (meth)acryloyl groups may be obtained by customary methods, for example by reacting poly(meth)acrylates with (meth)acrylic acid. These and other preparation methods are described in the literature and are known to the person skilled in the art. Unsaturated oligomers of this kind may also be referred to as prepolymers.

Functionalized acrylates are also suitable. Examples of suitable monomers which are normally used to form the backbone (the base polymer) of such functionalized acrylate and methacrylate polymers are acrylate, methyl acrylate, methyl methacrylate, ethyl acrylate, ethyl methacrylate, n-butyl acrylate, n-butyl methacrylate, isobutyl acrylate, isobutyl methacrylate, 2-ethylhexyl acrylate, 2-ethylhexyl methacrylate etc. Additionally, appropriate amounts of functional monomers are copolymerized during the polymerization in order to give the functional polymers. Acid-functionalized acrylate or methacrylate polymers are obtained using acid-functional monomers such as acrylic acid and methacrylic acid. Hydroxy-functional acrylate or methacrylate polymers are formed from hydroxy-functional monomers, such as 2-hydroxyethyl methacrylate, 2-hydroxypropyl methacrylate and 3,4-dihydroxybutyl methacrylate. Epoxy-functionalized acrylate or methacrylate polymers are obtained using epoxy-functional monomers such as glycidyl methacrylate, 2,3-epoxybutyl methacrylate, 3,4-epoxybutyl methacrylate, 2,3-epoxycyclohexyl methacrylate, 10,11-epoxyundecyl methacrylate etc. Similarly, for example, isocyanate-functionalized polymers may be prepared from isocyanate-functionalized monomers, such as metaisopropenyl-α,α-dimethylbenzyl isocyanate, for example.

Particularly suitable compounds are, for example, esters of ethylenically unsaturated monofunctional or polyfunctional carboxylic acids and polyols or polyepoxides, and polymers containing ethylenically unsaturated groups in the chain or in side groups, such as unsaturated polyesters, polyamides and polyurethanes and copolymers thereof, alkyd resins, polybutadiene and butadiene copolymers, polyisoprene and isoprene copolymers, polymers and copolymers containing (meth)acrylic groups in side chains, and also mixtures of one or more such polymers.

Examples of suitable monofunctional or polyfunctional unsaturated carboxylic acids are acrylic acid, methacrylic acid, crotonic acid, itaconic acid, cinnamic acid, maleic acid, fumaric acid, unsaturated fatty acids such as linolenic acid or oleic acid. Acrylic acid and methacrylic acid are preferred.

It is, however, also possible to use saturated dicarboxylic or polycarboxylic acids in a mixture with unsaturated carboxylic acids. Examples of suitable saturated dicarboxylic or polycarboxylic acids include tetrachlorophthalic acid, tetrabromophthalic acid, phthalic acid, trimellitic acid, heptanedicarboxylic acid, sebacic acid, dodecanedicarboxylic acid, hexahydrophthalic acid, etc.

Suitable polyols include aromatic and especially aliphatic and cycloaliphatic polyols. Preferred Examples of aromatic polyols are hydroquinone, 4,4′-dihydroxybiphenyl, 2,2-di(4-hydroxyphenyl)propane, and also novolaks and resols. Examples of polyepoxides are those based on the aforementioned polyols, especially the aromatic polyols, and epichlorhydrin. Further suitable polyols include polymers and copolymers containing hydroxyl groups in the polymer chain or in side groups, such as polyvinyl alcohol and copolymers thereof or polyhydroxyalkyl methacrylates or copolymers thereof, for example. Oligoesters containing hydroxyl end groups are further suitable polyols.

Examples of aliphatic and cycloaliphatic polyols are alkylenediols having preferably from 2 to 12 carbon atoms, such as ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols having molecular weights of preferably from 200 to 1500, 1,3-cyclopentanediol, 1,2-, 1,3- or 1,4-cyclohexanediol, 1,4-dihydroxymethylcyclohexane, glycerol, tris(β-hydroxyethyl)amine, trimethylolethane, trimethylolpropane, pentaerythritol, dipentaerythritol and sorbitol.

The polyols may have been partly or fully esterified with one or more different unsaturated carboxylic acids, the free hydroxyl groups in partial esters possibly having been modified, e.g. etherified or esterified with other carboxylic acids. Examples of such esters are for example trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol trisitaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, modified pentaerythritol triacrylate, sorbitol tetramethacrylate, sorbitol pentaacrylate, sorbitol hexaacrylate, oligoester acrylates and methacrylates, glycerol diacrylate and triacrylate, 1,4-cyclohexane diacrylate, bisacrylates and bismethacrylates of polyethylene glycol having a molecular weight from 200 to 1500, or mixtures thereof.

Suitable UV-curable resins include the amides of identical or different unsaturated carboxylic acids with aromatic, cycloaliphatic and aliphatic polyamines having preferably from 2 to 6, particularly from 2 to 4 amino groups. Examples of such polyamines are ethylenediamine, 1,2- or 1,3-propylenediamine, 1,2-, 1,3- or 1,4-butylenediamine, 1,5-pentylenediamine, 1,6-hexylenediamine, octylenediamine, dodecylenediamine, 1,4-diaminocyclohexane, isophoronediamine, phenylenediamine, bisphenylenediamine, di-β-aminoethyl ether, diethylenetriamine, triethylenetetramine, di(β-aminoethoxy)- or di(β-aminopropoxy)ethane. Further suitable polyamines are polymers and copolymers containing possibly additional amino groups in the side chain, and oligoamides having amino end groups. Examples of such unsaturated amides are: methylenebisacrylamide, 1,6-hexamethylenebisacrylamide, diethylenetriaminetrismethacrylamide, bis(methacrylamidopropoxy)ethane, β-methacrylamidoethyl methacrylate, and N-[(β-hydroxyethoxy)ethyl]acrylamide.

Suitable unsaturated polyesters and polyamides are derived, for example, from maleic acid and diols or diamines. The maleic acid may have been replaced in part by other dicarboxylic acids. They may be used together with ethylenically unsaturated comonomers, e.g. styrene. The polyesters and polyamides may also be derived from dicarboxylic acids and ethylenically unsaturated diols or diamines, especially from relatively long chain ones having, for example, from 6 to 20 carbon atoms. Examples of polyurethanes are those synthesized from saturated or unsaturated diisocyanates and unsaturated or saturated diols, respectively.

Polybutadiene and polyisoprene and copolymers thereof are known. Examples of suitable comonomers are olefins such as ethylene, propene, butene, hexene, (meth)acrylates, acrylonitrile, styrene or vinyl chloride. Polymers containing (meth)acrylate groups in the side chain are likewise known. They may comprise, for example, reaction products of novolak-based epoxy resins with (meth)acrylic acid, homopolymers or copolymers of vinyl alcohol or the hydroxyalkyl derivatives thereof that have been esterified with (meth)acrylic acid, or homopolymers and copolymers of (meth)acrylates esterified with hydroxyalkyl (meth)acrylates.

The UV-curable resins may be used alone or in any desired mixtures. Preference is given to using mixtures of polyol (meth)acrylates.

It is also possible to add binders to the compositions of the invention, which is especially appropriate when the photopolymerizable compounds are liquid or viscous substances. The amount of the binder can be for example 5-95, preferably 10-90 and especially 40-90% by weight, based on the overall solids. The choice of binder is made depending on the field of use and the properties required for that field, such as developability in aqueous and organic solvent systems, adhesion to substrates, and oxygen sensitivity, for example.

The unsaturated compounds may also be used in a mixture with non-photopolymerizable film-forming components. These may be, for example, physically drying polymers or their solutions in organic solvents, such as nitrocellulose or cellulose acetobutyrate, for example. They may also, however, be chemically and/or thermally curable resins, such as polyisocyanates, polyepoxides or melamine resins, for example. By melamine resins are meant not only condensates of melamine (1,3,5-triazine-2,4,6-triamine) but also those of melamine derivatives. In general, the components comprise a film-forming binder based on a thermo-plastic or thermosettable resin, predominantly on a thermosettable resin. Examples thereof are alkyd, acrylic, polyester, phenolic, melamine, epoxy and polyurethane resins and mixtures thereof. The additional use of thermally curable resins is of importance for use in what are known as hybrid systems, which may be both photopolymerized and also thermally crosslinked.

Component (a) may comprise, for example, a coating composition comprising (al) compounds containing one or more free-radically polymerizable double bonds and further containing at least one other functional group which is reactive in the sense of an addition reaction and/or condensation reaction (examples have been given above), (a2) compounds containing one or more free-radically polymerizable double bonds and further containing at least one other functional group which is reactive in a sense of an addition reaction and/or condensation reaction, the additional reactive functional group being complementary to or reactive toward the additional reactive functional groups of component (a1), (a3) if desired, at least one monomeric, oligomeric and/or polymeric compound containing at least one functional group which is reactive in the sense of an addition reaction and/or condensation reaction toward the functional groups from component (al) or component (a2) that are present in addition to the free-radically polymerizable double bonds.

Component (a2) carries in each case the groups which are reactive toward or complementary to component (a1). In this context it is possible in each case for different kinds of functional groups to be present in one component. In component (a3) there is a further component available containing functional groups which are reactive in the sense of addition reactions and/or condensation reactions and which are able to react with the functional groups of (al) or (a2) that are present in addition to the free-radically polymerizable double bonds. Component (a3) contains no free-radically polymerizable double bonds. Examples of such combinations of (a1), (a2), (a3) can be found in WO-A-99/55785. Examples of suitable reactive functional groups are selected, for example, from hydroxyl, isocyanate, epoxide, anhydride, carboxyl or blocked amino groups. Examples have been described above.

Preferably, component (b) is added to the organic material in an amount from 0.01 to 80%, in particular 1 to 50%, for example 2 to 20%, relative to the weight of the organic material.

The compositions according to the invention can contain, in addition to components (a) and (b), additional additives, for example, from the group consisting of pigments, dyes, fillers, flow control agents, dispersants, thixotropic agents, adhesion promoters, antioxidants, light stabilizers and curing catalysts such as, for example, the following:

### 1. Antioxidants

1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutyl phenol, 2,6-dicyclopentyl-4-methyl phenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

1.2. Alkylthiomethyl phenols, for example 2,4-dioctylthiomethyl-6-tert-butylphenol, 2,4-dioctylthiomethyl-6-methylphenol, 2,4-dioctylthiomethyl-6-ethyl phenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl)adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2, 2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methyl phenol), 4,4′-thiobis(3,6-di-sec-amyl phenol), 4,4′-bis(2,6-dimethyl-4-hydroxyphenyl)-disulfide.

1.6. Alkylidenebisphenols, for example 2, 2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methyllenebis(2,6-di-tert-butylphenol), 4,4′-methylenebis(6-tert-butyl-2-methyl phenol), 1,1-bis(5-tert-butyl-4-hydroxy-2-methylphenyl)butane, 2,6-bis(3-tert-butyl-5-methyl-2-hydroxybenzyl)-4-methyl phenol, 1,1,3-tris(5-tert-butyl-4-hydroxy-2-methyl phenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methyl phenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra-(5-tert-butyl-4-hydroxy-2-methyl phenyl)pentane.

1.7. O-, N- and S-benzyl compounds, for example 3, 5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzyl mercaptoacetate, tris(3,5-di-tert-butyl-4-hydroxybenzyl)amine, bis(4-tert-butyl-3-hydroxy-2,6-dimethyl benzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecyl mercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris(3,5-di-tert-butyl-4-hydroxy-benzyl)-2,4,6-trimethylbenzene, 1,4-bis(3,5-di-tert-butyl-4-hydroxybenzyl)-2,3,5,6-tetramethyl benzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethyl benzyl)isocyanurate, 2,4,6-tris-(3,5-di-tert-butyl-4-hydroxyphenylethyl)-1,3,5-triazine, 1,3,5-tris(3,5-di-tert-butyl-4-hydroxyphenyl propionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methyl benzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethyllene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tertbutyl-4-hydroxy-5-methylphenyl)propionyloxy}-1,1-dimethylethyl]-2,4,8,10-tetraoxaspiro[5.5]-undecane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tertbutyl-4-hydroxyphenyl propionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N N′-bis[2-(3-[3,5-di-tert-butyl-4-hydroxyphenyl]propionyloxy)ethyl]oxamide (Naugard®XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyidiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyidiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylamino-methylphenol, 2,4′-diaminodiphenylmethane, 4,4′-diaminodiphenylmethane, N,N,N′,N′-tetramethyl-4,4′-diaminodiphenyl methane, 1,2-bis[(2-methyl phenyl)amino]ethane, 1,2-bis(phenyl-amino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyidiphenylamines, a mixture of mono- and dialkylated nonyidiphenylamines, a mixture of mono- and dialkylated dodecyldiphenylamines, a mixture of mono- and dialkylated isopropyl/isohexyl-diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

### 2. UV Absorbers and Light Stabilizers

2.1. 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethyl hexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenyl benzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₁—COO—CH₂CH₂₂, where R=3′-tert-butyl-4′-hydroxy-5′-2H-benzotriazol-2-ylphenyl, 2-[2′-hydroxy-3′-(α,α-dimethyl benzyl)-5′-(1,1,3,3-tetra methyl butyl)-phenyl]benzotriazole; 2-[2′-hydroxy-3′-(1,1,3,3-tetramethylbutyl)-5′-(α,α-dimethylbenzyl)-phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butyl phenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N-(β-carbomethoxy-β-cyanovinyl)-2-methyindoline, neopentyl tetra(α-cyano-β,β-di-phenylacrylate.

2.5. Nickel compounds, for example nickel complexes of 2,2′-thio-bis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tertoctylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearoyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethyl piperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethyl hexanoyl)oxymethyl-3,3,5-trimethyl-2-morpholinone, Sanduvor (Clariant; CAS Reg. No. 106917-31-1], 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethyl piperazine-3-one-4-yl)amino)-s-triazine.

2.7. Oxamides, for example 4, 4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethyl phenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethyl-phenyl)-1,3,5-triazine, 2-(2-hydroxy-4-hexyloxy)phenyl-4,6-diphenyl-1,3,5-triazine, 2-(2-hydrooxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenylalkyl phosphites, phenyldialkyl phosphites, tris(nonylphenyl)phosphite, trilauryl phosphite, trioctadecyl phosphite, distearylpentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

5. Hydroxylamines, for example N,N-dibenzyl hydroxylamine, N,N-diethyl hydroxylamine, N,N-dioctylhydroxylamine, N,N-dilaurylhydroxylamine, N,N-ditetradecyl hydroxylamine, N,N-dihexadecylhydroxylamine, N,N-dioctadecyl hydroxylamine, N-hexadecyl-N-octadecylhydroxy-ylamine, N-heptadecyl-N-octadecylhydroxylamine, N,N-dialkyl hydroxylamine derived from hydrogenated tallow amine.

6. Nitrones, for example, N-benzyl-alpha-phenylnitrone, N-ethyl-alpha-methylnitrone, N-octyl-alpha-heptyinitrone, N-lauryl-alpha-undecylnitrone, N-tetradecyl-alpha-tridecylnnitrone, N-hexadecyl-alpha-pentadecyl nitrone, N-octadecyl-alpha-heptadecyl nitrone, N-hexadecyl-alpha-heptadecyl nitrone, N-ocatadecyl-alpha-pentadecyl nitrone, N-heptadecyl-alpha-hepta-decylnitrone, N-octadecyl-alpha-hexadecyl nitrone, nitrone derived from N,N-dialkylhydroxyl-amine derived from hydrogenated tallow amine.

7. Thiosynergists, for example dilauryl thiodipropionate, dimistryl thiodipropionate, distearyl thiodipropionate or distearyl disulfide.

8. Peroxide scavengers, for example esters of β-thiodipropionic acid, for example the lauryl, stearyl, myristyl or tridecyl esters, mercaptobenzimidazole or the zinc salt of 2-mercapto-benzimidazole, zinc dibutyldithiocarbamate, dioctadecyl disulfide, pentaerythritol tetrakis(β-dodecyl mercapto)propionate.

9. Polyamide stabilizers, for example copper salts in combination with iodides and/or phosphorus compounds and salts of divalent manganese.

10. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyldibenzylidene)sorbitol, and 1,3:2,4-di(benzylidene)sorbitol.

12. Fillers and reinforcing agents, for example calcium carbonate, silicates, glass fibres, glass beads, asbestos, talc, kaolin, mica, barium sulfate, metal oxides and hydroxides, carbon black, graphite, wood flour and flours or fibers of other natural products, synthetic fibers.

13. Other additives, for example plasticisers, lubricants, emulsifiers, pigments, rheology additives, catalysts, flow-control agents, optical brighteners, flameproofing agents, antistatic agents and blowing agents.

14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butyl benzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butyl benzofuran-2-one, 3-(3,4-dimethylphenyl)-5,7-di-tert-butyl benzofuran-2-one, 3-(2,3-dimethyl phenyl)-5,7-di-tert-butyl benzofuran-2-one, 3-(2-acetyl-5-isooctyl phenyl)-5-isooctylbenzofuran-2-one.

The additional additives are added, for example, in concentrations of 0.01 to 10%, relative to the total weight of the material to be colored.

Incorporation of component (b) and, if desired, further additives into the polymeric, organic material is carried out by known methods, for example before or during moulding or else by applying the dissolved or dispersed compounds to the polymeric, organic material, if appropriate with subsequent slow evaporation of the solvent. Component (b) can also be added to the materials to be colored in the form of a masterbatch or a colloidal sol or organosol containing for example 5 to 50% by weight of component (b).

Component (b) can also be added before or during polymerisation or before crosslinking.

Component (b) can be incorporated into the material to be colored in pure form or encapsulated in waxes, oils or polymers.

Component (b) can also be sprayed onto the material to be colored.

The materials thus treated as mentioned above can be used in various forms, for example as films, fibres, ribbons, moulded materials, profiles, coatings or as binders for paints, adhesives or cement.

A further embodiment of the present invention is the use of functionalized nanoparticles according to the present invention as coloring material for organic materials.

Furthermore, the present invention provides a process for coloring an organic material, which comprises incorporating therein, or applying thereto, functionalized nanoparticles according to the present invention.

A further embodiment of the present invention is the additional use of component (b) as reinforcer of coatings and improver of scratch resistance in coating compositions for surfaces.

The present invention also relates to a process for protecting a substrate, which comprises applying thereto a coating composition comprising components (a) and (b) and then drying and/or curing it.

In another embodiment, the invention also relates to a printing ink, printing ink concentrate or an ink-jet ink comprising the functionalized nanoparticles according to the present invention, advantageously in a concentration of from 0.01 to 75% by weight, preferably from 0.1 to 50% by weight, especially from 1 to 40% by weight, more especially from 1 to 25% by weight, based on the total weight of the printing ink or printing ink concentrate. It can be used, for example, for electrophotography, intaglio printing, flexographic printing, screen printing, offset printing or letterpress printing.

The printing ink is, for example, a liquid or paste-form dispersion comprising the functionalized nanoparticle, binder and optionally solvent and/or optionally water and additives. In a liquid printing ink, the binder and, where applicable, the additives are generally dissolved in a solvent. Customary viscosities in the Brookfield viscometer are, for example, from 20 to 5000 mPa·s, for example from 20 to 1000 mPa·s, for liquid printing inks. For paste-form printing inks, the values range, for example, from 1 to 100 Pa·s, preferably from 5 to 50 Pa·s. The person skilled in the art will be familiar with the ingredients and compositions of printing inks.

Suitable printing inks are both solvent-based printing inks and water-based printing inks. Preference is given to water-based printing inks.

A suitable aqueous or solvent-based printing ink composition comprises, for example, the functionalized nanoparticle, a dispersant and a binder.

Dispersants that come into consideration include, for example, customary dispersants, such as water-soluble dispersants based on one or more arylsulfonic acid/formaldehyde condensation products or on one or more water-soluble oxalkylated phenols, non-ionic dispersants or polymeric acids.

The arylsulfonic acid/formaldehyde condensation products are obtainable, for example, by sulfonation of aromatic compounds, such as naphthalene itself or naphthalene-containing mixtures, and subsequent condensation of the resulting arylsulfonic acids with formaldehyde. Such dispersants are known and are described, for example, in U.S. Pat. No. 5,186,846 und DE-A-197 27 767. Suitable oxalkylated phenols are likewise known and are described, for example, in U.S. Pat. No. 4,218,218 und DE-A-197 27 767. Suitable non-ionic dispersants are, for example, alkylene oxide adducts, polymerisation products of vinylpyrrolidone, vinyl acetate or vinyl alcohol and co- or ter-polymers of vinyl pyrrolidone with vinyl acetate and/or vinyl alcohol. It is also possible, for example, to use polymeric acids, which act both as dispersants and as binders.

Examples of suitable binder components that may be mentioned include acrylate-group-containing, vinyl-group-containing and/or epoxy-group-containing monomers, prepolymers and polymers and mixtures thereof. Further examples are melamine acrylates and silicone acrylates. The acrylate compounds may also be non-ionically modified (e.g. provided with amino groups) or ionically modified (e.g. provided with acid groups or ammonium groups) and used in the form of aqueous dispersions or emulsions (e.g. EP-A-704 469, EP-A-12 339). Furthermore, in order to obtain the desired viscosity, the solventless acrylate polymers can be mixed with so-called reactive diluents, for example vinyl-group-containing monomers. Further suitable binder components are epoxy-group-containing compounds.

The printing inks may also, for example, comprise solubilisers, e.g. ε-caprolactam.

The printing inks may, inter alia for the purpose of adjusting the viscosity, comprise thickeners of natural or synthetic origin. Examples of thickeners include commercially available alginate thickeners, starch ethers or locust bean flour ethers, especially sodium alginate on its own or in admixture with modified cellulose, for example methyl-, ethyl-, carboxymethyl-, hydroxyethyl-, methylhydroxyethyl-, hydroxypropyl- or hydroxypropylmethyl-cellulose, especially having preferably from 20 to 25% by weight carboxymethylcellulose. Synthetic thickeners that may be mentioned are, for example, those based on poly(meth)acrylic acids or poly(meth)acrylamides.

The inks comprise such thickeners e.g. in an amount of from 0.01 to 2% by weight, especially from 0.01 to 1% by weight and preferably from 0.01 to 0.5% by weight, based on the total weight of the ink.

It is also possible for the inks to comprise buffer substances, for example borax, borate, phosphate, polyphosphate or citrate. Examples include borax, sodium borate, sodium tetraborate, sodium dihydrogen phosphate, disodium hydrogen phosphate, sodium tripolyphosphate, sodium pentapolyphosphate and sodium citrate. They are used especially in amounts of from 0.1 to 3% by weight, preferably from 0.1 to 1% by weight, based on the total weight of the ink, in order to establish a pH value of e.g. from 4 to 9, especially from 5 to 8.5.

As further additives, the printing inks may comprise surfactants or humectants. Surfactants that come into consideration include commercially available anionic and non-ionic surfactants. Humectants that come into consideration include, for example, polyhydric alcohols, polyalkylene glycols, urea, or a mixture of sodium lactate (advantageously in the form of a 50 to 60% aqueous solution) and glycerol and/or propylene glycol in amounts of e.g. from 0.1 to 30% by weight, especially from 2 to 30% by weight.

The printing ink compositions may also comprise as additional component, for example, an agent having a water-retaining action (humectant), e.g. polyhydric alcohols, polyalkylene glycols, which renders the compositions especially suitable for ink-jet printing.

Furthermore, the printing inks may also comprise customary additives, for example foam-reducing agents or especially substances that inhibit the growth of fungi and/or bacteria. Such additives are usually used in amounts of from 0.01 to 1% by weight, based on the total weight of the printing ink.

The inks may also comprise water-miscible organic solvents, for example C₁-C₄alcohols, e.g. methanol, ethanol, n-propanol, isopropanol, n-butanol, sec-butanol, tert-butanol or isobutanol; amides, e.g. dimethylformamide or dimethylacetamide; ketones or ketone alcohols, e.g. acetone, diacetone alcohol; ethers, e.g. tetrahydrofuran or dioxane; nitrogen-containing heterocyclic compounds, e.g. N-methyl-2-pyrrolidone or 1,3-dimethyl-2-imidazolidone, polyalkylene glycols, e.g. polyethylene glycol, or polypropylene glycol; C₂-C₆alkylene glycols and thioglycols, e.g. ethylene glycol, propylene glycol, butylene glycol, triethylene glycol, thiodiglycol, hexylene glycol and diethylene glycol; further polyols, e.g. glycerol or 1,2,6-hexanetriol; and C₁-C₄alkyl ethers of polyvalent alcohols, e.g. 2-methoxyethanol, 2-(2-methoxy-ethoxy)ethanol, 2-(2-ethoxyethoxy)ethanol, 2-[2-(2-methoxyethoxy)ethoxy]-ethanol or 2-[2-(2-ethoxyethoxy)ethoxy]ethanol; preferably N-methyl-2-pyrrolidone, diethylene glycol, glycerol or especially 1,2-propylene glycol, usually in an amount of from 2 to 30% by weight, especially from 5 to 30% by weight and preferably from 10 to 25% by weight, based on the total weight of the ink.

Examples of solvents that can be used in non-aqueous inks are alkyl carbitols, alkyl cellosolves, dialkylformamides, dialkylacetamides, alcohols, acetone, methyl ethyl ketone, diethyl ketone, methyl isobutyl ketone, diisopropyl ketone, dibutyl ketone, dioxane, ethyl butyrate, ethyl isovalerate, diethyl malonate, diethyl succinate, butyl acetate, triethyl phosphate, ethyl glycol acetate, toluene, xylene, Tetralin or petroleum ether fractions. Examples of solid waxes as solvents that, as ink vehicles, have to be heated first, are stearic or palmitic acid.

Furthermore, the inks according to the invention, especially when binder curing is to be effected by means of UV radiation, may comprise a photoinitiator which initiates the polymerisation.

Suitable photoinitiators for free radical photopolymerisations, that is to say the polymer-isation of acrylates and, if desired, vinyl compounds, are e.g. benzophenone and benzophenone derivatives, such as 4-phenylbenzophenone and 4-chlorobenzophenone, acetophenone derivatives, such as 1-benzoylcyclohexan-1-ol, 2-hydroxy-2,2-dimethylacetophenone and 2,2-dimethoxy-2-phenylacetophenone, benzoin and benzoin ethers, such as methyl, ethyl and butyl benzoin ethers, benzil ketals, such as benzil dimethyl ketal, 2-methyl-1-[4-(methylthio)phenyl]-2-morpholinopropan-1-one, acylphosphine oxides, such as 2,4,6-trimethylbenzoyidiphenylphosphine oxide and bisacylphosphine oxides.

Suitable photoinitiators for cationic photopolymerisations, that is to say the polymerisation of vinyl compounds or epoxy-group-containing compounds, are, for example, aryidiazonium salts, such as 4-methoxybenzenediazonium hexafluorophosphate, benzenediazonium tetrafluoroborate and toluenediazonium tetrafluoroarsenate, aryliodonium salts, such as diphenyliodonium hexafluoroarsenate, arylsulfonium salts, such as triphenylsulfonium hexafluorophosphate, benzene- and toluene-sulfonium hexafluorophosphate and bis[4-diphenylsulfonio-phenyl]sulfide-bis-hexafluorophosphate, disulfones, such as diphenyl disulfone and phenyl-4-tolyl disulfone, diazodisulfones, imidotriflates, benzoin tosylates, isoquinolinium salts, such as N-ethoxyisoquinolinium hexafluorophosphate, phenyl-pyridinium salts, such as N-ethoxy-4-phenylpyridinium hexafluorophosphate, picolinium salts, such as N-ethoxy-2-picolinium hexafluorophosphate, ferrocenium salts, and titanocenes.

When a photoinitiator is present in the ink compositions according to the invention, which is generally necessary for binder curing by UV radiation, the content thereof is generally from 0.1 to 10% by weight, preferably from 0.1 to 8% by weight.

Furthermore, the inks may also comprise customary additives, for example preservatives (such as glutaric dialdehyde and/or tetramethylolacetyleneurea), anti-oxidants, degassers/defoamers, viscosity regulators, flow improvers, anti-settling agents, gloss improvers, lubricants, adhesion promoters, anti-skin agents, matting agents, emulsifiers, stabilisers, hydrophobic agents, light stabilisers, handle improvers and anti-statics. Such agents are usually used in amounts of from 0.01 to 1% by weight, based on the total weight of the ink.

The inks can be prepared in customary manner by mixing together the individual constituents in the desired amount of water or solvent.

Substrate materials that may be printed include, for example:
cellulosic materials, such as paper, paperboard, cardboard, which may also be varnished or have some other coating,
metallic materials, such as foils, sheets or workpieces of aluminium, iron, copper, silver, gold, zinc or alloys of those metals, which may be varnished or have some other coating,
silicate materials, such as glass, china and ceramics, which may likewise be coated,
polymeric materials of all kinds, such as polystyrene, polyamides, polyester, polyethylene, polypropylene, melamine resins, polyacrylates, polyacrylonitrile, polyurethanes, polycarbonates, polyvinyl chloride and corresponding copolymers and block copolymers,
textile materials, knitted goods, woven goods, non-wovens and made-up goods of polyester, modified polyester, polyester blends, cellulosic materials, such as cotton, cotton blends, jute, flax, hemp and ramie, viscose, wool, silk, polyamide, polyamide blends, polyacrylonitrile, triacetate, acetate, polycarbonate, polypropylene, polyvinyl chloride, polyester microfibres and glass fibre fabrics,
foodstuffs and cosmetics.

The subsequent curing of the binder, that is to say the fixing of the print, can be effected in customary manner with the aid of heat or high-energy radiation. For this purpose, the print is irradiated either with electrons under an inert gas atmosphere (e.g. nitrogen) (electron beam curing) or with high-energy electromagnetic radiation, preferably in a wavelength range of from 220 to 450 nm. In such a procedure, the chosen light intensities should be matched to the curing speed in order to avoid decomposition of the indicator.

In all embodiments of the present invention the preferences given above for the functionalized nanoparticles apply.

The following Examples illustrate the invention in more detail. Parts or percentages are by weight.

### EXAMPLE 1

### Preparation of 3-Aminopropylsilane Modified Silica Nanoparticles

510 g of Ludox TMA (Helm AG, 34% nanosilica dispersion in water) is mixed with 2490 g ethanol. 345 g 3-Aminopropyl-trimethoxysilane is added dropwise to this homogeneous mixture. After the addition, the mixture is heated to 50° C. for 18 hours. The volume of this mixture is then reduced to ca. 1 l; by evaporating EtOH/H₂O in the rotary evaporator. A total of 4 l hexane is added, the mixture shaken vigorously and the 2 phases separated in a separation funnel to remove unreacted aminosilane. The aqueous/ethanolic lower phase is concentrated to a wet paste in the rotary evaporator in vacuo and then re-suspended in 1 l ethanol. A total of 1199 g solution is obtained with a solid content of 27.3 percent by weight.

### Analytics:

Thermographimetric analysis (TGA; heating rate: 10° C./min from 50° C. to 600° C.): Weight loss: 25.2% corresponding to the organic material.

Elemental analysis: found: C, 17.68%, H, 4.65%, N, 6.73%: corresponding to an organic content of 28.1% in relatively good agreement to the TGA value.

Transmission Electron Microscopy (TEM): An average diameter of 35-40 nm is obtained for the individual nanoparticles.

Dynamic light scattering (DLS): Average diameter d=90-110 nm.

### EXAMPLE 2

### “Electrostatic” Immobilization of the Cationic Dye “Victoria Blue” onto Modified Silica Nanoparticles

### Reaction Scheme:

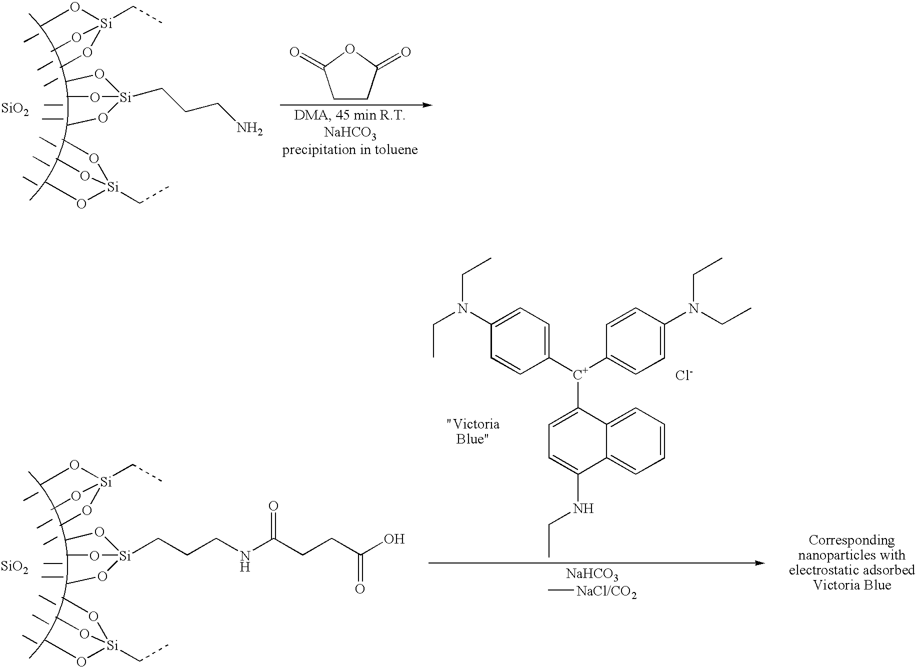

20 g of the dispersion obtainable according to Example 1 (amine content: 26.2 mmol) is concentrated with the rotary evaporator to a wet paste and redispersed in 40 ml dimethylacetamide (DMA), using an ultrasound bath. 2.62 g (26.2 mmol) succinic acid anhydride dissolved in 15 ml DMA is added with good stirring during 45 minutes, whereby a white suspension is formed. 2.20 g (26.2 mmol) sodium hydrogencarbonate is then added as fine powder and stirring continued for 20 hours at ambient temperature. 12.13 g (23.6 mmol) Victoria Blue (Basic Blue UN 3143 from Dye Intermediate Co.) dissolved in 30 ml DMA is added and stirring continued for 8 hours at ambient temperature. The reaction mixture is filtered and poored into 800 ml toluene, whereby a blue solid is formed which is re-dispersed in 300 ml ethanol. Dynamic light scattering (DLS) gives an average particle diameter d of 770 nm.

In order to analyze the product, ethanol is evaporated completely in the rotavap and the blue solid dried in vacuo. Yield: 10 g.

### Analytics:

Thermographimetric analysis (TGA; heating rate: 10° C./min from 50° C. to 800° C.): Weight loss: 71.1% corresponding to the organic material.

Elemental analysis: found: C, 45.15%, H, 5.37%, N, 6.60%: corresponding to an organic content of 67.1% in good agreement to the TGA value.

Transmission Electron Microscopy (TEM): Average diameter d=80-100 nm.

Application of the product obtainable according to Example 2:

In a 100 ml glass vessel containing 91.6 g of zircon ceramic beads, 3.05 g of the product obtained according to Example 2, 0.34 g of Solsperse® 5'000 (Avecia), 4.51 g of a 30% solution of DB 168 (Byke-Chemie) and 16.08 g of propylene glycol monomethyl ether acetate (MPA, CAS Reg. No 108-65-6), are stirred at 20° C. with a Dispermat at 1000 rpm for 10 minutes and at 3000 rpm for 180 minutes. Following the addition of 4.41 g of acrylic polymer binder (25% solution in MPA) at room temperature, stirring is continued at 3000 rpm for 30 minutes. After the beads have been separated off, the dispersion is diluted with an equal amount of MPA. A glass substrate (Corning Type 1737-F) is coated with this dispersion in a spin-coating apparatus and is spun at 1000 rpm for 30 s. The drying of the coat is carried out at 100° C. for 2 minutes and at 200° C. for 5 minutes on a hotplate. The trichromatic coordinates (with F10 as backlighting, calculated to an are x=0.169; y=0.143; Y=15%.

The thermal stability of nanoparticle bound “Victoria Blue” vs. “free” “Victoria Blue” dye is measured after aging 2 min at 100° C. and 5 min at 200° C. by their UV-VIS spectra, showing clearly the superior thermal stability of the nanoparticle bound dye. Also the photostability is higher as shown by a one week storage test under daylight condition.

### EXAMPLE 3

### Immobilization of the Cationic Dye “Victoria Blue” onto Modified Silica Nanoparticles by Chemical Reaction

### Reaction Scheme:

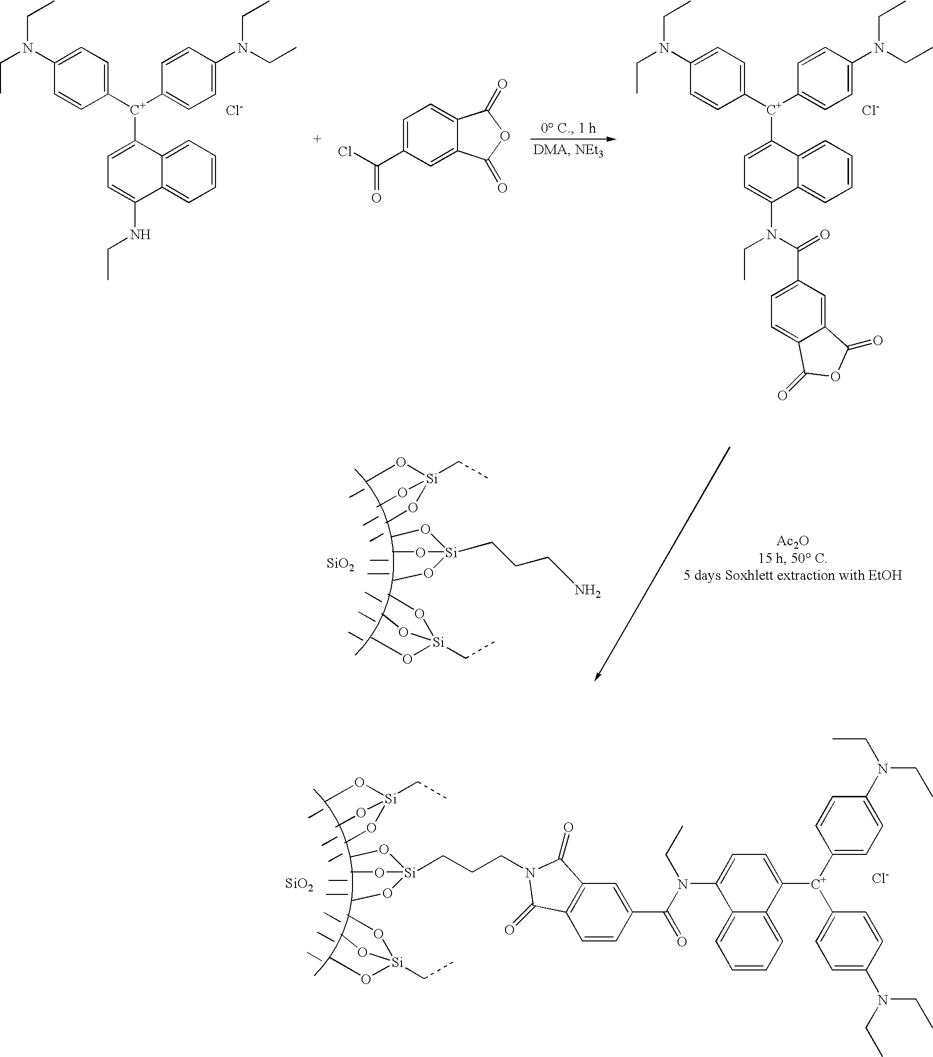

A solution of 22.25 g (43.2 mmol) “Victoria Blue” (Basic Blue UN 3143 from Dye Intermediate Co.) and 8.75 g (86.5 mmol) triethylamine in 900 g DMA is cooled to 0° C. and a solution of 9.11 g (43.2 mmol) trimellitic anhydride chloride in 70 g DMA added dropwise during 5 min. The reaction mixture is stirred for 20 minutes at 0° C., warmed up to ambient temperature and stirred for another 16 hours at ambient temperature. A dispersion of 18 g modified nanoparticles obtainable according to Example 1 (amine content: 86.5 mmol), concentrated with the rotary evaporator to a wet paste and redispersed in 100 ml dimethylacetamide and 17.66 g (173 mmol) acetic acid anhydride is added and the mixture stirred for 24 hours at 50° C. All solvents are evaporated in the rotavap in vacuo and the residue put into a soxhlett extracter and extracted with 750 ml ethanol at 11° C. for 5 days. The extracted solid is redispersed in 11 ethanol and centrifuged for 10 minutes at 2000 rpm. Dispersion and separation by centrifugation is repeated 4 times and the product dried in vacuo. Yield: 1.54 g of a blue/greenish powder

### Analytics:

Thermographimetric analysis (TGA; heating rate: 10° C./min from 50° C. to 800° C.): Weight loss: 30.0%, corresponding to the organic material.

Elemental analysis: found: C, 18.20%, H, 2.30%, N, 2.57%: corresponding to an organic content of 29.7% in excellent agreement to the TGA value.

Dynamic light scattering (DLS) of the reaction mixture before extraction and isolation of the product: Average diameter d=100 nm.

### EXAMPLE 4

### a) Modified Silica Nanoparticles

### Reaction Scheme:

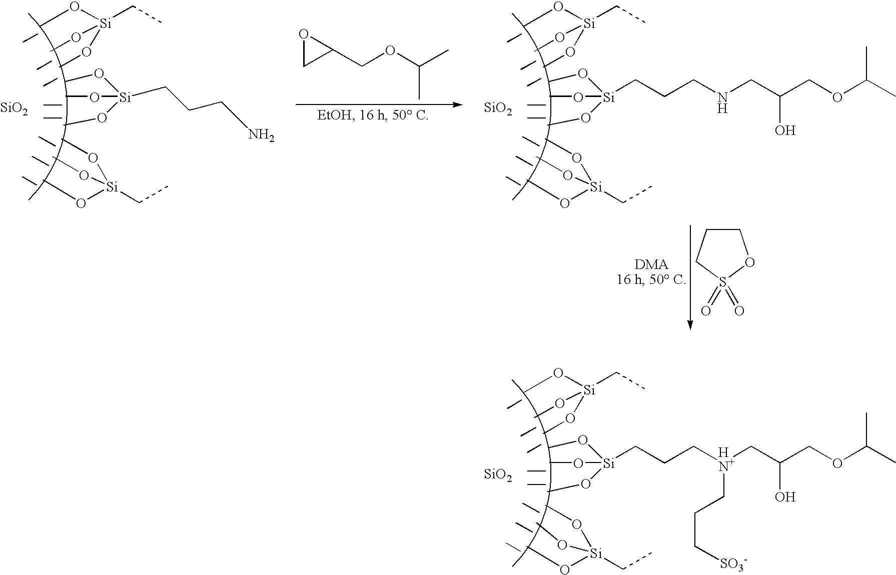

200 g of an aminopropyl modified silica nanoparticle dispersion obtainable according to Example 1 (25.6% in ethanol: dry content: 51.2 g; nitrogen content: 3.4 g or 242.9 mmol) is mixed with 28.22 g (242.9 mmol) glycidyl-isopropylether and stirred at 50° C. for 16 hours. The solvent (ethanol) is evaporated in the rotary evaporator to obtain a wet paste and 200 ml N,N-dimethylacetamide (DMA) added wherein the modified nanoparticles are redispersed using an ultrasound bath and good stirring. 29.7 g (242.9 mmol) 1,3-propane sulfone dissolved in 15 ml DMA is added with good stirring and the mixture stirred for another 16 hours at 50° C.

DMA is evaporated in the rotavap and the solid re-dispersed in ethanol which is again evaporated completely in the rotavap (in order to get separate all DMA) and the solid grinded to a fine powder and dried in vacuo at 90° C. Yield: 105.4 g.

### Analytics:

¹H-NMR and IR confirms the structure.

Thermographimetric analysis (TGA; heating rate: 10° C./min from 50° C. to 800° C.): Weight loss: 65.2% corresponding very well to the calculated organic material (65.6%).

Elemental analysis: found: C, 32.80%, H, 5.80%, N, 3.47%, S 6.91%: corresponding to an organic content of 65.4% in very good agreement to the TGA value.

Dynamic light scattering (DLS): Average diameter d=55.2 nm.

### b) Immobilization of the Cationic Dye “Victoria Blue” onto Anionic Modified Silica Nanoparticles

### Reaction Scheme:

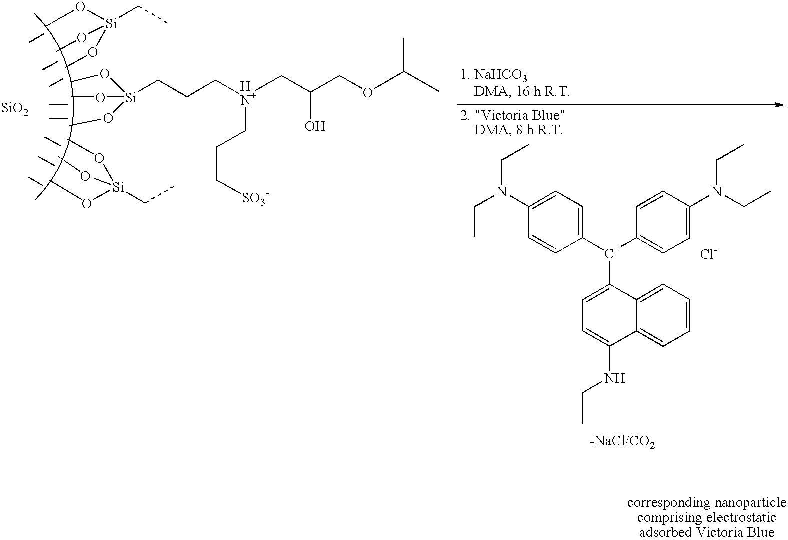

10.0 g of the powder obtainable according to Example 4a) (sulfonate content: 22.3 mmol) is re-dispersed in 200 ml dimethylacetamide (DMA). 1.87 g (22.3 mmol) NaHCO₃ is added and the mixture stirred in an ultrasound bath during 16 hours at room temperature, whereby a white suspension of the sodium sulfonate salt is formed. 12.32 g (20.07 mmol, 0.9 equiv.) Victoria Blue powder (Basic Blue UN 3143 from Dye Intermediate Co.) is added and stirring continued for 8 hours at ambient temperature. The reaction mixture is filtered (to remove the NaCl formed) and evaporated completely in the rotavap. The solid is re-dispersed in ethanol which is again evaporated completely in the rotavap (in order to remove all DMA). The blue solid is grinded to a fine powder and dried in vacuo at 50° C. Yield: 20.8 g (quantitative).

### Analytics:

Thermographimetric analysis (TGA; heating rate: 10° C./min from 50° C. to 800° C.): Weight loss: 79.1% (calculated value: 82.3%), corresponding to the total of organic material.

Elemental analysis: found: C, 51.59%, H, 6.47%, N, 5.97%, S 3.23%: corresponding to an organic content of 77.0% in good agreement to the TGA value.

Transmission Electron Microscopy (TEM): Particle diameter d=22 nm (visible core). The total dye content is calculated to be 50.2%.

### EXAMPLE 5

### a) 3-Mercaptopropylmethylsilane Modified Silica Nanoparticles

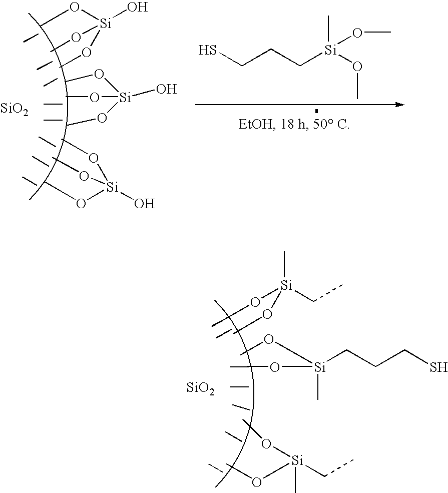

100 g of Ludox TMA (Helm AG, 34% nanosilica dispersion in water) is mixed with 100 g ethanol. 38 g 3-mercaptopropylmethyldimethoxysilane (ABCR Gelest) dissolved in 70 g ethanol is added dropwise to this homogeneous mixture. After the addition, the mixture is heated to 50° C. for 18 hours. The solvent of this mixture is then evaporated in the rotary evaporator and a white resin is obtained. The product is redispersed in 50 ml ethanol and 100 g of hexane is added. The precipitated product is centrifuged at 2000 rpm for 15 minutes. This procedure is repeated 3 times to get rid of unreacted 3-mercaptopropylmethyldimethoxysilane. Finally the product is redispersed in 2-propanol to obtain a 17.2 wt % dispersion.

### Analytics:

Thermographimetric analysis (TGA; heating rate: 10° C./min from 50° C. to 600° C.): Weight loss: 18.4 wt. % corresponding to the organic material.

Elemental analysis: found: S: 5.8 wt. %: corresponding to an organic content of 17.1 wt. % (in relatively good agreement to the TGA value).

Transmission Electron Microscopy (TEM): An average diameter of 35-40 nm is obtained for the individual nanoparticles.

Dynamic light scattering (DLS): Average diameter d=38 nm.

### b) Reaction of 3-Mercaptopropylmethylsilane Modified Silica Nanoparticles with Modified (Allylated) “Victoria Blue” Dye

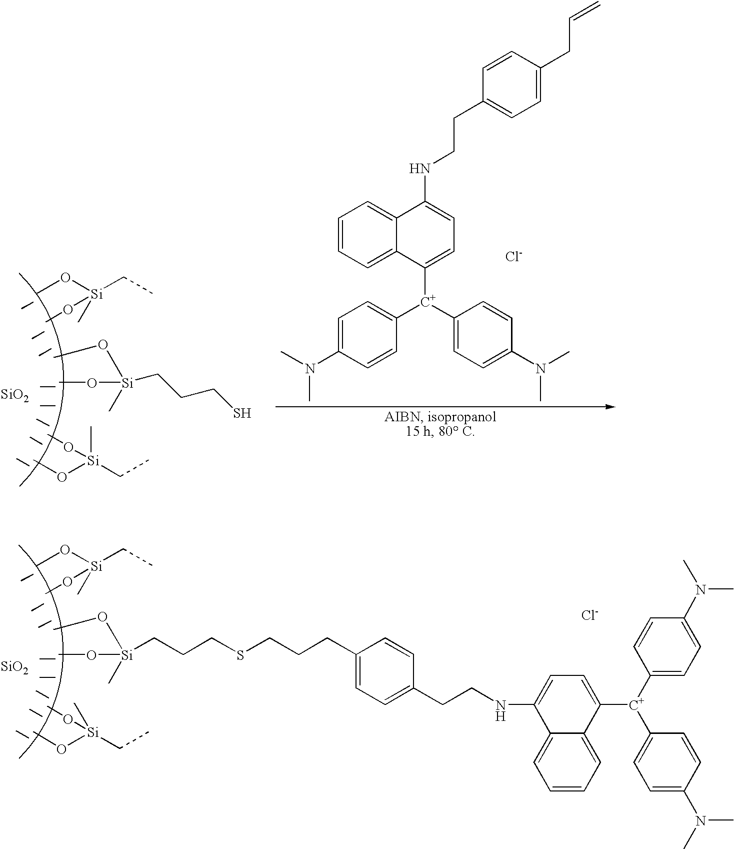

4.3 g of 3-mercaptopropylmethylsilane modified silica nanoparticles obtainable as given above under 5a) (1.33 mmol S) and 1.67 g (2.66 mmol) of the Victoria Blue derivative given in the above reaction scheme are dissolved in 50 ml isopropanol in a 250 ml round bottom flask and 200 mg AIBN (azobisisobutyronitrile) are added. The reaction mixture is heated to 80° C. for 15 hours with good stirring. The dye modified silica nanoparticles are isolated after cooling to ambient temperature by centrifugation (2000 rpm) and decantation of the supernatent, containing the excess of the free dye. Subsequent “washing” with ethanol and centrifugation until a colorless supernatent removes all free dye (not linked to the silica nanoparticles). The blue solid is dried in vacuo at 50° C. Yield: 4.7 g.

### Analytics:

Thermographimetric analysis (TGA; heating rate: 10° C./min from 50° C. to 800° C.): Weight loss: 43% corresponding to the organic material.

### EXAMPLE 6

### Immobilization of “Victoria Blue”-Silane onto Modified Silica Nanoparticles

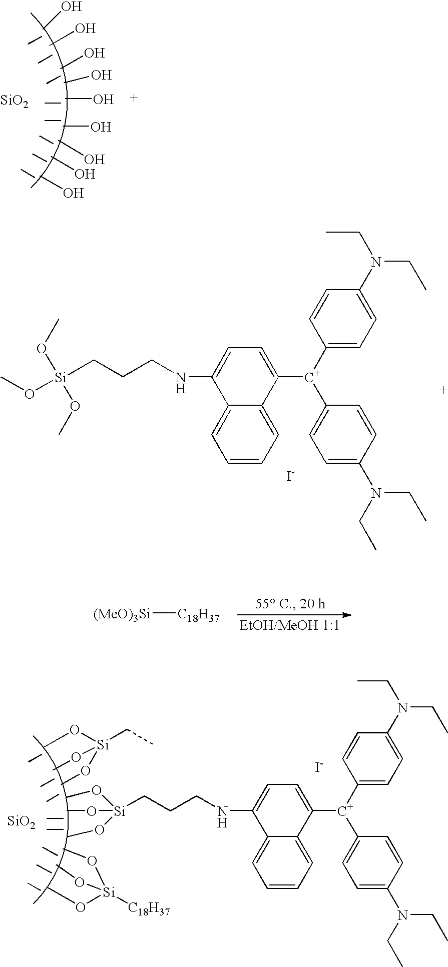

A dispersion of 2 g Ludox TMA (34% SiO₂ in H₂O) is diluted with 10 ml ethanol and 0.8 g (1.35 mmol) “Victoria Blue”-silane (see the above reaction scheme; this educt can be prepared in analogy to Example 11a)) in 60 ml EtOH/MeOH are added, followed by 0.8 g (2.1 mmol) octadecyl-trimethoxysilane. The reaction mixture is stirred for 20 minutes at 0° C., warmed up to ambient temperature and stirred for another 16 hours at 55° C. The dye modified silica nanoparticles are isolated after cooling to ambient temperature by centrifugation (2000 rpm) and decantation of the supernatent, containing the excess of the free dye. Subsequent “washing” with EtOH and centrifugation until a colorless supernatent removes all free dye (not linked to the silica nanoparticles). The blue solid is dried in vacuo at 50° C. Yield: 1.0 g.

### Analytics:

Thermographimetric analysis (TGA; heating rate: 10° C./min from 50° C. to 800° C.): Weight loss: 29.6%, corresponding to the organic material.

The thermostability of the attached dye (as measured by TGA) is approx. 100° C. higher than that of the free dye which starts to decompose at about 200° C.

### EXAMPLE 7

### Modified Silica Nanoparticles with “Victoria Blue Dye” and Dispersant (Poly(N-Butyl Acrylate) Made by ATRP-Technology)

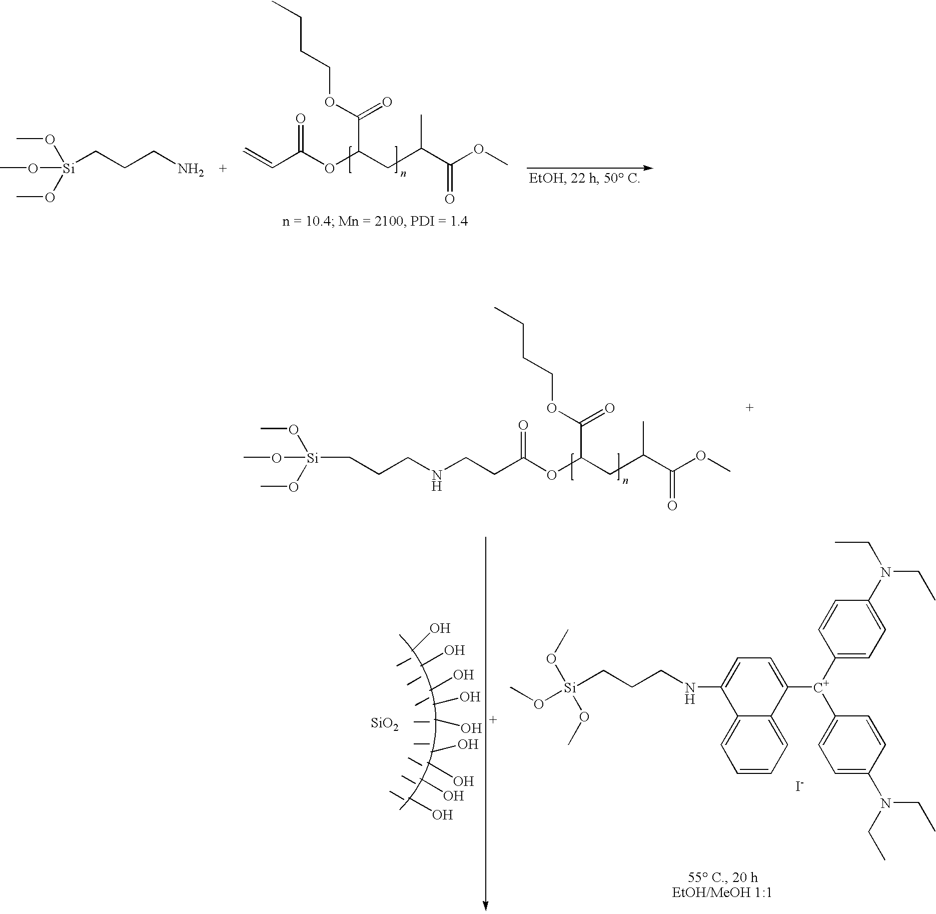

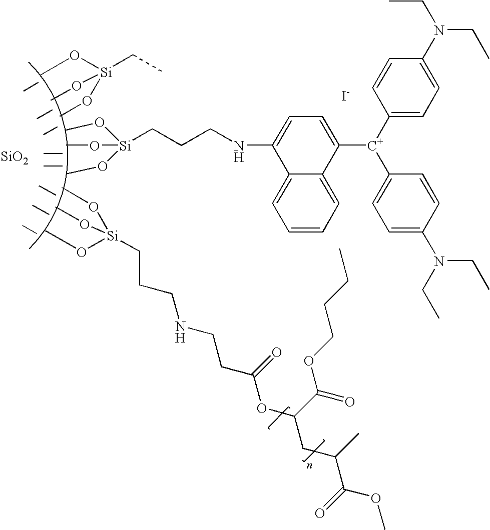

To 0.68 g (3.8 mmol) 3-aminopropyl-trimethoxysilane (Fluka purum) in 10 ml MeOH 8.0 g (3.8 mmol) of the poly(n-butyl acrylate) macromonomer with acrylate endgroup (synthesized with ATRP technology according to A. Muhlebach, F. Rime J. Polym. Sci., Polym. Chem. Ed. 2003, 41, 3425; Mₙ=2100, M_{w}=2940) is added and the mixture stirred at 50° C. for 18 hours. The so formed poly(n-butyl acrylate)-trimethoxysilane was then added together with 0.8 g (1.35 mmol) “Victoria Blue”-silane (see the above reaction scheme; this educt can be prepared in analogy to Example 11a)) in 60 ml EtOH/MeOH to a dispersion of 7.63 g Ludox TMA (34% SiO₂ in H₂O), diluted with 40 ml EtOH. The reaction mixture is stirred for 20 minutes at ambient temperature and followed by 16 hours at 55° C. The dye and dispersant modified silica nanoparticles are isolated after cooling to ambient temperature by centrifugation (2000 rpm) and decantation of the supernatent, containing the excess of the free dye. Subsequent “washing” with EtOH and centrifugation until a colorless supernatent removes all free dye (not linked to the silica nanoparticles). The blue solid is dried in vacuo at 50° C. Yield: 10.8 g.

### Analytics:

Thermographimetric analysis (TGA; heating rate: 10° C./min from 50° C. to 800° C.): Weight loss: 82.3% corresponding to the organic material.

Dynamic light scattering (DLS): Average diameter d=64.5 nm.

### EXAMPLE 8

### a) Synthesis of Iodopropyl-Silane Modified Silica Nanoparticles

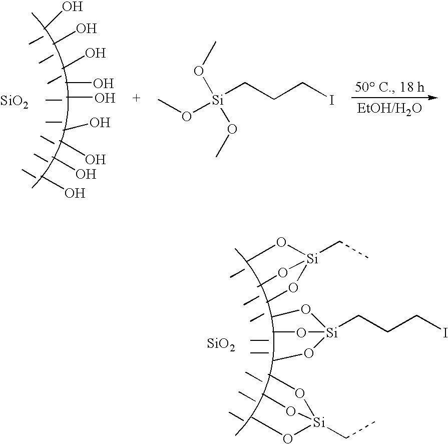

A dispersion of 33.4 g Ludox TMA (Aldrich, 34% SiO₂ in H₂O) is diluted with 190 ml EtOH and 25 g (86.2 mmol) 3-iodopropyl-trimethoxysilane (Fluka purum) are dropwise added during 45 minutes. The reaction mixture is stirred for 18 hours at 50° C. After cooling to ambient temperature the aqueous/ethanolic dispersion is extracted two times with totally 650 ml hexane. The water is removed by an azeotropic distillation (evaporation of 75% of volume) and 120 ml EtOH are added to prepare the final dispersion. Yield: 123.1 g with 24% solid content.

### Analytics:

DLS: d=37 nm

Thermographimetric analysis (TGA; heating rate: 10° C./min from 50° C. to 800° C.): Weight loss: 46.6%, corresponding to the organic material.

Elemental analysis: C, 11.58%, H, 2.12%, 1: 31.69%

### b) Synthesis of Nanoparticle Bound “Victoria Blue”

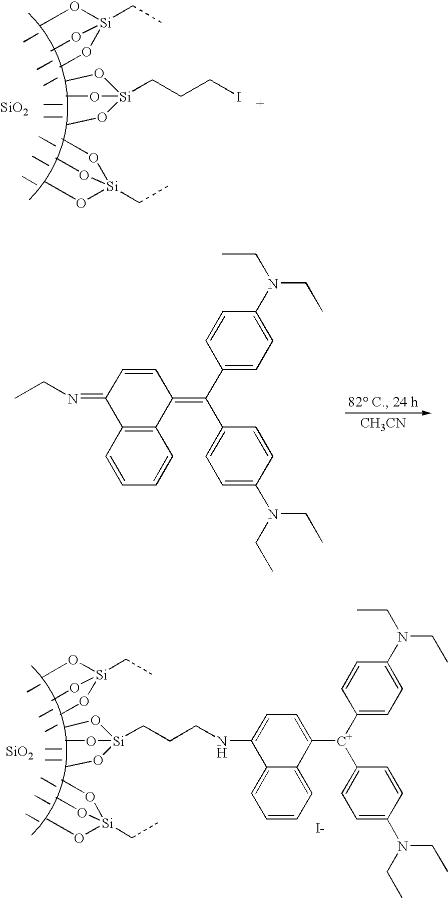

The solvent of 15 g of the dispersion obtainable as given above under Example 8a) (3.6 g solid content, I-content of particles: 1.14 g=9 mmol) is completely evaporated and the solid material dispersed in 50 ml acetonitrile. 4.02 g (9 mmol) of the leuco form of “Victoria Blue” (see the above reaction scheme; obtained by deprotonation with NaOH) is added and the reaction mixture stirred for 24 hours at 82° C. (reflux). The reaction mixture is concentrated to 25 ml and the product precipitated by adding 160 ml of water. Centrifugation (20 min, 2000 rpm) gives a blue solid residue which is washed again with 100 ml water followed by treatment with ultrasound (30 min.) and centrifugation. The dispersion is filtered, washed with water and dried at 45° C. in vacuo. Yield: 5.6 g (74%). The product is easily redispersable in EtOH or propanediol-monomethylether acetate.

### Analytics:

DLS: d=454 nm

Thermographimetric analysis (TGA; heating rate: 10° C./min from 50° C. to 800° C.): Weight loss: 69.2%, corresponding to the total of organic material.

Elemental analysis: C, 44.27%, H, 4.81%, N, 4.05%.

Dye content: 67%.

### EXAMPLE 9

### Synthesis of Nanoparticle Bound “Victoria Blue” Containing Diethanol-Aminopropylsilane as Additional Surface Modifier

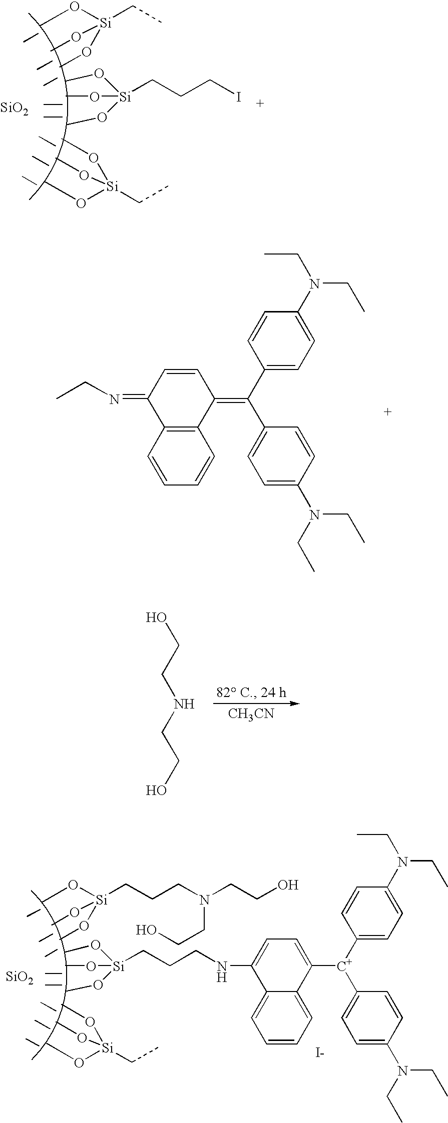

The solvent of 15 g of the dispersion obtainable as given above under Example 8a) (3.6 g solid content, I-content of particles: 1.14 g=9 mmol) is completely evaporated and the solid material dispersed in 50 ml acetonitrile. 2.01 g (4.5 mmol) of the leuco form of “Victoria Blue” (see the above reaction scheme; obtained by deprotonation with NaOH) and 0.47 g (4.5 mmol) diethanolamine are added and the reaction mixture stirred for 24 hours at 82° C. (reflux). The reaction mixture is concentrated to 25 ml and the product precipitated by adding 150 ml of water. The dispersion is filtered, washed with water and dried at 45° C. in vacuo. Yield: 4.8 g (85%). The product is very easily redispersable in many solvents.

### Analytics:

Thermographimetric analysis (TGA; heating rate: 10° C./min from 50° C. to 800° C.): Weight loss: 64.6%, corresponding to the total of organic material.

Elemental analysis: C, 36.01%, H, 4.62%, N, 3.83%.

Dye content: 49.5%.

### EXAMPLE 10

### a) Synthesis of Iodopropyl- and Propyl-Silane Modified Silica Nanoparticles

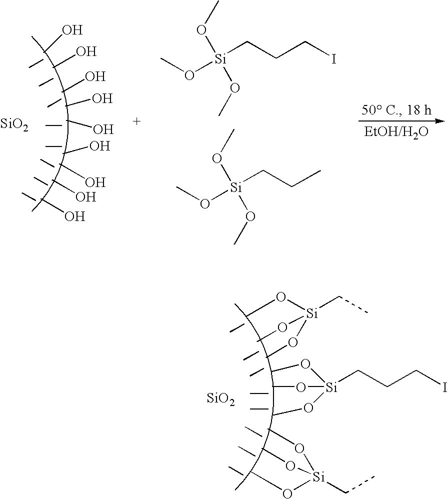

A dispersion of 100 g Ludox TMA (Aldrich, 34% SiO₂ in H₂O) is diluted with 600 ml EtOH and 9.98 g (34.4 mmol) 3-iodopropyl-trimethoxysilane (Fluka purum) and 51 g (31.6 mmol) propyl-trimethoxysilane are dropwise added during one hour. The reaction mixture is stirred for 18 hours at 50° C. The reaction mixture is concentrated to 300 ml and extracted three times with totally 300 ml hexane. The water is removed by an azeotropic distillation (evaporation of 200 ml EtOH/H₂O) and 150 ml EtOH are added to prepare the final dispersion. Yield: 219.7 g with 19% solid content.

### Analytics:

DLS: d=31 nm

Thermographimetric analysis (TGA; heating rate: 10° C./min from 50° C. to 800° C.): Weight loss: 12.6%, corresponding to the organic material.

Elemental analysis: C, 5.22%, H, 1.29%, 1: 4.94%

### b) Synthesis of Nanoparticle Bound “Victoria Blue”, Containing N-Propylsilane as Additional Surface Modifier

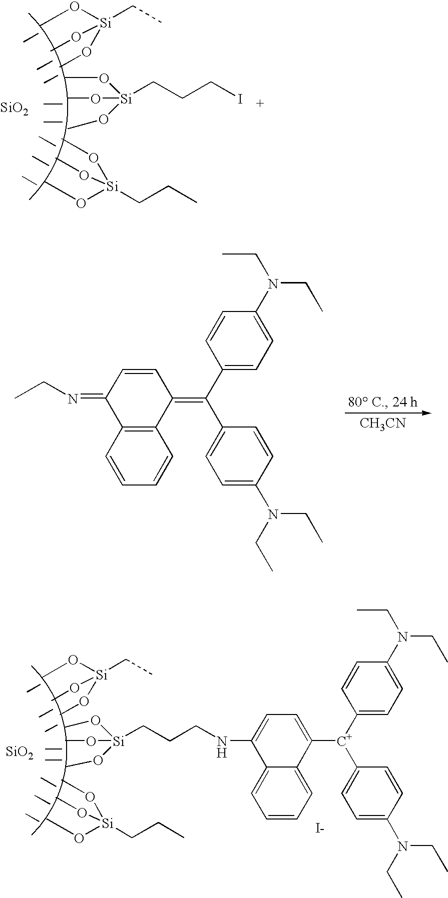

The solvent of 100 g of the dispersion obtainable as given above in Example 10a) (19% in EtOH, I-content of particles: 4.94%) is completely evaporated and the solid material dispersed in 100 ml acetonitrile. 3.53 g (7.4 mmol) of the leuco form of “Victoria Blue” (see the above reaction scheme; obtained by deprotonation with NaOH) is added and the reaction mixture stirred for 24 hours at 82° C. (reflux). The reaction mixture is concentrated to 50 ml and the product precipitated by adding 160 ml of water. Centrifugation (1 hour, 2000 rpm) gives a blue solid residue which is washed again with 160 ml water followed by centrifugation. The residue is dried at 30° C. in vacuo. Yield: 21.7 g (96%).

### Analytics:

DLS: d=308 nm

Thermographimetric analysis (TGA; heating rate: 10° C./min from 50° C. to 800° C.): Weight loss: 24.0%, corresponding to the total of organic material.

Elemental analysis: C, 16.57%, H, 2.45%, N, 1.08%.

Dye content: 16.6%.

### EXAMPLE 11

### a) Preparation of the “Victoria Blue”-Propyl Silane Precursor

51.52 g of C.I. Basic Blue 7 are dissolved in 750 ml of distilled water and then under stirring a 2N solution of sodium hydroxide in water is added dropwise, until the deprotonated form of the dye is completely precipitated and no blue colour remains in the solution. The precipitate is filtered off, washed with distilled and decarbonated water until the filtrate is free of chloride ions, and is dried at 60° C. under reduced pressure (200 mbar). 45.23 g (94.7%) of the deprotonated C.I. Basic Blue 7 are isolated as a nearly black powder.

A solution of 2.0 ml (2.95 g; 10.2 mmol) of 3-iodopropyl-trimethoxysilane in 50 ml of anhydrous ethanol are stirred at ambient temperature under argon for 60 hours, and subsequently the solvent is distilled off under reduced pressure, which results in complete exchange of the methoxy by ethoxy groups.

The residue is dissolved in 50 ml of anhydrous acetonitrile, 2.389 g (5 mmol) of deprotonated C.I. Basic Blue 7 are added, and the solution is heated under argon under reflux for 24 hours. The solvent is distilled off, and the semi-solid residue is washed several times with methyl-tert-butylether in order to remove the excess of the alkylating agent and unreacted deprotonated dye, until the filtrate is nearly colourless, avoiding the intrusion of atmospheric moisture during the procedure. Without drying, the solid residue is dissolved in 50 ml of anhydrous ethanol.

The product has the following structure:

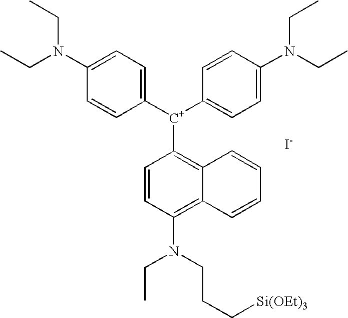

### b) Immobilization of the Cationic Dye “Victoria Blue” onto Aluminum Oxide Nanoparticles (Nyacol) by Chemical Reaction

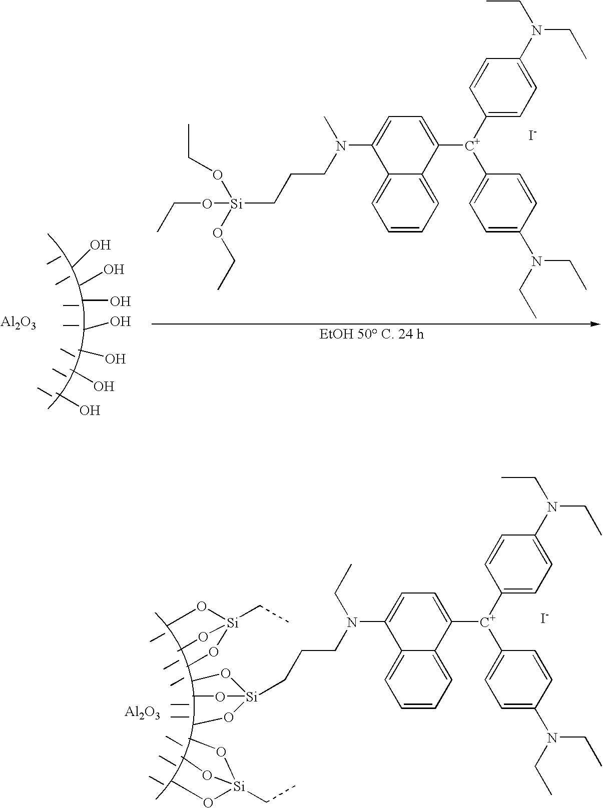

A solution of 0.7 g “Victoria Blue”-propyl silane precursor (obtainable as given above in Example 11a)) in 50 ml of anhydrous ethanol and 30 g of aluminum oxide nanoparticle suspension (Nyacol Corp., Nyacol A120 DW, 22% nanoalumina dispersion in water) in 120 ml of ethanol are combined carefully to avoid agglomeration of the nanoparticles and the mixture is stirred for 24 hours at 50° C. After completion of the reaction, 100 ml of ethyl acetate are added to precipitate the product. The paste is separated by centrifugation at 2000 rpm, washed three times with ethyl acetate to remove unreacted dye, and dried in a vacuum oven at reduced pressure at a temperature of 60° C. for 16 hours.

The blue powder shows good migration fastness, tested in a 1% concentration in PVC foil application.

### Analytics:

Thermogravimetric analysis (TGA; heating rate: 10° C./min from 50° C. to 800° C.): Weight loss: 4.8%, corresponding to the organic material.

### EXAMPLE 12

### Sulfo-Rhodamine B Reacted with 3-Amino Propyl Silane Modified Silica Nanoparticles

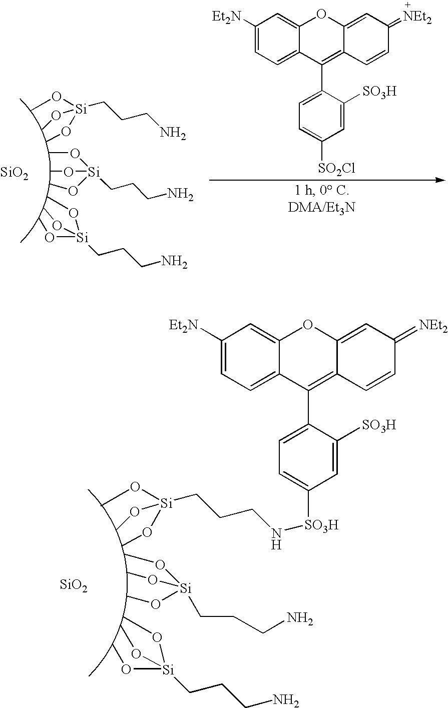

24 g of a 25% suspension of 3-aminopropylsilane modified nanoparticles in ethanol

(obtainable according to Example 1) are mixed with 25 g of dimethylacetamide (DMA), homogenized and the ethanol removed in a rotary evaporator at a temperature of 50° C. (85 hPa). The mixture is combined with 1 g of triethylamine, homogenized and cooled down to 0° C. To this solution, the dye-solution consisting of 50 mg of Sulforhodamine B acid chloride (Fluka) in 25 g of dimethylacetamide (DMA) is run in 10 minutes under stirring at a temperature of 0° C. The violet suspension is stirred for an additional 1 hour at a temperature of 0° C. and then 16 hours at room temperature. The violet suspension is centrifuged (4500 rpm) and the obtained violet gel is re-dispersed in 40 g of xylene, washed, centrifuged and re-dispersed thrice until no educt is found in the washing liquid (controlled by TLC).

The violet gel is separated and dispersed in xylene (2.2% by weight). Thermogravimetric analysis (TGA; heating rate: 10° C./min from 25° C. to 800° C.): Weight loss: 11.32%, corresponding to the organic material.

Elemental analysis: C, 6.74%, H, 1.68%, N, 2.11%, S: <0.3% corresponding to an organic content of 10.53% in relatively good accordance to TGA.

TEM: Average diameter d=˜50 nm (visible core).

The IR shows a band at 1565 and ˜1630 cm⁻¹ corresponding to the amide-bond.

### EXAMPLE 13

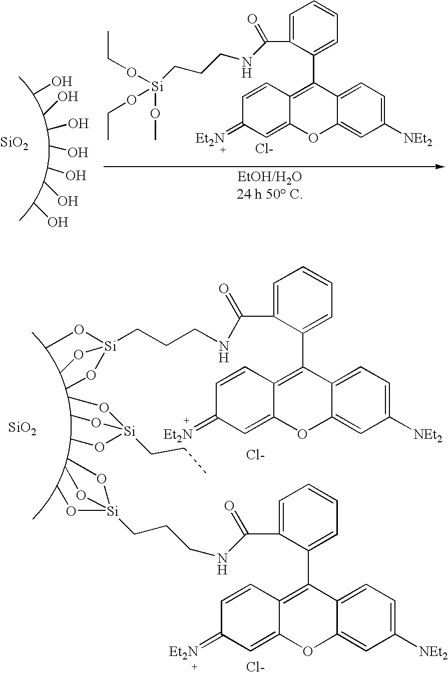

150 μl of concentrated HCl are added to 100 mg of Rhodamine B Base (see the above reaction scheme) in 3 ml water. The mixture is evaporated to dryness. 4 ml DMF are added to the residue. 100 mg of dicyclohexylcarbodiimide (DCC) and 200 mg (3-aminopropyl)trimethoxysilane are added, the reaction mixture is stirred until termination of the reaction and then centrifuged. The red solution is added to a suspension of 0.5 g nanosized silica particles (˜1.47 g Ludox TMA 34% in aqueous suspension) in 80% ethanol and heated 24 hours at a temperature of 50° C. under vigorously stirring. After completion of the reaction and cooling down to room temperature, ethyl acetate is added to precipitate the fluorescent silica nanoparticles. The suspension is centrifuged at 2000 rpm, washed with ethyl acetate until the supernatant is completely discoloured and the residue is dried for 24 hours in an oven under reduced pressure (70 hPa) at a temperature of 60° C. The fluorescent red powder is checked in a PVC-foil application and shows strong fluorescence, no migration and high transparency. The particle size as indicated by TEM is found to be ˜60 nm. The organic content of the fluorescent modified silica nanoparticles is checked by thermogravimetric analysis (TGA; heating rate: 10° C./min from 50° C. to 800° C.) with a loss of weight of 14.4%.

### EXAMPLE 14

### Fluorescent Dye (6-Methoxybenzoxanthene) Bound to Modified Silica Nanoparticles

### Reaction Scheme:

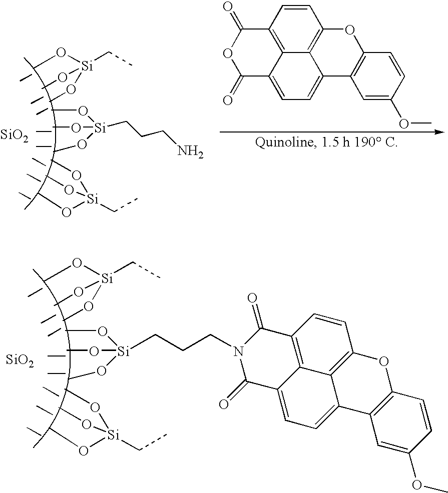

5.0 g of a dispersion obtainable according to Example 1 (25 percent by weight in ethanol, amine content 6.8%, 23.8% organic shell and average diameter of 107 nm (DLS)) is concentrated with the rotary evaporator to a wet paste and redispersed in 70 ml quinoline, using an ultrasound bath. 1.72 g (5.4 mmol) of the fluorescent dye given in the reaction scheme above (synthesis described in U.S. Pat. No. 3,741,971) is added and the reaction mixture stirred for 1.5 hours at 190° C. An almost clear brownish solution is obtained which is poored into 400 ml ethanol to precipitate the product. It is filtered and the residue purified by stirring in 130 ml o-dichlorobenzene at 180° C. for 20 hours, filtration and redispersion in 130 ml DMA. This dispersion is stirred again for 20 hours at 160° C. and filtrated. The residue is washed with ethanol and dried in vacuo. Yield: 1.3 g.

### Analytics (Before Purification and Isolation of the Product):

IR (KBr): 1761, 1690 and 1647 cm⁻¹: Imide band.

Thermographimetric analysis (TGA; heating rate: 10° C./min from 50° C. to 800° C.): Weight loss: 67.9% corresponding to the organic material.

Elemental analysis: found: C, 49.93%, H, 3.63%, N, 3.17%: corresponding to an organic content of 69.5% in excellent agreement with the TGA.

Dynamic light scattering (DLS) of the reaction mixture before purification and isolation of the product: Average diameter d=451 nm.

The migration test in PVC of 1% of this product in PVC foils gives no migration.

A dispersion (0.1%) of this product in NMP shows fluorescence under the UV-lamp (λ=366 nm).

### EXAMPLE 15

### 6-Methoxybenzoxanthene Reacted with 3-Amino Propyl Silane Modified Silica Nanoparticles

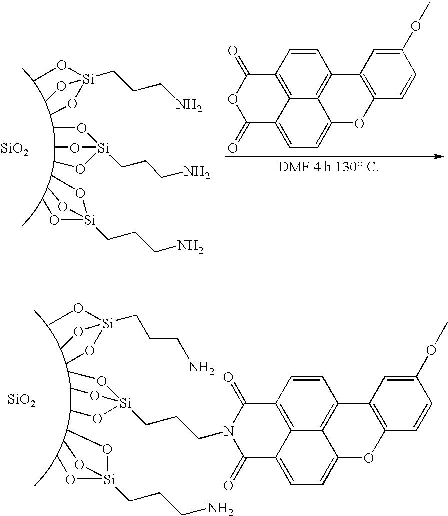

22 g of a 27.3% suspension of 3-aminopropylsilane modified nanoparticle in ethanol (obtainable according to Example 1) are mixed with 20 g of dimethylformamide (DMF), homogenized and the ethanol removed with the rotary evaporator at a temperature of 50° C. (65 hPa).

This suspension is added under stirring to a solution of 0.15 g of 6-methoxybenzoxanthene in 40 g of dimethylformamide. The brown yellow reaction mixture is stirred and heated for 4 hours to a temperature of 130° C., then 16 hours at room temperature, combined with 140 g of tetrahydrofuran (THF) and thereafter with 140 g of n-hexane. The precipitating nano-particles are filtered off, redispersed in 80 g of xylene, washed and centrifuged. The obtained brown-yellow gel is separated and dispersed in 80 g of xylene, centrifuged (4500 rpm) and re-dispersed in 80 g of xylene, washed, centrifuged until no educt is found in the washing liquid (controlled by TLC).

Thermogravimetric analysis (TGA; heating rate: 10° C./min from 25° C. to 800° C.): Weight loss: 12.2%, corresponding to the organic material.

Elemental analysis: found: C, 6.64%, H, 1.09%, N, 1.03%, corresponding to an organic content of 8.76%.

TEM: Average diameter d=−45 nm (visible core).

The IR shows a band at 1594, 1649 and ˜1695 cm⁻¹ corresponding to the imide-bond.

### EXAMPLE 16

### 6-Methoxybenzoxanthene and Light Stabilizer Reacted with 3-Amino Propyl Silane Modified Silica Nanoparticles

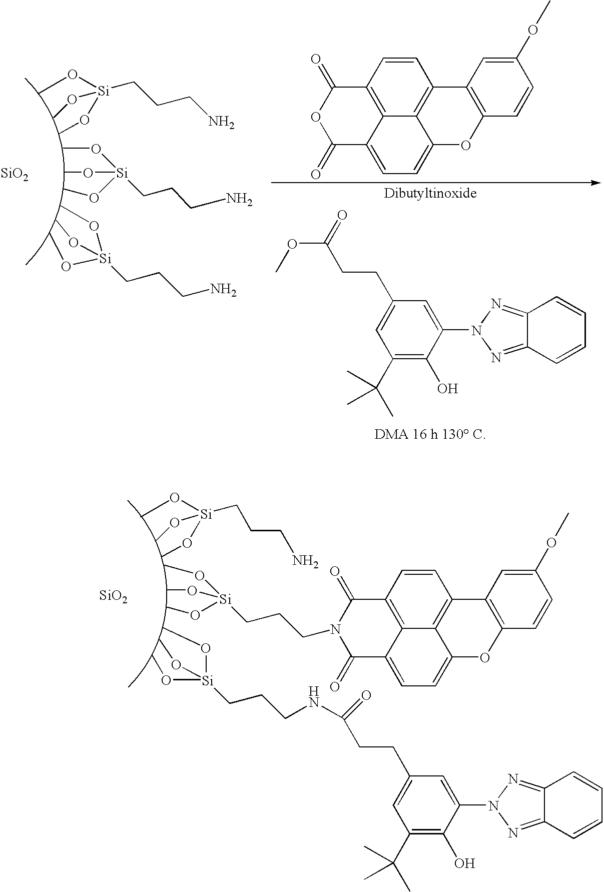

22 g of a 27.3% suspension of 3-aminopropylsilane modified nanoparticles in ethanol

(obtainable according to Example 1) are mixed with 30 g of dimethylacetamide (DMA), homogenized and the ethanol removed with the rotary evaporator at a temperature of 50° C. (75 hPa).

This suspension is added under stirring to a solution consisting of 0.2 g of 6-methoxybenzoxanthene, 0.1 g of the light stabilizer shown in the above reaction scheme, and of 50 mg of dibutyltinoxide in 40 g of dimethylacetamide. The orange reaction mixture is stirred and heated for 16 hours to a temperature of 130° C., then 1 hour at 45° C. and combined with 160 g of tetrahydrofuran (THF). The nano-particle suspension is centrifuged (4500 rpm), orange gel re-dispersed in 160 g of tetrahydrofuran, washed and centrifuged until no educt is found in the washing liquid (controlled by TLC).

Thermogravimetric analysis (TGA; heating rate: 10° C./min from 25° C. to 800° C.): Weight loss: 11.7%, corresponding to the organic material.

Elemental analysis: found: C, 7.16%, H, 1.61%, N, 2.08%, corresponding to an organic content of 10.85% which is in good accordance to the TGA.

TEM: Average diameter d=˜45 nm (visible core).

The IR shows a broad band at 1573 and 1635 cm⁻¹ corresponding to the amide/imide-bond. The product shows fluorescence in the UV-light.

### EXAMPLE 17

### 6-Methoxybenzoxanthene and Light Stabilizer Reacted with 3-Amino Propyl Silane Modified Silica Nanoparticles

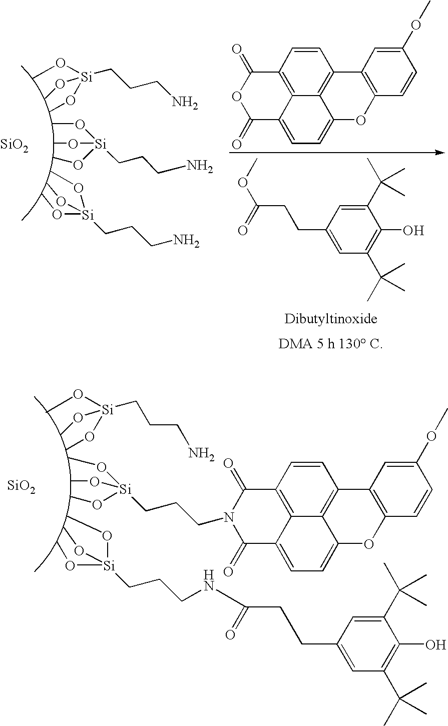

22 g of a 27.3% suspension of 3-aminopropylsilane modified nanoparticles in ethanol (obtainable according to Example 1) are mixed with 30 g of dimethylacetamide (DMA), homogenized and the ethanol removed with the rotary evaporator at a temperature of 50° C. (80 hPa).

This suspension is added under stirring to a solution consisting of 0.3 g of 6-methoxybenzoxanthene, 0.2 g of the light stabilizer shown in the above reaction scheme and of 50 mg of dibutyltinoxide in 40 g of dimethylacetamide. The orange reaction mixture is stirred and heated for 5 hours to a temperature of 130° C., then 1 hour at 50° C. and combined with 160 g of tetrahydrofuran (THF) and thereafter with 160 g of n-hexane. The nano-particle mixture is stirred for additional 16 hours at room temperature, centrifuged (4500 rpm), re-dispersed in 160 g of xylene, washed and centrifuged until no educt is found in the washing liquid (controlled by TLC). The obtained orange gel is separated by centrifugation and dispersed in 90 g of xylene.

Thermogravimetric analysis (TGA; heating rate: 10° C./min from 25° C. to 800° C.): Weight loss: 15.51%, corresponding to the organic material.

Elemental analysis: found: C, 10.3%, H, 2.12%, N, 3.00%, corresponding to an organic content of 15.42% which is in very good accordance to the TGA result.

TEM: Average diameter d=˜45 nm (visible core).

The IR shows a broad band at 1579 and ˜1640 cm⁻¹ corresponding to the amide/imide-bonds.

### EXAMPLE 18

### 6-Methoxybenzoxanthene and Light Stabilizer Reacted with 3-Amino Propyl Silane Modified Silica Nanoparticles

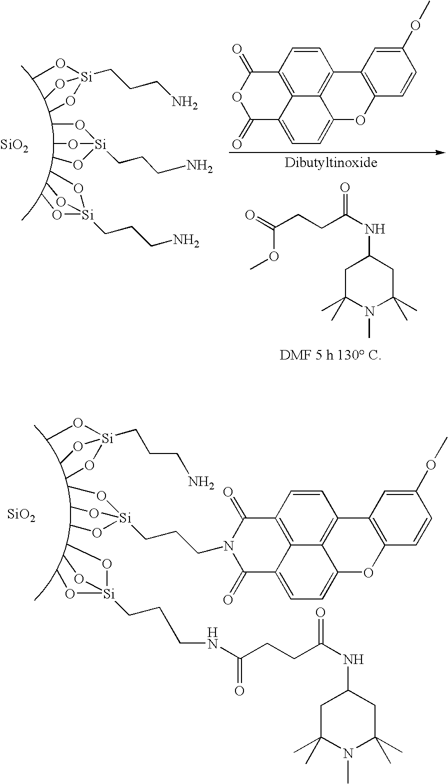

a) 22 g of a 27.3% suspension of 3-aminopropylsilane modified nanoparticle in ethanol (obtainable according to Example 1) are mixed with 30 g of dimethylacetamide (DMA), homogenized and the ethanol removed with the rotary evaporator at a temperature of 50° C. (85 hPa).

This suspension is added under stirring to a solution consisting of 0.3 g of 6-methoxybenzoxanthene, 0.6 g of succinic acid methylester 4-amido-(2,2,6,6)-tetramethyl-1-methyl-piperidine (see reaction scheme above) and of 300 mg of dibutyltinoxide in 50 g of dimethylacetamide. The orange reaction mixture is stirred and heated for 5 hours to a temperature of 130° C., then 1 hour at 50° C. and combined with 190 g of tetrahydrofuran (THF) and thereafter with 190 g of n-hexane. The nano-particle mixture is stirred for additional 16 hours at room temperature, centrifuged (4500 rpm) redispersed in 160 g of xylene, washed and centrifuged until no educt is found in the washing liquid (controlled by TLC). The obtained orange gel is separated by centrifugation and dispersed in 90 g of xylene.

Thermogravimetric analysis (TGA; heating rate: 10° C./min from 25° C. to 800° C.): Weight loss: 29.41%, corresponding to the organic material.

Elemental analysis: found: C, 19.4%, H, 3.83%, N, 5.24%, corresponding to an organic content of 28.47% which is in good accordance to the TGA result.

TEM: Average diameter d=˜50 nm (visible core).

The IR shows a broad band at 1576 and 1638 cm⁻¹ corresponding to the amide/imide-bonds.

The product shows fluorescence in the UV-light.

b) The process is carried out as given above under a), but with a solution consisting of 0.2 g of 6-phenoxybenzoxanthene, 0.5 g of succinic acid methylester 4-amido-(2,2,6,6)-tetramethyl-1-methyl-piperidine (see example above) and of 150 mg of dibutyltinoxide in 50 g of dimethylacetamide (DMA).

Thermogravimetric analysis (TGA; heating rate: 10° C./min from 25° C. to 800° C.): Weight loss: 23.91%, corresponding to the organic material.

Elemental analysis: found: C, 16.34%, H, 3.26%, N, 4.67%, corresponding to an organic content of 24.27% which is in good accordance to the TGA result.

TEM: Average diameter d=˜50 nm (visible core).

The IR shows a broad band at 1577 and 1642 cm⁻¹ corresponding to the amide/imide-bonds.

### EXAMPLE 19

### Perylene Dye Bound to Propyl-Silane and 3-Aminopropylsilane Modified Silica nanoparticles

### Reaction Scheme:

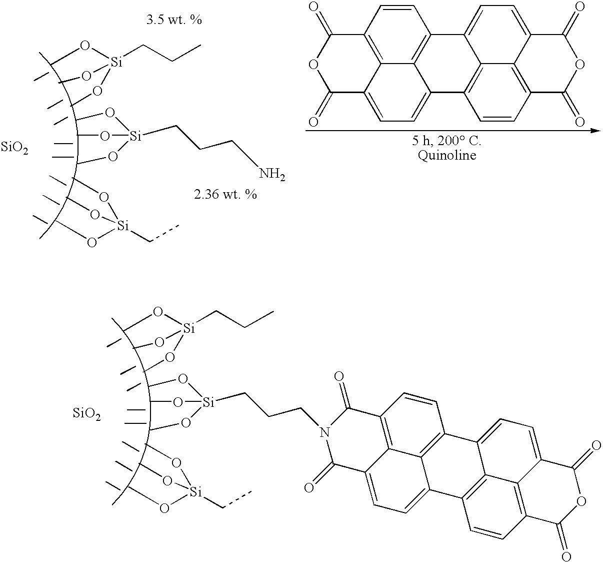

### a) Synthesis of Precursor: Propyl-Silane and 3-Aminopropylsilane Modified Silica Nanoparticles

50 g of Ludox TMA (Helm AG, 34% nanosilica dispersion in water) is mixed with 250 ml ethanol. A mixture of 2.29 g (12.8 mmol) 3-aminopropyl-trimethoxysilane and 8.42 g (51.3 mmol) propyl-trimethoxysilane is added dropwise to it during 15 minutes with stirring. After the addition, the mixture is heated to 50° C. for 16 hours. The reaction mixture is centrifuged (1 hour, 2000 rpm and the sedimented product redispersed in 200 ml ethanol, followed by a second centrifugation (1 hour, 2000 rpm). The sedimented product is re-dispersed in 70 ml toluene, giving a dispersion with a solid content of 13.5 wt. %.

### Analytics:

Thermographimetric analysis (TGA; heating rate: 10° C./min from 50° C. to 600° C.): Weight loss: 5.9% corresponding to the organic material.

Elemental analysis: found: C, 4.70%, H, 1.22%, N, 0.37%: corresponding to an aminopropyl content of 2.36 wt. % and a n-propyl content of 3.53 wt. %.

Dynamic light scattering (DLS): Average diameter d=69 nm.

### b) Synthesis of Perylene Dye (13%) and Propyl Silane (8%) Modified Silica Nanoparticles (Silica Content: 79%).

20.0 g of the dispersion obtainable as given above under 19a) is concentrated with the rotary evaporator to a paste and re-dispersed in 40 ml quinoline, using an ultrasound bath. 0.392 g (1.0 mmol) of the perylene dye given in the above reaction scheme is added and the reaction mixture stirred for 5 hours at 190-200° C. The reaction mixture is cooled to ambient temperature, filtered and washed with hot acetic acid (AcOH). The red solid is dispersed in acetic acid and stirred for 5 hours at 80° C., then filtered, washed with AcOH and water (until pH=7) and ethanol. The residue is dried in vacuo at 70° C. Yield: 2.3 g.

### Analytics:

IR (KBr): Two new strong bands at 1700 and 1668 cm⁻¹ (imide). Thermographimetric analysis (TGA; heating rate: 10° C./min from 50° C. to 800° C.): Weight loss: 21.3% corresponding to the total of organic material.

Elemental analysis: found: C, 13.35%, H, 1.40%, N, 0.48%: corresponding to a perylene content of 13.4%.

Dynamic light scattering (DLS) of the powder, re-dispersed in NMP: Average diameter d=462 nm.

The migration test in PVC of 1% of this product in PVC foils gives no migration.

### EXAMPLE 20

### Synthesis of Perylene Dye (7%) and Propyl Silane (9%) Modified Silica Banoparticles (Silica Content: 84%).

Reaction scheme in analogy to Example 19.

196 mg (0.5 mmol) of the perylene dye given in Example 19 is suspended in 40 ml quinoline and stirred at 90° C. 20.0 g of a dispersion obtainable as given in Example 19a) (13.5% in toluene) is added dropwise and the temperature increased to 120° C. to evaporate the toluene. Then the temperature is increased to 200° C. and the reaction mixture stirred at this temperature for 5 hours. The reaction mixture is cooled to ambient temperature, filtered and washed with hot acetic acid (AcOH). The red solid is dispersed in acetic acid and stirred for 5 hours at 80° C., then filtered, washed with AcOH and water (until pH=7) and ethanol. The residue is dried in vacuo at 70° C. Yield: 2.1 g.

### Analytics:

IR (KBr): Two new strong bands at 1700 and 1660 cm⁻¹ (imide).

Thermographimetric analysis (TGA; heating rate: 10° C./min from 50° C. to 800° C.): Weight loss: 16.5% corresponding to the total of organic material.

Elemental analysis: found: C, 9.18%, H, 1.18%, N, 0.53%: corresponding to a perylene content of 7.4%.

Dynamic light scattering (DLS) of the powder, re-dispersed in NMP: Average diameter d=463 nm.

The migration test in PVC of 1% of this product in PVC foils gives no migration.

### EXAMPLE 21

### Perylene Bis-Anhydride (Pigment Red 224) Reacted with 3-Amino Propyl Silane Modified Silica Nanoparticles

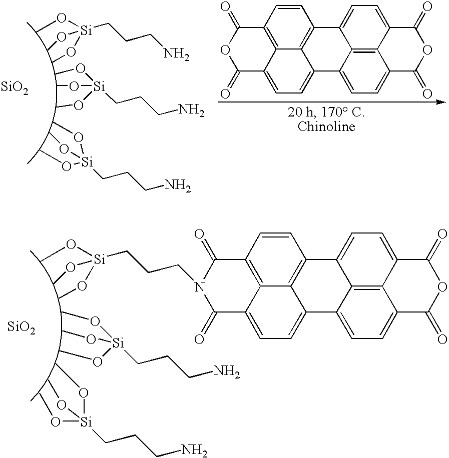

Solution A: 1.6 g of perylene di-anhydride (Pigment Red 224) are dissolved in 200 g of chinoline (Aldrich), heated under stirring to a temperature of 100° C. for 1 hour, cooled down to 70° C. and combined with Solution B, consisting of 25.1 g of a 23.9% suspension of 3-aminopropylsilane modified nanoparticle in ethanol (obtainable according to Example 1), previously mixed with 30 g of chinoline (Aldrich) and 30 g of pyridine, homogenized and removed from ethanol in a rotary evaporator at a temperature of 40° C. (50 hPa).

The reaction mixture is stirred and heated to a temperature of 170° C. and the volume of distilled pyridine is replaced with portions of chinoline. The stirring is continued over a total of 20 hours and then diluted with 160 g of dimethylacetamide (DMA) at a temperature of 100° C. The violet suspension is stirred for additional 16 hours at room temperature. The violet suspension is centrifuged (4500 rpm) and the obtained dark-red gel is re-dispersed in 80 g of dimethylacetamide (DMA), washed, centrifuged and re-dispersed twice until no educt is found in the washing liquid (controlled by TLC).

The red gel is separated and dispersed in 80 g of xylene, centrifuged (4500 rpm) and re-dispersed until no educt is found in the washing liquid (controlled by TLC).

The dark red nanoparticles are dispersed in 80 g of xylene, washed, centrifuged twice until no educt is found in the washing liquid (controlled by TLC).

Thermogravimetric analysis (TGA; heating rate: 10° C./min from 25° C. to 800° C.): Weight loss: 39.75%, corresponding to the organic material.

Elemental analysis: C, 29.67%, H, 3.24%, N, 4.03%, corresponding to an organic content of 36.94%.

TEM: Average diameter d=˜65 nm (visible core).

The IR shows a band at 1578, 1595, 1650 and 1693 cm⁻¹ corresponding to the imide- and anhydride bonds.

### EXAMPLE 22

### Lower Concentration of Perylene Bis-Anhydride (Pigment Red 224) Reacted with 3-Amino Propyl Silane Modified Silica Nanoparticles

Solution A: 200 mg of perylene di-anhydride (Pigment Red 224) are dissolved in 30 g of chinoline (Aldrich), heated under stirring to a temperature of 100° C. for 1 hour, cooled down to 70° C. and combined with Solution B, consisting of 24.1 g of a 24.9% suspension of 3-aminopropylsilane modified nanoparticle in ethanol (obtainable according to Example 1), mixed with 20 g of chinoline (Aldrich), homogenized, removed from ethanol in a rotary evaporator at a temperature of 40° C. (50 hPa) and combined with 10 g of pyridine. The pyridine reaction mixture is stirred and heated to a temperature of 170° C. and the volume of distilled is replaced with portions of chinoline. The stirring is continued over a total of 20 hours and then diluted with 60 g of dimethylacetamide (DMA) at a temperature of 100° C. The violet suspension is stirred for additional 16 hours at room temperature, centrifuged (4500 rpm) and the obtained dark-red gel is re-dispersed in 80 g of dimethylacetamide (DMA), washed, centrifuged and re-dispersed thrice until no educt is found in the washing liquid (controlled by TLC).

The red gel is separated and dispersed in 80 g of xylene, centrifuged (4500 rpm) and re-dispersed in 80 g of xylene, washed, centrifuged twice until no educt is found in the washing liquid (controlled by TLC).

Thermogravimetric analysis (TGA; heating rate: 10° C./min from 25° C. to 800° C.): Weight loss: 18.66%, corresponding to the organic material.

Elemental analysis: C, 11.55%, H, 1.79%, N, 2.33%, corresponding to an organic content of 15.67%.

TEM: Average diameter d=˜45 nm (visible core).

The IR shows a band at 1595, 1654 and ˜1692 cm⁻¹ corresponding to the imide- and anhydride bonds.

### EXAMPLE 23

### Lower Concentration of Perylene Bis-Anhydride (Pigment Red 224) Reacted with 3-Amino Propyl Silane Modified Silica Nanoparticles

Solution A: 50 mg of perylene di-anhydride (Pigment Red 224) are dissolved in 40 ml of chinoline (Aldrich), heated under stirring to a temperature of 100° C. for 1 hour, cooled down to 70° C. and combined with Solution B, consisting of 24.1 g of a 24.9% suspension of 3-aminopropylsilane modified nanoparticle in ethanol (obtainable according to Example 1), mixed with 25 g of chinoline (Aldrich), homogenized and ethanol removed in a rotary evaporator at a temperature of 40° C. (50 hPa).

The reaction mixture is heated under stirring to a temperature of 170° C. over a total of 8 hours and then diluted first with 40 g of dimethylacetamide (DMA) and then 50 g of n-hexane at room temperature.

The violet suspension is centrifuged (4500 rpm) and the obtained dark-red gel is re-dispersed in 160 g of dimethylacetamide (DMA), washed, centrifuged and re-dispersed thrice until no educt is found in the washing liquid (controlled by TLC).

The red gel is separated and dispersed in 80 g of xylene, centrifuged (4500 rpm) and re-dispersed in 80 g of xylene, washed, centrifuged twice until no educt is found in the washing liquid (controlled by TLC).

Thermogravimetric analysis (TGA; heating rate: 10° C./min from 25° C. to 800° C.): Weight loss: 18.16%, corresponding to the organic material.

TEM: Average diameter d=˜45 nm (visible core).

The IR shows a weak band at ˜1595, 1652 and ˜1692 cm⁻¹ corresponding to the imide- and anhydride bonds.

### EXAMPLE 24

### Perylene Bis-Anhydride (Pigment Red 224) Reacted with 3-Amino Propyl Silane Modified Silica Nanoparticles

Solution A: 50 mg of perylene di-anhydride (Pigment Red 224) are dissolved in 40 g of 1-methylpyrrolidone (NMP, Aldrich), heated under stirring to a temperature of 100° C. for 1 hour, cooled down to 70° C. and combined with Solution B, consisting of 24.1 g of a 24.9% suspension of 3-aminopropylsilane modified nanoparticle in ethanol (obtainable according to Example 1), mixed with 25 g of 1-methylpyrrolidone (NMP, Aldrich), homogenized and ethanol removed in a rotary evaporator at a temperature of 50° C. (60 hPa).

The reaction mixture is heated under stirring to a temperature of 150° C. over a total of 5 hours and then for 16 hours at room temperature. The violet suspension is centrifuged (4500 rpm) and the obtained dark-red gel is re-dispersed in 80 g of dimethylacetamide (DMA), washed and centrifuged. The red gel is separated and dispersed in 80 g of xylene, centrifuged (4500 rpm) and re-dispersed in 80 g of xylene, washed, centrifuged twice until no educt is found in the washing liquid (controlled by TLC).

Thermogravimetric analysis (TGA; heating rate: 10° C./min from 25° C. to 800° C.): Weight loss: 9.91%, corresponding to the organic material. Elemental analysis: found: C, 5.44%, H, 1.25%, N, 1.53%, corresponding to an organic content of 8.22%.

TEM: Average diameter d=˜65 nm (visible core).

The IR shows a weak band at ˜1595 and ˜1650 cm⁻¹ corresponding to the imide- and anhydride bonds.

### EXAMPLE 25

### Perylene Reacted with 3-Amino Propyl Silane Modified Silica Nanoparticles

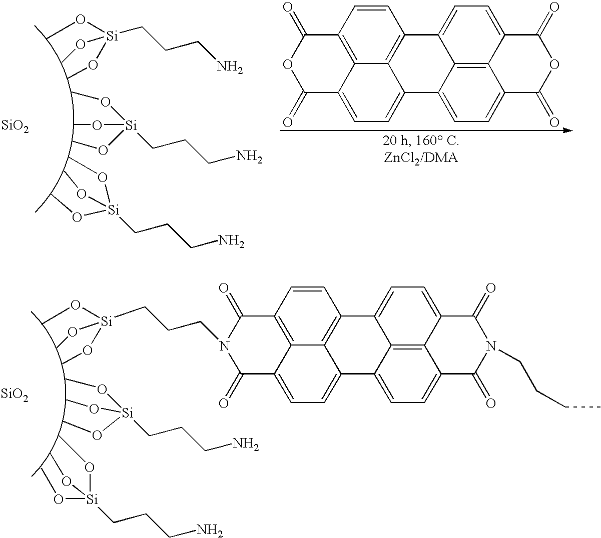

Solution A: 100 mg of perylene di-anhydride (Pigment Red 224) and 30 mg of anhydrous zinc chloride are dissolved in 40 g of dimethylacetamide (DMA), heated under stirring to a temperature of 100° C. for 1 hour, cooled down to 80° C. and combined with Solution B, consisting of 22 g of a 27.3% suspension of 3-aminopropylsilane modified nanoparticle in ethanol (obtainable according to Example 1), mixed with 25 g of dimethylacetamide (DMA), homogenized and freed from ethanol in a rotary evaporator at a temperature of 50° C. (65 hPa).

The red mixture is stirred and heated to a temperature of 160° C. over a total of 20 hours, and for additional 16 hours at room temperature.

The violet suspension is centrifuged (4500 rpm) and the obtained dark-red gel is re-dispersed in 80 g of THF/H₂O (1:1), washed, centrifuged and re-dispersed thrice in 80 g of 100% THF until no educt is found in the washing liquid (controlled by TLC).

The red-violet gel is separated and dispersed in 80 g of xylene, centrifuged (4500 rpm) and re-dispersed in 80 g of xylene, washed, centrifuged twice until no educt is found in the washing liquid (controlled by TLC).

Thermogravimetric analysis (TGA; heating rate: 10° C./min from 25° C. to 800° C.): Weight loss: 14.06%, corresponding to the organic material.

Elemental analysis: C, 8.25%, H, 1.56%, N, 1.89%, corresponding to an organic content of 11.7%.

TEM: Average diameter d=−60 nm (visible core).

The IR shows a band at 1557, 1651 and ˜1692 cm⁻¹ corresponding to the imide- and anhydride bonds.

### EXAMPLE 26

### 2-Ethyl-Hexyl-Imido-Perylene-Mono-Anhydride Reacted with 3-Amino-Propylsilane Modified Silica Nanoparticles

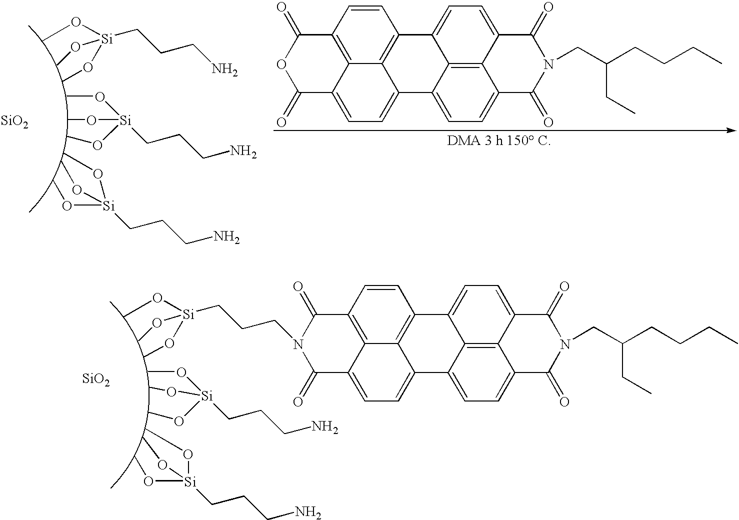

Solution A: 200 mg of 1-hexyl-2-ethyl-imido-perylene mono-anhydride (mixture with bis-imide) are dissolved in 50 g of dimethylacetamide (DMA), heated under stirring to a temperature of 100° C. for 1 hour, cooled down to 80° C. and combined with Solution B, consisting of 24 g of a 25% suspension of 3-aminopropylsilane modified nanoparticle in ethanol (obtainable according to Example 1), mixed with 30 g of dimethylacetamide, homogenized and freed from ethanol in a rotary evaporator at a temperature of 45° C. (80 hPa).

The red reaction mixture is stirred and heated at a temperature of 150° C. for a total of 3 hours and then for additional 16 hours at room temperature.

The dark-red suspension is centrifuged (4500 rpm) and the obtained red gel is re-dispersed in 80 g of dimethylacetamide, washed, centrifuged and re-dispersed thrice until no educt is found in the washing liquid (controlled by TLC).

The red gel is separated and dispersed in 80 g of xylene, centrifuged (4500 rpm) and re-dispersed in 80 g of xylene, washed, centrifuged until no educt is found in the washing liquid (controlled by TLC).

Thermogravimetric analysis (TGA; heating rate: 10° C./min from 25° C. to 800° C.): Weight loss: 13.84%, corresponding to the organic material.

Elemental analysis: found: C, 9.04%, H, 1.57%, N, 1.94%, corresponding to an organic content of 12.55%.

TEM: Average diameter d=˜40 nm (visible core).

The IR shows a band at 1595, 1653 and 1694 cm⁻¹ corresponding to the bis-imide bond. The product shows surprising solid-state fluorescence in the UV-light.

### EXAMPLE 27

### 2-Ethyl-Hexyl-Imido Perylene-Mono-Anhydride and Mpeg Reacted with 3-Amino Propylsilane Modified Silica Nanoparticles

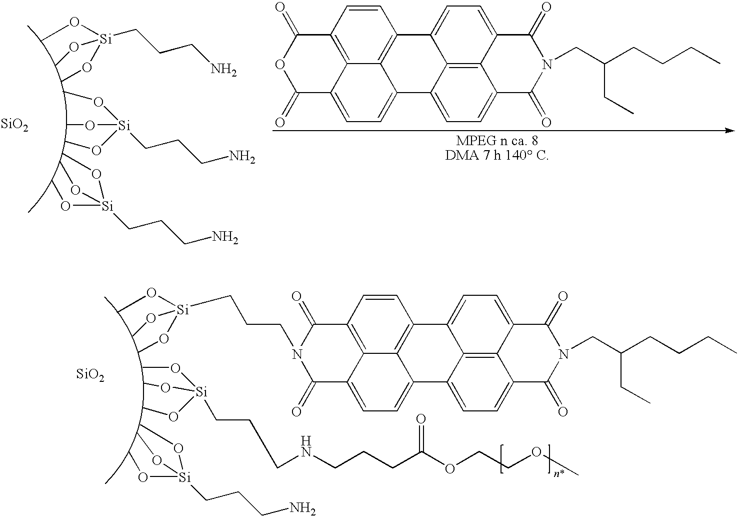

22 g of a 27.3% suspension of 3-aminopropylsilane modified nanoparticle in ethanol (obtainable according to Example 1) are mixed with 30 g of dimethylacetamide, homogenized and the ethanol removed with the rotary evaporator at a temperature of 45° C. (75 hPa).

This solution is added in 5 seconds under stirring to a mixture consisting of 3 g MPEG (Aldrich) and 0.4 g of 2-ethyl-hexyl imido perylene mono-anhydride dissolved in 50 g of dimethylacetamide. The red reaction mixture is stirred and heated to a temperature of 140° C. for 7 hours. The suspension is cooled to room temperature, centrifuged (4500 rpm), the isolated product re-dispersed in 80 g of dimethylacetamide, washed and centrifuged until no educt is found in the washing liquid (controlled by TLC). The obtained gel is washed, redispersed in xylene and centrifuged twice.

The product shows surprising solid-state fluorescence.

Thermogravimetric analysis (TGA; heating rate: 10° C./min from 25° C. to 800° C.): Weight loss: 28.56%, corresponding to the organic material.

Elemental analysis: found: C, 19.10%, H, 2.62%, N, 2.69%: corresponding to an organic content of 24.41%.

TEM: Average diameter d=˜50 nm (visible core).

The IR shows a band at 1595, 1654 and 1695 cm⁻¹ corresponding to the imide-bond.

### EXAMPLE 28

### 2-Ethyl-Hexyl-Imido Perylene-Mono-Anhydride, Reacted with 3-Amino Propyl Silane/MPEG-Amino Propyl Silane Modified Silica Nanoparticles

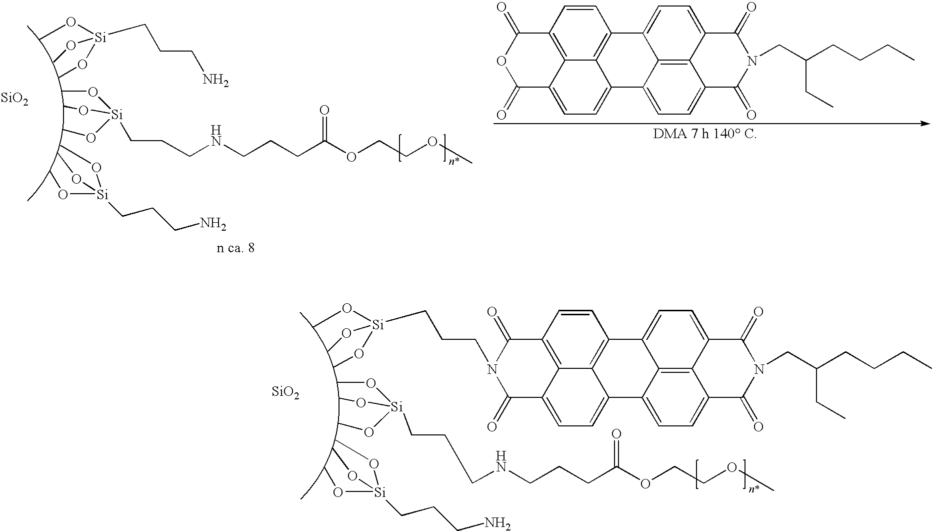

13.3 g of a 45.2% suspension of 3-aminopropylsilane/MPEG-aminopropylsilane modified nanoparticle in ethanol (obtainable in analogy to Example 27) are mixed with 30 g of dimethylacetamide (DMA), homogenized and the ethanol is removed with the rotary evaporator at a temperature of 45° C. (75 hPa).

This solution is added in 5 seconds under stirring to a mixture consisting of 0.4 g of 2-ethyl-hexyl-imido perylene mono-anhydride dissolved in 50 g of dimethylacetamide. The red reaction mixture is stirred and heated to a temperature of 140° C. for 7 hours. The suspension is cooled to room temperature, centrifuged (4500 rpm), the isolated product re-dispersed in 160 g of dimethylacetamide, washed and centrifuged until no educt is found in the washing liquid (controlled by TLC). The obtained gel is washed, re-dispersed in xylene and centrifuged twice.

Elemental analysis: found: C, 19.59%, H, 2.87%, N, 3.54%: corresponding to an organic content of 26%.

TEM: Average diameter d=−50 nm (visible core).

### EXAMPLE 29

### 4-Propylamino-1,8-Naphthalic Anhydride Reacted with 3-Amino Propyl Silane Modified Silica Nanoparticles

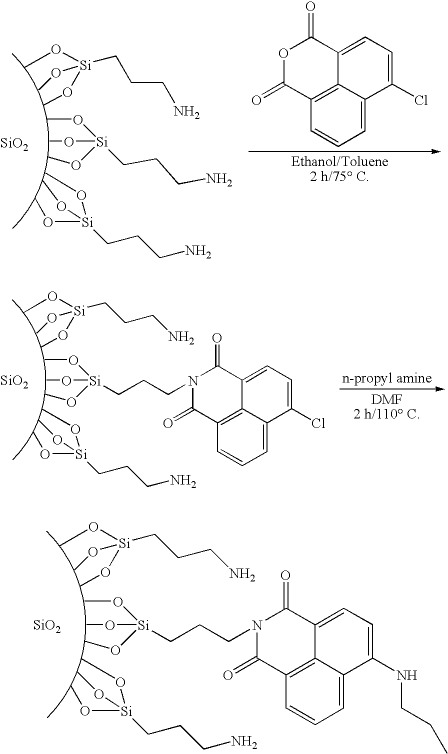

22.9 g of a 26.2% suspension of 3-aminopropylsilane modified nanoparticle in ethanol (obtainable according to Example 1) are freed from ethanol to a white gel at a temperature of 45° C. (80 hPa). The gel is re-dispersed in absolute ethanol.

This suspension is added under stirring to a orange solution of 1 g of 4-chloro-1,8-naphthalic anhydride (techn., ACROS) in a mixture of 50 g of dry toluene and 50 g of dry ethanol. The orange mixture is stirred and heated for 2 hours to reflux temperature of 75° C. The solvents are evaporated in vacuum (45° C., 70 hPa) and the gel re-dispersed in 100 g of dimethylformamide (DMF). Thereafter 0.51 g of n-propylamine are added and the suspension is stirred for 3 hours at a temperature of 100° C. and additional 16 hours at room temperature. The yellowish suspension is combined with 200 g of tetrahydrofuran (THF) and thereafter with 200 g of n-hexane. The sedimenting colored nano-particles are separated by centrifugation (4500 rpm), re-dispersed in 160 g of xylene, washed and centrifuged until no educt is found in the washing liquid (controlled by TLC).

Thermogravimetric analysis (TGA; heating rate: 10° C./min from 25° C. to 800° C.): Weight loss: 32.73%, corresponding to the organic material.

Elemental analysis: found: C, 20.15%, H, 3.08%, N, 4.49% corresponding to an organic content of 27.72%.

TEM: Average diameter d=˜55 nm (visible core).

The IR shows a band at 1548, 1578 and 1661 cm⁻¹ corresponding to the imide-bond. The product shows solid-state fluorescence in the UV-light.

### EXAMPLE 30

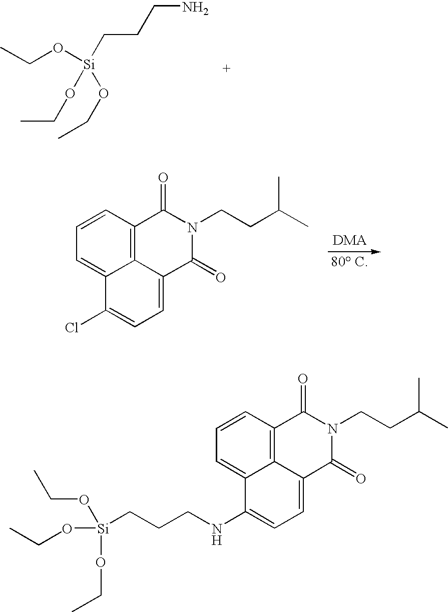

10.0 g of a commercial grade 4-chloronaphthalic anhydride (0.04 mol, Acros tech. dried) is suspended in 50 ml of methanol at ambient temperature. A solution of 5.3 ml of iso-pentylamine (0.045 mol, Fluka purum 98%) in 10 ml methanol is added dropwise. The reaction mixture is heated to 65° C. and stirred overnight. The beige suspension is then filtered, washed with methanol and dried in a vacuum oven at 80° C. overnight.

4.5 g (0.015 mol) of the raw material is dissolved in 10 ml of dimethylacetamide (Fluka purum) at 80° C. 33.2 ml of 3-aminopropyltriethoxysilane (0.15 mol Fluka purum 97%) are added over 30 min. The orange solution is cooled to ambient temperature and further processed.

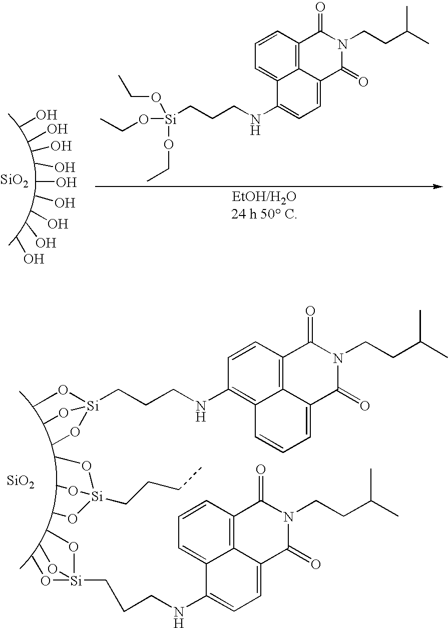

1.5 g of the silanized naphthalimide as described above, are added to a suspension of 3 g nanosized silica particles (Ludox TMA) in 80% ethanol and heated for 24 hours at a temperature of 50° C. under vigorously stirring. After completion of the reaction and cooling down to room temperature, ethyl acetate is added to precipitate the fluorescent silica nanoparticles. The suspension is centrifuged at 2000 rpm, washed with ethyl acetate until the supernatant is completely discoloured and the residue is dried for 24 hours in an oven under reduced pressure (70 hPa) at a temperature of 60° C. The fluorescent powder is checked in a PVC-foil application and shows strong fluorescence, no migration and high transparency. The particle size as indicated by TEM is found to be ˜65 nm. The organic content of the fluorescent modified silica nanoparticles is checked by TGA with a loss of weight of 8.3%.

### EXAMPLE 31

### 3-Mercaptopropylmethylsilane Modified Silica Nanoparticles

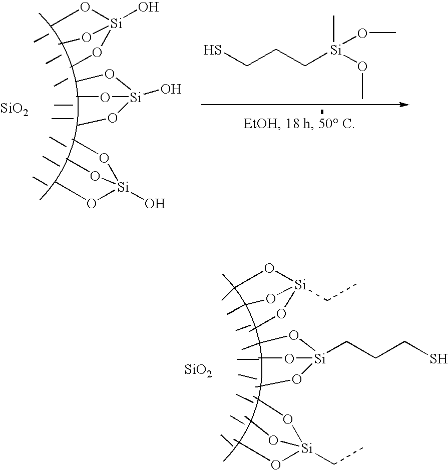

510 g of Ludox TMA (Helm AG, 34% nanosilica dispersion in water) is mixed with 2490 g ethanol. 188 g 3-mercaptopropylmethyldimethoxysilane (ABCR Gelest) is added dropwise to this homogeneous mixture. After the addition, the mixture is heated to 50° C. for 18 hours. The volume of this mixture is then reduced to ca. 1 l by evaporating ethanol and water in the rotary evaporator. A total of 4 l n-hexane is added, the mixture shaken vigorously and the 2 phases separated in a separation funnel to remove unreacted mercaptopropylmethylsilane. The aqueous/ethanolic lower phase is concentrated to a wet paste in the rotary evaporator in vacuo and then resuspended in 1.51 ethanol. A total of 1508 g solution is obtained with a solid content of 19.4 wt. %.

### Analytics:

Thermographimetric analysis (TGA; heating rate: 10° C./min from 50° C. to 600° C.): Weight loss: 14.4 weight-% corresponding to the organic material.

Elemental analysis: found: S: 5.04 weight-%: corresponding to an organic content of 14.2 weight-% in relatively good agreement to the TGA value.

Transmission Electron Microscopy (TEM): An average diameter of 35-40 nm is obtained for the individual nanoparticles.

Dynamic light scattering (DLS): Average diameter d=38 nm.

### EXAMPLE 32

### 1,4-dioxo-2,5-di-2-ethylhexyl-3,6-bis(4-bromophenyl)pyrrolo[3,4-c]pyrrole (DPP) reacted with 3-mercaptopropyl-methyl-silane modified silica nanoparticles

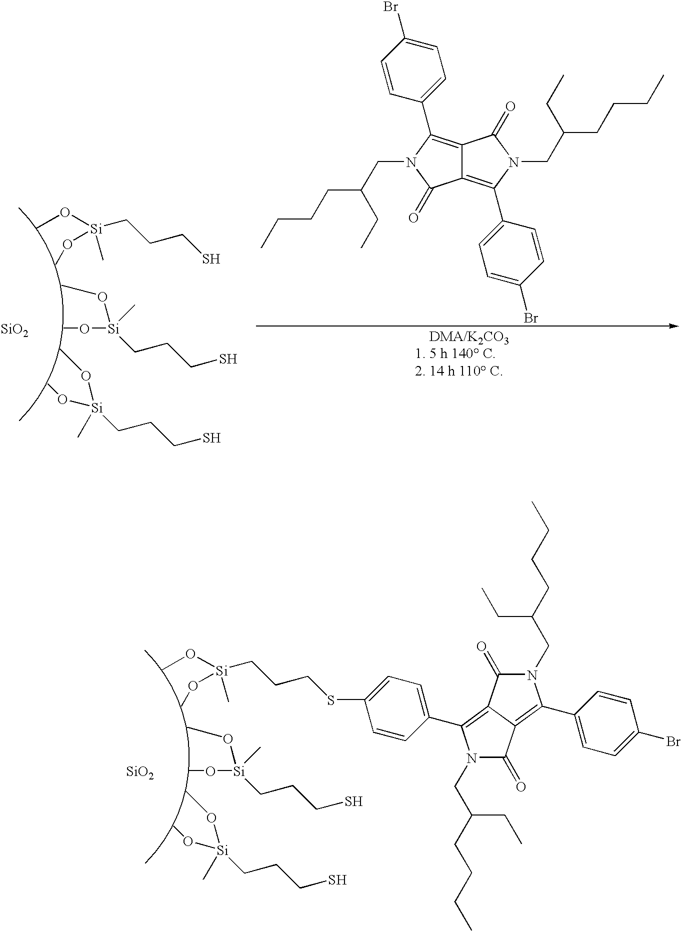

35.7 g of a 12.5% ethanolic suspension of 3-mercaptopropyl-methylsilane modified nanoparticles (obtainable according to Example 31) are mixed with 10 g of dimethylacetamide and the ethanol is evaporated in a rotary evaporator at a temperature of 45° C. (70 hPa).

To this mixture, 74 mg of 1,4-dioxo-2,5-di-2-ethylhexyl-3,6-bis(4-bromophenyl)pyrrolo[3,4-c]pyrrole and 67 mg of potassium carbonate are added under stirring at room temperature. The orange suspension is stirred and heated to a temperature of 140° C. for 5 hours and additional 11 hours at 110° C.

The orange suspension is centrifuged (4500 rpm) and the obtained gel is re-dispersed in 40 g of xylene, washed, centrifuged and re-dispersed thrice until no starting material is found in the washing liquid (controlled by TLC).

The orange-red gel is separated and dried in vacuum.

Thermogravimetric analysis (TGA; heating rate: 10° C./min from 25° C. to 800° C.): Weight loss: 9.45%, corresponding to the organic material.

Elemental analysis: C, 6.08%, H, 1.24%, S: 3.38%, N: less than 0.3%, Br: less than 0.3%, corresponding to an organic content of 11%.

TEM: Average diameter d=˜45 nm (visible core). The product shows in a 1% PVC-foil strong fluorescence, and no migration.

### EXAMPLE 33

### Cu-phthalocyanine dye and glycidylether (1:5 mol ratio) modified silica nanoparticles

a) Synthesis of a Cu-Phthalocyanine Dye with Acrylate Groups.

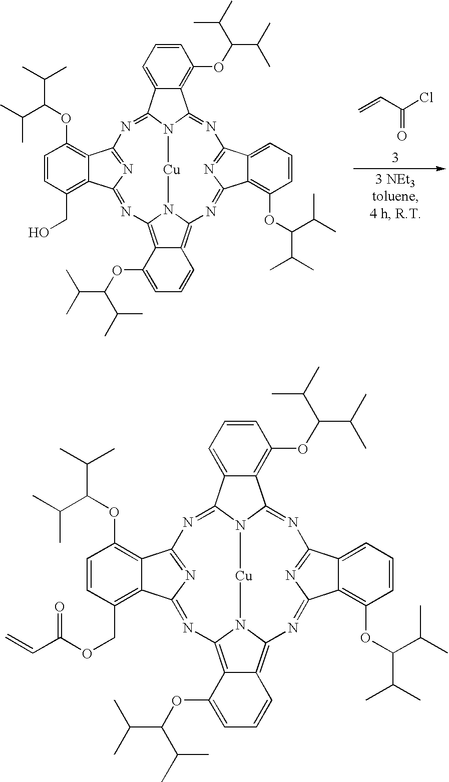

5.31 g (5 mmol) of the Cu-phthalocyanine dye given in the above reaction scheme as educt (synthesis described in WO 2002/083796, Examples 1 and 2) is dissolved in 125 ml toluene. 1.51 g (15 mmol) NEt₃ followed by 1.36 g (15 mmol) acryloylchloride is added and the mixture stirred 4 hours at ambient temperature. The reaction is slightly exothermic. After verification by thin layer chromatography (hexane/EtOAc 4:1) that no starting product is left, the reaction mixture is washed with 100 ml 2% NH₄OH and with 100 ml saturated NaCl solution. The organic phase is dried over Na₂SO₄, filtered, the solvent evaporated in the rotavap and the residue dried in vacuo at 50° C. over night. Yield: 5.58 g (quantitative). The structure is confirmed by MS: m/e=1115.5 (M⁺) since ¹H-NMR is not possible due to the paramagnetic Cu²⁺.

### b) Synthesis of Cu-Phthalocyanine Dye and Glycidylether (1:5 Mol Ratio) Modified Silica Nanoparticles, Dye Content: 38%, Silica Content: 36%.

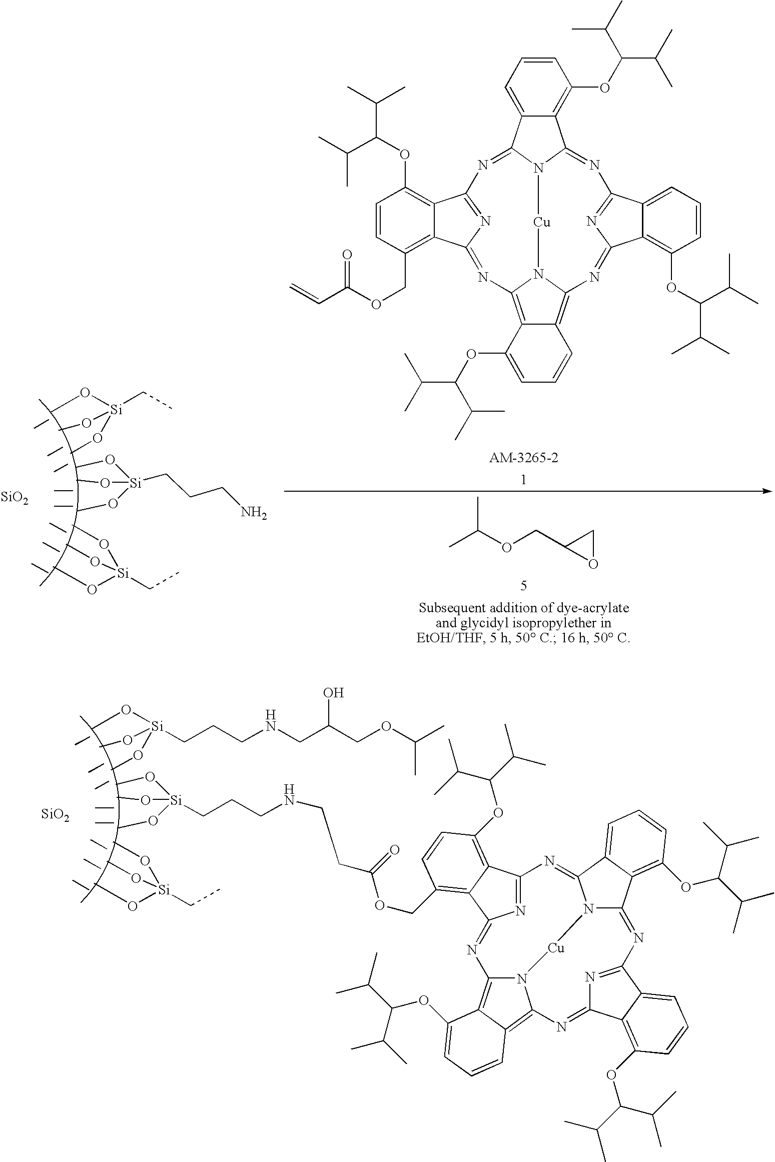

0.864 g of an ethanolic dispersion obtainable according to Example 1 (total amine content: 1.08 mmol; organic shell: 26.6%; 26.2% by weight in ethanol) is mixed and stirred with a solution of 206 mg (0.18 mmol) of the Cu-phthalocyanine dye obtainable according to Example 33a) in 5 ml THF at 50° C. for 5 hours. After verification by thin layer chromatography (toluene/THF 4:1) that no starting product is left, 105 mg (0.9 mmol) glycidyl isopropylether is added and the reaction mixture stirred at 50° C. for 16 hours. The solvent is evaporated in the rotavap and the residue dried in vacuo at 50° C. over night. A green powder is obtained. Yield: 458 mg.

### Analytics:

Thermographimetric analysis (TGA; heating rate: 10° C./min from 50° C. to 800° C.): Weight loss: 64.3% corresponding to the total of organic material. Dye content: 38.4%. Dynamic light scattering (DLS) of the powder, re-dispersed in BuOAc: Average diameter d=68.4 nm (monomodal).

A comparison of the thermal stabilities of the pure and acrylate modified dyes (see the Cu-phthalocyanine dye used as educt in Example 33a) and the acrylate modified Cu-phthalocyanine dye obtained according to Example 33a)) with the nanoparticle bound dye (see the Cu-phthalocyanine dye obtained according to this Example 33b)) reveals clearly the superior thermal stability of the nanoparticle bound dye.

A polycarbonate film with a thickness of 30 μm is prepared by dissolving 10 g polycarbonate and 100 mg of the Cu-phthalocyanine dye obtained according to this Example 33b) in 40 g CH₂Cl₂ and its UV-VIS-NIR spectrum measured. Compared to the Cu-phthalocyanine dye used as educt in Example 33a) the wavelength of the maximum absorption decreases slightly.

### EXAMPLE 34

### 3-Aminopropylsilane Modified Alumina Nanoparticles

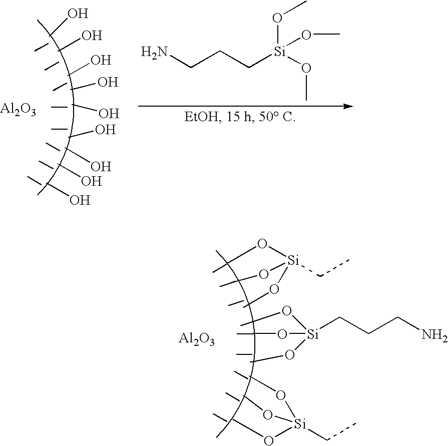

150 g of alumina nanoparticles (Nyacol Corp., Nyacol A120 DW, 22% nanoalumina dispersion in water) is mixed with 250 ml ethanol. 27 g 3-Aminopropyltrimethoxysilane is added dropwise to this homogeneous mixture. After the addition, the mixture is heated to 50° C. for 15 hours. The volume of this mixture is then reduced to ca. 1 L by evaporating EtOH/H₂O in the rotary evaporator. The obtained solid is redispersed in ethanol to a 11.4 weight-% opaque dispersion.

### Analytics:

Thermographimetric analysis (TGA; heating rate: 10° C./min from 50° C. to 800° C.): Weight loss: 27.9 weight-% corresponding to the organic material.

Elemental analysis: found: N, 4.16 wt. %: corresponding to an organic content of 17.3 weight-%. The difference between TGA and elemental analysis results is due to the loss of water out of the inorganic matrix and water generated from condensation processes on the surface during thermal treatment.

Dynamic light scattering (DLS): Average diameter d=164 nm.

### EXAMPLE 35

### 6-Methoxybenzoxanthene Reacted with 3-Aminopropyl Silane Modified Alumina Nanoparticles

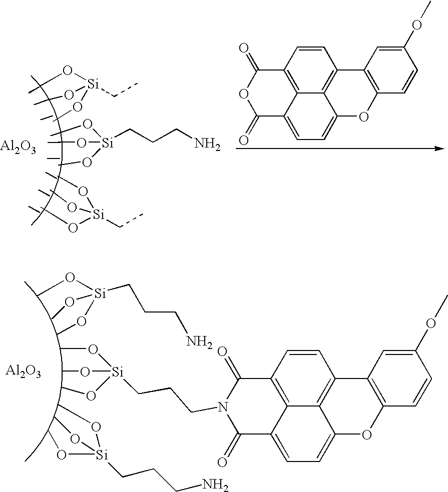

88.6 g of a 11.4 weight-% dispersion of 3-aminopropylsilane modified alumina nanoparticles (obtainable according to example 34) in ethanol is mixed with 30 g of dimethylformamid (DMF), homogenized and ethanol is removed with the rotary evaporator at a temperature of 45° C. (80 hPa).

To this dispersion a total of 212 mg of 6-methoxybenzoxanthene is added under magnetic stirring. The yellow-orange reaction mixture is stirred and heated for 15 hours to a temperature of 110° C. After cooling down to room temperature a total of 150 ml THF and 150 ml n-hexane is added to the orange dispersion. Thereafter, the modified particles are precipitated and separated via centrifugation (3000 rpm). Then, particles are redispersed in 100 ml THF, again precipitated by adding 100 ml n-hexane and separated by centrifugation. After 2 times washing with this procedure the particle-free solvent phase is colourless and no free dye can be found with thin layer chromatography (toluene/ethyl acetate=10:1). After drying to weight constancy 87.2 g of a yellow-orange fine powder is obtained. It shows strong fluorescence under 366 nm UV-light radiation.

### Analytics:

Thermographimetric analysis (TGA; heating rate: 10° C./min from 50° C. to 800° C.): Weight loss: 35.1 weight-% corresponding to the organic material.

Elemental analysis: found: C, 13.55 wt. %, H, 3.36 wt 5.%, O: 13.76 wt. % N, 4.07 wt. %: corresponding to an organic content of 34.7 wt. % in relatively good agreement to the TGA value.

TEM: Average diameter d=70 nm.

1. Functionalized nanoparticles comprising on the surface a covalently bound radical of formula 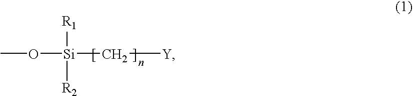
wherein
the nanoparticles are SiO₂, Al₂O₃ or mixed SiO₂ and Al₂O₃ nanoparticles,
R₁ and R₂ are independently of each other hydrogen, nanoparticle surface-O—, or a substituent,
n is 1, 2, 3, 4, 5, 6, 7 or 8, and
Y is a radical of formula
—B₁-D₁ (2a),
wherein
B₁ is a direct bond or a bridge member, and
D₁ is a radical of a cationic dye, a radical of a phthalocyanine dye which carries no water-solubilizing group, or a radical of a fluorescent dye selected from the group consisting of coumarins, benzocoumarins, xanthenes, benzo[a]xanthenes, benzo[b]xanthenes, benzo[c]xanthenes, phenoxazines, benzo[a]phenoxazines, benzo[b]phenoxazines, benzo[c]phenoxazines, napthalimides, naphtholactams, azlactones, methines, oxazines, thiazines, diketopyrrolopyrroles, quinacridones, benzoxanthenes, thio-epindolines, lactamimides, diphenylmaleimides, acetoacetamides, imidazothiazines, benzanthrones, phthalimides, benzotriazoles, pyrimidines, pyrazines and triazines,
or Y is a radical of formula
—B₂D₂ (2b),
wherein
B₂ is an organic radical comprising at least one group having a negative charge, and
D₂ is a cationic dye selected from the group consisting of monoazo, disazo, polyazo, methine, azamethine, diphenylmethane, triphenylmethane, triaminotriarylmethane, azine, oxazine, cyanine and anthraquinone dyes.

2. Functionalized nanoparticles according to claim 1, wherein
R₁ and R₂ independently of each other are hydrogen; C₁-C₂₅alkyl which may be interrupted by —O— or —S—; C₂-C₂₄alkenyl; phenyl; C₇-C₉phenylalkyl; —OR₅; 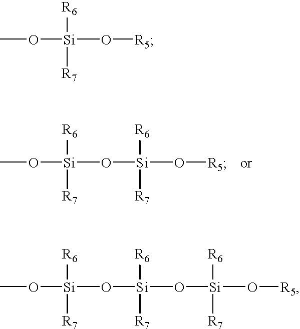
R₅ is hydrogen; C₁-C₂₅alkyl which may be interrupted by —O— or —S—; C₂-C₂₄alkenyl; phenyl; C₇-C₉phenylalkyl; 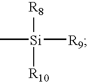
or the nanoparticle surface,
R₆ and R₇ independently of each other are hydrogen; C₁-C₂₅alkyl which may be interrupted by —O— or —S—; C₂-C₂₄alkenyl; phenyl; C₇-C₉phenylalkyl; or —OR₅, and
R₈, R₉ and R₁₀ independently of each other are hydrogen; C₁-C₂₅alkyl which may be interrupted by —O— or —S—; C₂-C₂₄alkenyl; phenyl; or C₇-C₉phenylalkyl.

3. Functionalized nanoparticles according to claim 1, wherein n is 2, 3 or 4.

4. Functionalized nanoparticles according to claim 1, wherein
B₁ is a direct bond, —NH—SO₂—, —NH—CO—, —NH—CO—NH—CO— or C₁-C₂₅alkylene, which may be bound and/or be interrupted by at least one of the radicals selected from the group consisting of —O—, —S—, —NH—, —CO—, —O—CO—, —CO—O—, —NH—CO— and —CO—NH— and
B₂ is C₁-C₂₅alkyl which may be bound and/or be interrupted by at least one of the radicals selected from the group consisting of —O—, —S—, —N(R₄)—, —CO—, —O—CO—, —CO—O—,
—N(R₄)—CO— and —CO—N(R₄)—, and which is unsubstituted or substituted by hydroxy, carboxy, sulfo or sulfato,
R₄ is hydrogen or C₁-C₁₂alkyl which is unsubstituted or substituted by hydroxy, carboxy, sulfo or sulfato, and
wherein at least one of the alkyl radicals B₂ and R₄ contains a carboxy, sulfo or sulfato group.

5. Functionalized nanoparticles according to claim 4, wherein
B₁ is a direct bond or —NH—SO₂—, —NH—CO—(CH₂)₁₋₆, —NH—(CH₂)₁₋₆—CO—O—(CH₂)₁₋₆—, —NH—CO—(CH₂)₁₋₆CO—NH—, —NH—CO—(CH₂)₁₋₆CO—O— or —NH—(CH₂)₁₋₆CO—O—(CH₂)₁₋₆—O— and
B₂ is C₁-C₂₅alkyl, which is bound by —N(R₄)— or —N(R₄)—CO—, which is uninterrupted or interrupted by —O—, and which is unsubstituted or substituted by hydroxy, carboxy or sulfo,
R₄ is hydrogen or C₁-C₈alkyl which is unsubstituted or substituted by carboxy or sulfo, and
wherein at least one of the alkyl radicals B₁ and R₄ contains a carboxy or sulfo group.

6-7. (canceled)

8. Functionalized nanoparticles according to claim 1, wherein
D₁ is derived from xanthene, benzoxanthene, naphthalimid, diketopyrrolopyrrole or phthalocyanine dyes.

9. Functionalized nanoparticles according to claim 8, wherein D₁ is a radical of formula 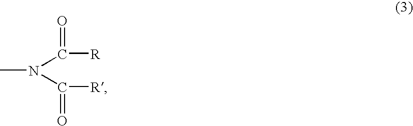
wherein R and R′ together with the residue of formula —N(CO—)₂ form the radical of a benzoxanthene or naphthalimid dye.

10. Functionalized nanoparticles according to claim 1, wherein the cationic dye D₁ is derived from monoazo, disazo, polyazo, methine, azamethine, diphenylmethane, triphenylmethane, triaminotriarylmethane, azine, oxazine, thiazine, cyanine or anthraquinone dyes.

11. Functionalized nanoparticles according to claim 1, wherein the cationic dye D₁ is derived from diphenylmethane, triphenylmethane or triaminotriarylmethane dyes and the cationic dye D₂ is a diphenylmethane, triphenylmethane or triaminotriarylmethane dye.

12. (canceled)

13. Functionalized nanoparticles according to claim 1, comprising on the surface additionally a covalently bound radical of the formula (16) 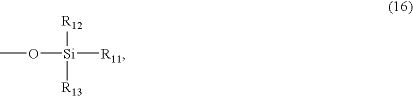
wherein
the nanoparticles are SiO₂, Al₂O₃ or mixed SiO₂ and Al₂O₃ nanoparticles,
R₁₁ is C₁-C₂₅alkyl or C₂-C₂₄alkenyl, which may be substituted by amino, mercapto or hydroxyl and/or may be interrupted by —O—, —S—, —N(R₁₄)—, —CO—, —O—CO— or —CO—O—; C₅-C₁₂cycloalkyl; C₅-C₁₂cycloalkenyl; or a polymerizable group or a polymer each of which may be bound via a bridge member,
R₁₂ and R₁₃ are independently of each other hydrogen, nanoparticle surface-O—, or a substituent, and
R₁₄ is hydrogen or C₁-C₄alkyl.

14. Functionalized nanoparticles according to claim 13, wherein
R₁₂ and R₁₃ independently of each other are hydrogen; C₁-C₂₅alkyl which may be interrupted by —O— or —S—; C₂-C₂₄alkenyl; phenyl; C₇-C₉phenylalkyl; —OR₅; 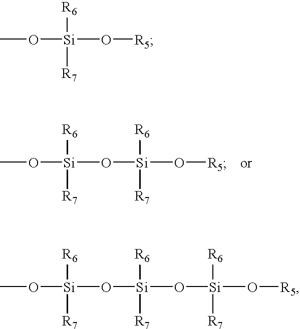
R₅ is hydrogen; C₁-C₂₅alkyl which may be interrupted by —O— or —S—; C₂-C₂₄alkenyl; phenyl; C₇-C₉phenylalkyl; 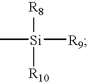
or the nanoparticle surface,
R₆ and R₇ independently of each other are hydrogen; C₁-C₂₅alkyl which may be interrupted by —O— or —S—; C₂-C₂₄alkenyl; phenyl; C₇-C₉phenylalkyl; or —OR₅, and
R₈, R₉ and R₁₀ independently of each other are hydrogen; C₁-C₂₅alkyl which may be interrupted by —O— or —S—; C₂-C₂₄alkenyl; phenyl; or C₇-C₉phenylalkyl.

15. Functionalized nanoparticles according to claim 13, wherein
R₁₁ is C₁-C₂₅alkyl which is unsubstituted or substituted by hydroxyl, and is uninterrupted or interrupted by —O—, —S—, —NH—, —CO—, —O—CO— or —CO—O—;
or R₁₁ is a polyethylene glycol, polypropylene glycol or polyacrylate group which is bound via C₁-C₂₅alkylene, which in turn may be bound and/or be interrupted by at least one of the radicals selected from the group consisting of —O—, —S—, —NH—, —CO—, —O—CO— and —CO—O—.

16. Functionalized nanoparticles according to claim 1 comprising on the surface additionally a covalently bound radical of formula (17) 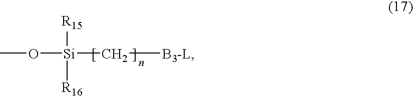
wherein
the nanoparticles are SiO₂, Al₂O₃ or mixed SiO₂ and Al₂O₃ nanoparticles,
R₁₅ and R₁₆ are independently of each other hydrogen, nanoparticle surface-O—, or a substituent,
n is 1, 2, 3, 4, 5, 6, 7 or 8,
B₃ is the direct bond or a bridge member, and
L is the residue of a stabilizer.

17. Functionalized nanoparticles according to claim 16, wherein
R₁₅ and R₁₆ independently of each other are hydrogen; C₁-C₂₅alkyl which may be interrupted by —O— or —S—; C₂-C₂₄alkenyl; phenyl; C₇-C₉phenylalkyl; —OR₅; 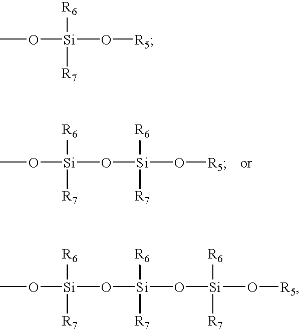
R₅ is hydrogen; C₁-C₂₅alkyl which may be interrupted by —O— or —S—; C₂-C₂₄alkenyl; phenyl; C₇-C₉phenylalkyl; 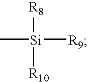
or the nanoparticle surface,
R₆ and R₇ independently of each other are hydrogen; C₁-C₂₅alkyl which, may be interrupted by —O— or —S—; C₂-C₂₄alkenyl; phenyl; C₇-C₉phenylalkyl; or —OR₅, and
R₈, R₉ and R₁₀ independently of each other are hydrogen; C₁-C₂₅alkyl which may be interrupted by —O— or —S—; C₂-C₂₄alkenyl; phenyl; or C₇-C₉phenylalkyl.

18. Functionalized nanoparticles according to claim 16, wherein B₃ is C₁-C₂₅alkylene, which may be bound and/or be interrupted by at least one of the radicals selected from the group consisting of —O—, —S—, —NH—, —CO—, —O—CO—, —CO—O—, —NH—CO— and —CO—NH—.

19. Functionalized nanoparticles according to claim 16, wherein
L is selected from the group consisting of sterically hindered amines, 2-hydroxyphenylbenzotriazoles, 2-hydroxyphenylbenzophenones, oxalanilides, 2-hydroxyphenyl-4,6-diaryltriazines, and sterically hindered phenol types.

20. Functionalized nanoparticles according to claim 19, wherein
L is a radical of formula 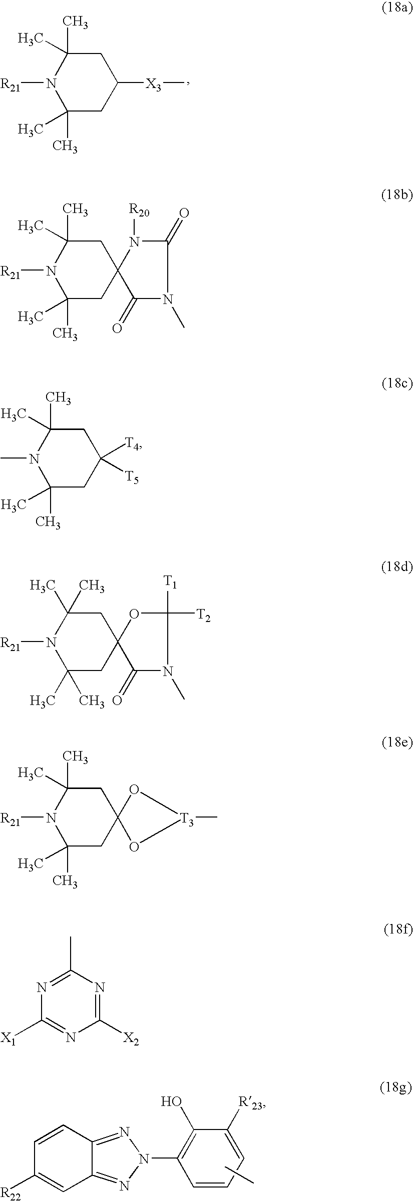 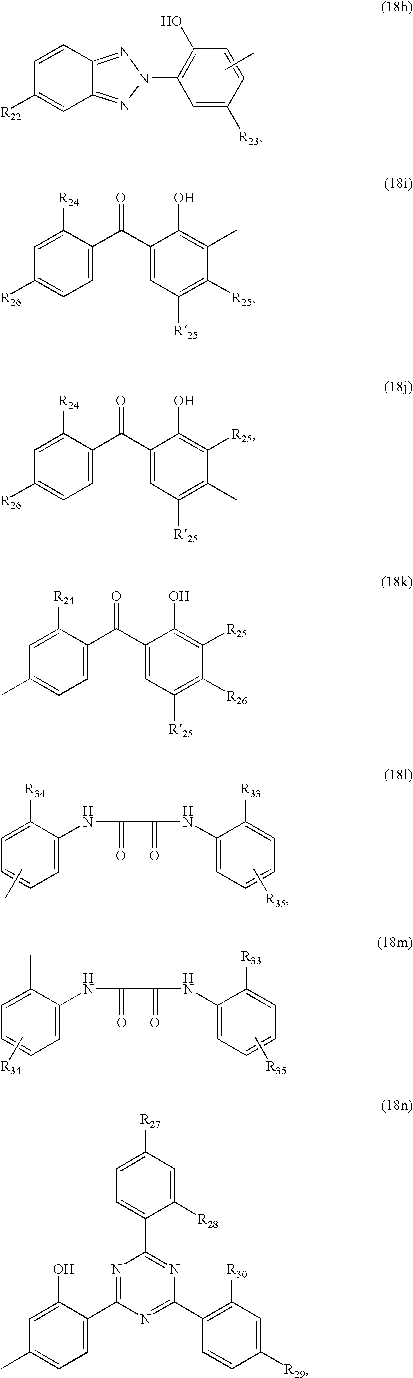 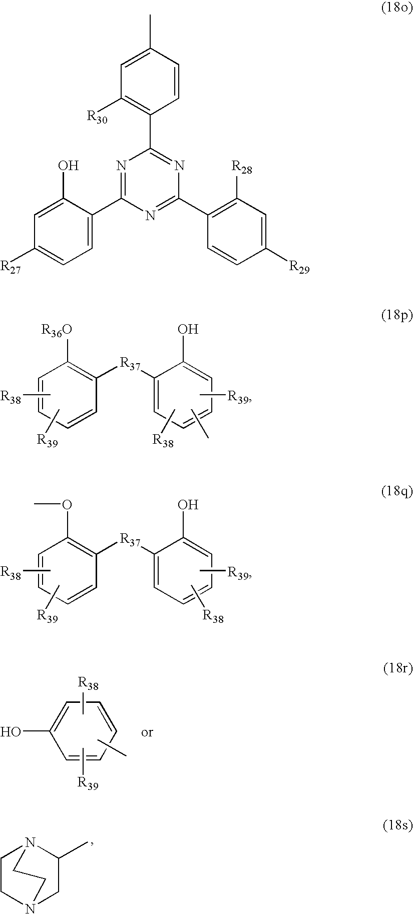
wherein
R₂₀ is H, C₁-C₁₈alkyl, C₇-C₁₁phenylalkyl, C₂-C₆alkoxyalkyl or C₅-C₁₂cycloalkyl;
R₂₁ is hydrogen, oxyl, hydroxyl, C₁-C₁₈alkyl, C₃-C₈alkenyl, C₃-C₈alkynyl, C₇-C₁₂aralkyl, C₁-C₁₈alkoxy, C₁-C₁₈hydroxyalkoxy, C₅-C₁₂cycloalkoxy, C₇-C₉phenylalkoxy, C₁-C₈alkanoyl, C₃-C₅alkenoyl, C₁-C₁₈alkanoyloxy, benzyloxy, glycidyl or a group —CH₂CH(OH)-G, in which G is hydrogen, methyl or phenyl,
R₂₂ is H, Cl, C₁-C₄alkyl or C₁-C₄alkoxy;
R₂₃ is C₁-C₁₂alkyl;
R′₂₃ is H or C₁-C₁₂alkyl;
R₂₄ is H or OH;
R₂₅ is H, Cl, OH or C₁-C₁₈alkoxy;
R′₂₅ is H, Cl or C₁-C₄alkyl;
R₂₆ is H, Cl, OH or C₁-C₁₈alkoxy;
R₂₇ and R₂₉, independently of one another, are H, OH, Cl, CN, phenyl, C₁-C₆alkyl, C₁-C₁₈alkoxy, C₄-C₂₂alkoxy which is interrupted by 0 and/or substituted by OH, or are C₇-C₁₄phenylalkoxy; and
R₂₈ and R₃₀, independently of one another, are H, OH, Cl, C₁-C₆alkyl or C₁-C₆-alkoxy;
R₃₁ and R′₃₁, independently of one another, have one of the meanings indicated for R₂₀ or together form tetramethylene or -oxamethylene or pentamethylene or -oxamethylene;
R₃₂ is C₁-C₁₈alkyl, C₂-C₄alkenyl or phenyl;
R₃₃, R₃₄ and R₃₅, independently of one another, are H, C₁-C₁₈alkyl or
C₁-C₁₈-alkoxy;
R₃₆ is hydrogen or 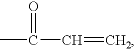
R₃₇ is C₁-C₄alkylene,
R₃₈ and R₃₉ are each independently of the other hydrogen, C₁-C₁₈alkyl, C₇-C₉phenylalkyl, phenyl or C₅-C₈cycloalkyl,
T₁ and T₂, independently of one another, are hydrogen, C₁-C₁₈alkyl, phenyl-C₁-C₄-alkyl or unsubstituted or halogen- or C₁-C₄alkyl-substituted phenyl or naphthyl or T₁ and T₂, together with the carbon atom connecting them, form a C₅-C₁₂cycloalkane ring,
T₃ is C₂-C₈alkanetriyl,
T₄ is hydrogen, C₁-C₁₈alkoxy, C₃-C₈alkenyloxy or benzyloxy, and
T₅ has the same meaning as T₄, or T₄ and T₅ together are —O—C₂-C₈alkylene-O—, or T₅, if
T₄ is hydrogen, is —OH or —NR₂₀—CO—R₃₂;
X₁ is a group of the formula (18a) and
X₂ has the same meaning as X₁ or is C₁-C₁₈alkoxy or —NR₃₁R′₃₁;
X₃ is the direct bond, —NR₂₀—, —NX₆— or —O—, or is a radical of the formula —O—CO—X₅—CO—O—X₆, where
X₅ is C₁-C₁₂alkanetriyl and
X₆ is a radical of the formula

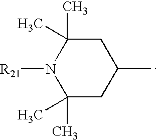

21. Functionalized nanoparticles comprising on the surface a covalently bound radical of formula 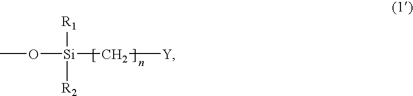
wherein
the nanoparticles are SiO₂, Al₂O₃ or mixed SiO₂ and Al₂O₃ nanoparticles,
R₁ and R₂ are independently of each other hydrogen, nanoparticle surface-O—, or a substituent,
n is 1, 2, 3, 4, 5, 6, 7 or 8, and
Y is a radical of formula
—B₁-D₁′ (2′),
wherein
B₁ is the direct bond or a bridge member, and
D₁′ is the radical of a fluorescent perylene dye, and
wherein the functionalized nanoparticles comprise on the surface additionally a covalently bound radical of the formula (16) 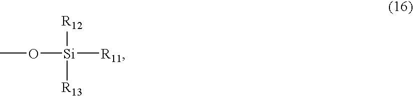
wherein
the nanoparticles are SiO₂, Al₂O₃ or mixed SiO₂ and Al₂O₃ nanoparticles.
R₁₁ is C₁-C₂₅alkyl or C₂-C₂₄alkenyl, which may be substituted by amino, mercapto or hydroxyl and/or may be interrupted by —O—, —S—, —N(R₁₄)—, —CO—, —O—CO— or —CO—O—; C₅-C₁₂cycloalkyl; C₅-C₁₂cycloalkenyl; or a polymerizable group or a polymer each of which may be bound via a bridge member,
R₁₂ and R₁₃ are independently of each other hydrogen, nanoparticle surface-O—, or a substituent, and
R₁₄ is hydrogen or C₁-C₄alkyl
or a radical of formula (17). 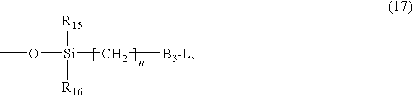
wherein
the nanoparticles are SiO₂, Al₂O₃ or mixed SiO₂ and Al₂O₃ nanoparticles,
R₁₅ and R₁₆ are independently of each other hydrogen, nanoparticle surface-O—, or a substituent,
n is 1, 2, 3, 4, 5, 6, 7 or 8.
B₃ is the direct bond or a bridge member, and
L is the residue of a stabilizer.

22. Functionalized nanoparticles according to claim 1, wherein the functionalized nanoparticles have a spherical shape.

23. Functionalized nanoparticles according to claim 1, wherein the functionalized nanoparticles have a particle size of 10 to 1000 nm.

24. Functionalized nanoparticles according to claim 1, wherein the functionalized nanoparticles are silica nanoparticles.

25. A composition comprising
(a) an organic material, and
(b) functionalized nanoparticles according to claim 1 present in an amount from 0.01 to 80%, based on the weight of component (a).

26-30. (canceled)
